(19) United States
(12) Patent Application Publication
(10) Pub. No.: US 2024/0058767 A1
(43) Pub. Date: Feb. 22, 2024

(54) POLYMERIC COMPOSITE MEMBRANES HAVING ORIENTED NANOCHANNELS AND METHODS OF MAKING THE SAME

(71) Applicants: The Trustees of the University of Pennsylvania, Philadelphia, PA (US); Yale University, New Haven, CT (US)

(72) Inventors: Chinedum Osuji, Gladwyne, PA (US); Yizhou Zhang, Philadelphia, PA (US); Xunda Feng, New Haven, CT (US); Lucas Sixdenier, New Haven, CT (US)

(21) Appl. No.: 18/040,484

(22) PCT Filed: Aug. 9, 2021
(86) PCT No.: PCT/US21/45272

§ 371 Date: Feb. 3, 2023

Related U.S. Application Data
(60) Provisional application No. 63/062,820, filed on Aug. 7, 2020.

(51) Int. Cl. B01D 69/12; B01D 61/08

(52) U.S. Cl. CPC B01D 69/125; B01D 61/08; B01D 2323/216; B01D 2323/30; B01D 2323/64; B01D 2325/02832; B01D 2325/04

(57) ABSTRACT

Disclosed herein is a polymer membrane, film or coating comprising cylindrical polymer fibers at least partially ordered as hexagonal packed cylinders within the film, aligned parallel to the film surface, and present as an H₁ mesophase; wherein the cylinders are crosslinked internally within the cylinders; and wherein the cylinders are spatially arranged to provide channels between the cylinders for fluid flow through the membrane, film or coating.

### CROSS REFERENCE TO RELATED APPLICATIONS

This application claims the benefit of U.S. Provisional Patent Application No. 63/062,820 filed on Aug. 7, 2020, which is incorporated by reference herein in its entirety.

### STATEMENT REGARDING FEDERALLY SPONSORED RESEARCH OR DEVELOPMENT

This invention was made with government support under Grant Nos. PFI:AIR-TT IIP-1640375, CBET1703494, and DMR-1945966 awarded by The National Science Foundation. The government has certain rights in the invention.

### BACKGROUND OF THE INVENTION

Membrane separations are widely used in existing technological applications including seawater desalination, gas separation, food processing and fuel cells, as well as in emerging areas, such as, sustainable power generation and distillation. Nanofiltration (NF) involves the removal of dissolved or suspended solutes ranging from 1-10 nm in size. The development of new NF membranes is of particular interest for low-cost treatment of wastewaters to remove organic contaminants, including so-called contaminants of emerging concern such as pesticides and metabolites of pharmaceutical drugs. Current state-of-the-art membranes, however, suffer from a generally recognized trade-off between permeability and selectivity: increasing permeability often results in decreased selectivity, and vice versa. This trade-off originates from the intrinsic structural limitation of these conventional membranes, i.e., a broad distribution of free volume elements in dense polymer membranes or pore sizes in porous membranes. Membranes based on self-assembled materials entail the use of nanostructures with near-monodisperse critical dimensions. Self-assembled materials have therefore been considered an attractive way to realize highly selective separations without compromising permeability.

In some instances, and under certain conditions, some block copolymers (BCPs) and small molecule liquid crystals (LCs) may be able to self-assemble into a series of mesophase morphologies possessing periodic nanoscale domains with sizes and shapes that are thermodynamically defined. The well-ordered nanostructures found in such BCPs and LCs, including cylinders, lamellae, and gyroids, have been considered as attractive templates for the fabrication of nanoporous membranes. (see, for example, M. J. Zhou, et al., Adv. Mater. 17, 1850 (2005)). Membranes made by non-solvent induced phase separation of block copolymers represent a compelling advance in terms of selectivity (at the ˜10 nm length scale) and scalability of fabrication. Additionally, self-assembling materials provide useful templates for controlling the organization of discrete structures that may be capable of functioning as nanofiltration pores.

For the readily accessed 1-D cylindrical and 2-D lamellar systems, the anisotropic nature of the nanostructures implies the need for uniform orientation throughout the system, e.g. cylinders in a thin film, to produce an optimized morphology for membrane performance. Such optimized morphologies, however, do not spontaneously occur during membrane fabrication processes. Considerable efforts must be made to direct the self-assembly of nanostructured domains in thin films. On the other hand, 3-D interconnected gyroid nanopores are advantageous over their cylindrical or lamellar counterparts, because the nanopores need no alignment to ensure continuity and optimized permeability in the resulting membrane. However, access to gyroid morphologies is complicated by their generally narrow windows for phase stability in BCPs and by the tailored molecular structures required in LC assemblies. The aforementioned challenges have combined to hamper the pursuit of high performance membranes derived from self-assembled materials. In addition to the need to optimize transport morphology, biofouling resistance is a significant concern. The generally poor biofouling resistance of current water treatment membranes and difficulties associated with their cleaning increase operating costs and are an important challenge to overcome.

There is a need in the art for nanoporous membranes having high permeability and selectivity. There is also a need in the art for useful nanoporous membranes having improved biofouling resistance. The present invention addresses these, as well as other, important ends.

### SUMMARY OF THE INVENTION

In one aspect of the invention, there is provided a polymer membrane, film or coating comprising a layer having a first surface, a second surface and a film thickness therebetween, and comprising cylindrical polymer fibers at least partially ordered as hexagonal packed cylinders within the film, aligned parallel to the film surface, and present as an H₁ mesophase; wherein the cylinders are crosslinked internally within the cylinders; and wherein the cylinders are spatially arranged to provide channels between the cylinders for fluid flow through the membrane, film or coating.

In embodiments, the channels between the cylinders have a critical separation dimension of less than about 1.5 nm for fluids or fluid/solute mixtures passing through the polymer membrane, film or coating.

In embodiments, the cylindrical polymer fibers comprise surfactant monomer units, in polymerized or crosslinked form.

In embodiments, the surfactant monomer is a polymerizable surfactant of the formula [Z—N⁺(R₁)(R₂)(R₃)]X⁻, wherein Z comprises a polymerizable group; X is a salt counter anion; R₁, R₂, and R₃ are alkyl groups which are bound to N that independently may be the same or different; and at least one of R₁, R₂, and R₃ is an alkyl group comprising at least 10 carbon atoms.

In embodiments, the surfactant monomer is [2-(acryloyloxy) ethyl] tetradecyl dimethyl ammonium bromide (AETDAB) or [2-(methacryloyloxy) ethyl] tetradecyl dimethyl ammonium bromide (METDAB).

In embodiments, the polymer membrane, film or coating has a film thickness ranging from about 50 nm to about 20 μm.

In embodiments, the polymer membrane, film or coating has a water permeation rate of at least 1 L m⁻² h⁻¹ bar⁻¹, or it may have a water permeation rate of at least 20 L m⁻² h⁻¹ bar⁻¹.

In embodiments, the cylinders are crosslinked internally within the cylinders and inter-cylinder crosslinking also exists to connect neighboring cylindrical polymer fibers.

In embodiments, no inter-cylinder crosslinking exists to connect neighboring cylindrical polymer fibers.

The invention further provides a thin film composite membrane comprising:
(i) a polymer membrane, film or coating comprising a layer having a first surface, a second surface and a film thickness therebetween, and comprising cylindrical polymer fibers at least partially ordered as hexagonal packed cylinders within the film, aligned parallel to the film surface, and present as an H₁ mesophase; wherein the cylinders are crosslinked internally within the cylinders; and wherein the cylinders are spatially arranged to provide channels between the cylinders for fluid flow through the membrane, film or coating; and
(ii) a porous support layer in contact with the polymer membrane, film or coating.

In embodiments, the porous support layer is polyacrylonitrile, polyvinylidene fluoride, polysulfone, polyamide, polyimide, polypropylene, anodized aluminum oxide, cellulose acetate, or nonwoven fabric.

The invention further provides a nanofiltration device comprising the thin film composite membrane.

The invention further provides a method of producing a thin film composite membrane, said method comprising the steps of: providing a porous support layer, and, optionally, an adjacent layer in contact with the porous support layer; depositing a solution comprising at least one polymerizable mesophase precursor on the porous support layer or adjacent layer, wherein the solution has a water and/or solvent content; forming a mesophase on the porous support layer or adjacent layer, optionally, by reducing the water and/or solvent content; and polymerizing and crosslinking the mesophase precursor to form a polymer membrane, film or coating comprising cylindrical polymer fibers at least partially ordered as hexagonal packed cylinders within the film, aligned parallel to the film surface, and present as an H₁ mesophase; wherein the cylinders are crosslinked internally within the cylinders; and wherein the cylinders are spatially arranged to provide channels between the cylinders for fluid flow through the thin film composite membrane.

In embodiments of the method, the polymerizable mesophase precursor is a polymerizable surfactant.

In embodiments of the method, the polymerizable mesophase precursor is a polymerizable surfactant of the formula [Z—N⁺(R₁)(R₂)(R₃)]X⁻, wherein Z comprises a polymerizable group; X is a salt counter anion; R₁, R₂, and R₃ are alkyl groups which are bound to N that independently may be the same or different; and at least one of R₁, R₂, and R₃ is an alkyl group comprising at least 10 carbon atoms.

In embodiments of the method, the polymerizable mesophase precursor is [2-(acryloyloxy) ethyl] tetradecyl dimethyl ammonium bromide (AETDAB) or [2-(methacryloyloxy) ethyl] tetradecyl dimethyl ammonium bromide (METDAB).

In embodiments of the method, the solution further comprises a photoinitiator.

In embodiments of the method, the photoinitiator is 2,4,6-trimethylbenzoyl-diphenylphosphine oxide or 2-methoxy-2-phenylacetophenone.

In embodiments of the method, the amount of photoinitiator is from about 0.02-2.0 wt. %.

In embodiments of the method, the step of polymerizing the polymerizable mesophase precursor is performed by exposing it to UV light.

In embodiments of the method, the channels between the cylinders provide a critical separation dimension of less than about 1.5 nm for fluids or fluid/solute mixtures passing through the thin film composite membrane.

In embodiments of the method, the porous support layer is polyacrylonitrile, polyvinylidene fluoride, polysulfone, polyamide, polyimide, polypropylene, anodized aluminum oxide, cellulose acetate, or nonwoven fabric.

In embodiments of the method, the step of depositing the at least one polymerizable mesophase precursor comprises the step of spin coating from an organic solvent solution.

In embodiments of the method, the organic solvent is selected from ethylene glycol, glycerol, ethyl acetate, ethanol, methanol, isopropanol, acetonitrile, tetrahydrofuran, 1,4-dioxane, acetone, dimethylformamide, or N-methyl pyrrolidone.

In embodiments of the method, the step of spin coating from an organic solvent solution produces a polymeric membrane, film or coating having a thickness ranging from about 50 nm to about 20 μm.

In embodiments of the method, the step of polymerizing and crosslinking the polymerizable mesophase precursor forms a polymer membrane, film or coating having a water permeation rate of at least 1 L m⁻² h⁻¹ bar⁻¹.

In embodiments of the method, the step of polymerizing and crosslinking the polymerizable mesophase precursor forms a polymer membrane, film or coating having a water permeation rate of at least 20 L m⁻² h⁻¹ bar⁻¹.

In embodiments of the method, the step of polymerizing and crosslinking the polymerizable mesophase precursor forms a polymer membrane, film or coating comprising cylindrical polymer fibers at least partially ordered as hexagonal packed cylinders within the film, aligned parallel to the film surface, and present as an H₁ mesophase; wherein the cylinders are crosslinked internally within the cylinders and wherein inter-cylinder crosslinking also exists to connect neighboring cylindrical polymer fibers.

In embodiments of the method, no inter-cylinder crosslinking exists to connect neighboring cylindrical polymer fibers.

In embodiments of the method, the adjacent layer is a sacrificial layer which can be readily dissolved away using a solvent or water or dilute acid or dilute base solution.

In embodiments of the method, the sacrificial layer is selected from a layer of polyacrylic acid, polyvinyl alcohol, polyvinylpyrrolidone, alginic acid, alginate, cadmium hydroxide, polyethyleneoxide, or a layer of chitosan or a layer of dextran.

In embodiments of the method, the polymerizable mesophase precursor comprises at least two polymerizable surfactants having differing hydrophobic tail lengths.

In embodiments of the method, selecting the polymerizable mesophase precursor results in a selected pore size.

The invention further provides a thin film composite membrane formed by any of the methods disclosed herein.

The invention is not intended to be limited by the specific embodiments disclosed herein, and any combination of these embodiments (or portions thereof) may be made to define further embodiments.

### BRIEF DESCRIPTION OF THE DRAWINGS

The following detailed description of preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities of the embodiments shown in the drawings.

FIG. 1, comprised of FIGS. 1A-1D, depicts schematic illustrations of self-assembled structures used to fabricate nanoporous polymer membranes. FIG. 1A shows the two readily obtained morphologies, i.e., lamellae and cylinders, while used for forming nanopores, require alignment of the self-assembled domains. Also shown, 3-D interconnected gyroids are not universally observed in block copolymer and liquid crystal (LC) systems, and where they occur, usually exhibit narrow windows of stability. FIG. 1B shows a proposed morphology for fabricating membranes that can be easily templated from mesophases of hexagonally packed cylinders and requires no alignment to enhance flux. FIG. 1C is a schematic illustration for preparation of size exclusion nanofiltration membranes from crosslinking of a direct hexagonal cylinder lyotropic mesophase (H₁). The crosslinked sample contains hexagonally packed molecular fibrils in the continuous water phase, which allows water to permeate through the gap between nanofibers but rejects larger-size solutes due to size exclusion. FIG. 1D shows the molecular structures of the polymerizable surfactant 2-(methacryloyloxy)ethyl tetradecyl dimethyl ammonium bromide (METDAB), the water soluble crosslinker oligo(ethylene glycol) dimethacrylate (OEG-DMA) and the oily crosslinker ethylene glycol dimethacrylate (EG-DMA) for the formulation of the desired H₁ mesophase. EG-DMA copolymerizes with the surfactant in the hydrophobic core and water soluble OEG-DMA bridges each cylinder into a network, the morphology of which provides a continuous aqueous transport path, as schematically illustrated. Mn is the number average molecular weight of the OEG-DMA.

FIG. 2A shows the METDAB/water binary phase diagram as determined by polarized optical microscopy (POM) and X-ray scattering, along with exemplary POM images. The weight fractions of METDAB are shown in the phase diagram. As the concentration of METDAB is increased, the surfactant/water mixtures follow a phase sequence of micellar solution (L₁), hexagonal cylinder (H₁), gyroid (G), lamellar (L_{α}), and crystal (K). FIG. 2B shows exemplary X-ray scattering data representing this sequence.

FIG. 3 shows the results of polymerization of H₁ mesophases formed by METDAB/water binary systems in the absence of crosslinkers. FIG. 3A presents exemplary photos showing remarkable cloudiness in polymerized H₁ samples with different METDAB contents ranging from 55 to 80 wt %. FIG. 3B presents an exemplary POM image of the polymerized H₁ mesophase with 70 wt % METDAB showing loss of the typical LC texture. FIG. 3C shows 1-D small angle X-ray scattering (SAXS) data for this system displaying that the ratio of peak locations changes from 1:√3 to 1:√4 after polymerization, indicative of disruption of the H₁ morphology.

FIG. 4 shows exemplary structural characterization of an H₁ mesophase containing only one cross-linking species in the hydrophobic core of cylindrical micelles before and after UV-initiated cross-linking. The cross-linker is 1,6-hexanediol dimethacrylate (HDMA). The mesophase contained 70 wt % METDAB, 6 wt % HDMA, and 24 wt % water. FIG. 4A (upper image) shows the characteristic developable domain texture of the H₁ mesophase observed using POM before crosslinking, while the lower image shows that after UV induced cross-linking, a superficially similar, but discernably different, birefringent texture was observable in low magnification POM images. The rectangles (inserts in the upper and lower images) highlight the change of the LC texture induced polymerization. A magnified view (right image) more clearly shows the emergence of optical inhomogeneities within the developable domains, reflecting disruption of the original H₁ morphology. FIG. 4B shows exemplary X-ray scattering data showing intact peak locations but an unexpected increase of the intensity of the (200) peak after UV-induced cross-linking. FIG. 4C presents an exemplary transmission electron microscopy (TEM) image and accompanying schematic, which illustrate the tendency of the hexagonal cylinders to transform to lamellar structures after cross-linking.

FIG. 5 shows high-fidelity retention of the H₁ mesophase morphology after UV-induced crosslinking with the aid of dual crosslinkers. FIG. 5A presents an exemplary photo of an H₁ mesophase gel formed by 70 wt. % METDAB, 22.8 wt. % water, 5.4 wt. % OEG-DMA, and 1.8 wt. % EG-DMA. FIG. 5B presents exemplary photos showing the corresponding crosslinked polymer film (40 μm thick) and the film integrity after immersion in water for 24 h. FIG. 5C presents exemplary 1-D integrated SAXS data displaying the structural consistency of the H₁ morphology in the non-crosslinked gel, the crosslinked polymer, and the polymer after immersion in water for 24 h. A small increase of the d₁₀₀ spacing from 3.6 to 3.7 nm was found after 24 h of water immersion, indicating that there was very little swelling of the sample. FIG. 5D shows an exemplary POM image displaying the preservation of the typical LC texture found in cylindrical mesophases after crosslinking. FIG. 5E is a schematic illustration of the shear alignment and the direction of 2-D SAXS measurements. FIG. 5F shows exemplary 2-D SAXS patterns before (gel) and after (polymer) crosslinking as obtained by incidence of the X-ray beam parallel to the shear direction; and FIG. 5G, similarly, orthogonal to the shear direction. FIG. 5H shows exemplary POM images showing the essentially unchanged birefringent color of the oriented cylindrical micelles before and after crosslinking. The sample was positioned such that the original shear direction was at 450 with respect to each of the two crossed polarizers. FIG. 5I and FIG. 5J present exemplary TEM micrographs viewed along (FIG. 5I) and orthogonal to (FIG. 5J) the shear direction showing aligned nanofibrils. Insets: fast Fourier transform images. Prior to microtoming, the polymer was immersed into a 0.1 wt. % KI aqueous solution for 1 h to replace Br⁻ with I⁻ to enhance the atomic number contrast for imaging.

FIG. 6 presents exemplary X-ray scattering and POM data showing slight structural changes in the H₁ gel, the dual crosslinked H₁ mesophase, and the swelled polymer. FIG. 6A shows Gaussian fits of the (100) SAXS peaks of the H₁ gel and the corresponding polymer to obtain the values of full width at half maximum (fwhm).

FIG. 6B presents the time dependent d₁₀₀ spacing of the cross-linked H₁ membrane immersed in water as determined by X-ray scattering. FIG. 6C presents low-magnification and FIG. 6D presents high-magnification exemplary POM images of the crosslinked H₁ mesophase.

FIG. 7A shows a schematic for the geometrical dimension estimation from the cross-sectional viewpoint (assuming the volume fraction of cylinders=0.55). In the case of 55% solid fraction, the controlling dimension of the planar H₁, Sₓ is ˜0.9 nm. The calculations are provided herein in the calculation for critical pore dimension. The light grey particle represents the critical dimension if the solvent flows along the cylinder's axial direction, while the dark grey particle represents the critical dimension if the solvent flows perpendicular to the axial direction. FIG. 7B is a schematic top-down viewpoint of the crosslinked H₁ nanofibrils.

FIG. 8A shows a schematic illustrating H₁ membrane fabrication on a supporting polyacrylonitrile (PAN) membrane. FIG. 8B presents an exemplary photograph of an H₁/PAN composite membrane. FIG. 8C shows an exemplary cross-sectional scanning electron microscopy (SEM) image showing the composite membrane. FIG. 8D presents exemplary atomic force microscopy (AFM) images (scale bar 50 nm) showing the surface morphology of the H₁ membrane with closely-packed nanofibrils. Topological defects including dislocations, disclinations and grain boundaries are well-preserved on the film surface, consistent with high-fidelity retention of the mesophase morphology on crosslinking. FIG. 8E shows a line-profile analysis of the high-resolution AFM image (scale bar 20 nm) demonstrating an inter-fibril distance of ˜4 nm, in good agreement with SAXS and TEM measurements. A sinusoidal fit of the line profile provides a guide for the eye.

FIG. 9 presents exemplary SEM images showing the cross-sections of the H₁/PAN composite membranes. The H₁ gel infiltrates the pores of the PAN support membrane during the pressing stage and the infiltrated H₁ is eventually crosslinked along with the surface H₁ layer.

FIG. 10 presents the time-dependent solute rejection experiment for H₁ composites and the static solute adsorption experiment for free-standing H₁ membranes. In FIG. 10A the time-dependent solute rejection tests suggest the separation performance of H₁ composite is independent of experiment time; and in FIG. 10B the static solute adsorption tests suggest the separation performance for free-standing H₁ membranes is independent of permeated solution volume. UV-Vis spectroscopy was employed to determine the possible adsorption of dye molecules by the membranes. Dyes tested were FIG. 10C Alcian blue, FIG. 10D lysozyme, FIG. 10E crystal violet, FIG. 10F vitamin B₁₂, FIG. 10G methylene blue and FIG. 10H vitamin B₂. The experiment was performed with the same initial solute concentration as utilized during the single solute rejection experiment, with a packing ratio of ˜0.2 g membrane per L solution. The membranes did not uptake a significant amount of solute during prolonged soaking, suggesting adsorption did not affect the results in single solute rejection experiments.

FIG. 11 shows solute rejection and antibacterial properties of H₁ membranes. FIG. 11A illustrates exemplary rejection data of H₁ membranes and PAN membranes for seven different solutes: cobaltous chloride (Co(II)), methylene blue (MB), crystal violet (CV) and alcian blue 8G (AB), riboflavin (VB₂), cobalamin (VB₁₂) and lysozyme. Spacing filling models and estimated geometric mean diameters of the solutes are shown. Error bars represent 95% t-test confidence limits derived from data variance across multiple measurements, typically 2 membranes and 4 permeate samples per membrane. FIG. 11B shows exemplary photos of the feed solution of AB, the permeate from the H₁ membrane after the AB solution has passed through the membrane, and DI water as a reference, respectively. FIG. 11C presents an exemplary UV-Vis spectrum and photo showing competitive solute separation of CV and Co(II). FIG. 11D illustrates quantification of bacterial growth in colony forming units (CFU) in the samples, and exemplary photographs (insets) showing control (PAN membrane) and H₁-derived membrane samples after incubation with bacteria.

FIG. 12 shows an exemplary UV-Vis spectrum and photographs demonstrating the competitive solute separation of CV and VB2. The membrane selectively rejects CV while allowing VB2 to partially permeate through (R˜50%).

FIG. 13 illustrates a nanostructured thin-film composite from a lyotropic precursor. FIG. 13A shows a schematic demonstrating the highly ordered cylindrical nanofibrils nanoconfined microporous features that are available for highly selective molecular separation. The lyotropic mesophase functions to provide ultra-thin but defect-free arrays of single-nanometer 3D ordered water-bicontinuous channels for practical nanofiltrations. Inset photograph: a piece of 1-inch diameter H₁ thin-film composite nanofiltration membrane. FIG. 13B shows a schematic of the assembly of the lyotropic H₁ mesophase which begins from spin-coating a dilute solution of mesophase precursors dissolved in the selected organic solvent. Given a sufficient evaporation time, a critically low concentration of volatile solvent allows for microphase separation that leads to an ultra-thin film of direct cylindrical mesophase planar arranged at the equilibrium.

FIG. 14A shows the reaction scheme for the synthesis of [2-(acryloyloxy)ethyl]-dimethyl tetradecyl ammonium bromide (AETDAB). FIG. 14B shows an exemplary ¹H nuclear magnetic resonance (NMR) spectrum of the AETDAB in CDCl₃. ¹H NMR [500 MHz, CDCl₃]: δ=6.46 (1H, a), 6.11 (1H, c), 5.94 (1H, b), 4.66 (2H, d), 4.15 (2H, e), 3.59 (2H, g), 3.51 (6H, f), 1.74-1.24 (26H, h-i), 0.86 (3H, j).

FIG. 15 presents a structural analysis demonstrating the high-fidelity retention of the H₁ mesophase with a 1-nm separation feature. FIG. 15A shows the molecular structure of the lyotropic precursor that self-assembles into the mesophase at equilibrium. The mesophase is composed of a polymerizable amphiphilic acrylate AETDAB, a hydrophobic crosslinker hexanediol diacrylate (HDDA), and aqueous content glycerol. FIG. 15B shows exemplary 1D SAXS diffraction data for the pre-polymerized gel and the polymer demonstrating the comprehensive retention of a nanostructured template from lyotropic mesophase during the photoinitiated crosslinking in bulk. A consistent characteristic q ratio is maintained with averaged center-center distance alternated from ˜3.5 to 3.6 nm. FIG. 15C shows exemplary high magnification polarized optical micrographs, from which identical birefringence texture was established. Micrographs were taken from a bulk sample prior to and after the crosslinking reaction. Inset: exemplary photographs for the lyotropic gel and the free-standing polymeric thin-film. FIG. 15D presents a schematic for an array of hexagonally packed nanofibrils that constructs the water-bicontinuous nanochannels available for nanofiltration. Assuming a cylinder volume fraction of 55%, planar ordered nanochannels provide solute separation at a 1-nm scale.

FIG. 16 presents exemplary Fourier-transform infrared (FTIR) spectra before and after UV-initiated polymerization, confirming the UV-initiated polymerization of the monomer AETDAB within the self-assembled H₁ matrix. The polymerization was conducted using a 100-W focused UV beam illuminating on the surface of the lyotropic liquid crystal in a nitrogen atmosphere for 25 min. The disappearance of the peaks at ˜(i) 1620 cm⁻¹, (ii) 1410 cm⁻¹, and (iii) 810 cm⁻¹ indicates the formation of saturated alkanes. An estimated percent conversion >97% is calculated by comparing the characteristic peak areas before and after the polymerization.

FIG. 17 presents an exemplary stress-strain curve of crosslinked H₁ bulk films. The curve is demonstrating a consistent toughness of ˜130 kPa m⁻³ for both dry and water wetted films, indicating the film is sufficiently strong to prevent irreversible deformation from the pressure-driven flow present during filtration.

FIG. 18 presents exemplary optical micrographs (200 μm scale bar) demonstrating the high fidelity mesophase preservation after polymerizations related to the photoinitiator concentrations labeled on the left. The birefringence textures representative of H₁ nanostructure were fully retained at lower photoinitiator concentration. Specifically, no defects can be seen to be present in the micrograph derived from mesophase with 0.04 wt. % photoinitiator. An unusual phenomenon of water vapor condensation was identified during the fabrication of mesophase templates as ultra-thin films. An instantaneous deposition of water film was observed while relocating the crosslinked thin-film from the inert gas chamber into the atmosphere (at room temperature, and air-conditioning controlled relative humidity between 30 to 70%). The water droplets contribute the mosaic texture atop the original texture, and the focal conic H₁ texture shown up when droplets were wiped.

FIG. 19 presents exemplary high magnification polarized optical micrographs (100 μm scale bar) of a crosslinked H₁ mesophase template with 0.04 wt. % initiator. FIG. 19A shows a layer of condensed water droplets covering the surface of the H₁ thin-film upon polymerization. FIG. 19B shows the micrograph acquired from wiping-off the water droplets.

FIG. 20 presents thin-films fabricated from spin-coating with preserved H₁ nanostructure arranged degenerative planar to the substrate. FIG. 20A shows an exemplary high-resolution polarized optical micrograph revealing the high-fidelity retention of the mesophase during the processing into a crosslinked thin-film. FIG. 20B illustrates the AFM height profile for the crosslinked thin-film atop of silicon substrate showing the dependence of film thickness with corresponding mesophase solution concentration. FIG. 20C shows representative 2-D GISAXS patterns recorded from H₁ thin-films cast on silicon wafers from a range of mesophase solution concentrations from 20 to 3% (by weight). The scattering pattern suggests the cylinders follow a particular directional orientation. A modified substrate surface chemistry labeled with asterisk (lower two images) induces potential phase transformation through coating a lower solution concentration on a hydrophilic polymer polyvinyl pyrrolidone (PVP). FIG. 20D presents the schematic nanostructure reflecting the scattering acquired from the H₁ thin-film is following a degenerative planar confirmation; and FIG. 20E presents a schematic showing the cylinders are oriented perpendicular to the prospective fluid flow.

FIG. 21 presents an exemplary 2D-transmission SAXS pattern collected from a crosslinked bulk film that does not show preferential nanofibril alignment. The 3-D model illustrates nanostructures at bulk follow a random orientation.

FIG. 22 shows exemplary 1D SAXS diffraction data of the polymer-supported H₁ thin-film calculated from a 2D GISAXS image. The mesophase solution was prepared by dissolving mesophase precursor molecules in ethyl acetate with pre-determined concentrations. The thin-film cast from a higher solution concentration (i.e., 10 wt. %) remained hexagonal close-packed nanostructure, following a characteristic peak spacing ratio 1:√3:√4 despite the hydrophilic surface chemistry (see asterisk samples in FIG. 20). However, the thin-film prepared from a lower solution concentration at 3 wt. % showed phase transformation with a different peak spacing ratio 1:2:3:4 that is similar to the lamellar nanostructure.

FIG. 23 presents a schematic of the composite H₁ nanofiltration membrane fabrication with corresponding micrograph analysis. FIG. 23A depicts a sacrificial layer assisted fabrication protocol based on spin-coating which generates ultra-thin thin film composite (TFC) membranes without significant solution infiltration into the support layer. FIG. 23B presents an exemplary surface micrograph for H₁ surface of a TFC which possesses a rather smooth surface. The membrane was cast from spin-coating 10 wt. % H₁ solution dissolved in ethyl acetate on polyacrylonitrile (PAN) covered with PVP, with subsequent UV crosslinking. FIG. 23C presents an exemplary micrograph showing a thin-film mesophase template with homogeneous cross-section was generated after rinsing the water-soluble protective layer from the PAN-H₁. FIG. 23D presents an exemplary micrograph showing that casting the same mesophase solution formulation on a PVP/polyvinylidene fluoride (PVDF) composite results in a lower film thickness. The PVDF supported H₁-TFC membrane demonstrates hydraulic permeance of 10 L m⁻² h⁻¹ bar⁻¹ which is comparable with high-performance nanofiltration membranes. FIG. 23E presents an exemplary micrograph showing an ultrathin film fabricated from casting a 3 wt. % solution on PVP sacrificial layer protected PAN (asterisk sample 3%* from FIG. 20).

FIG. 24 shows exemplary SEM micrographs of the PAN and PVDF ultrafiltration supports, and the cross-sectional images for the supports covered with a polymeric sacrificial layer. FIG. 24A shows an exemplary view of the surface morphology of a PAN ultrafiltration membrane with an advertised molecular weight cut-off (MWCO) at 300 kg mol⁻¹. FIG. 24B shows an exemplary view of the cross-sectional image of the same membrane covered with a 1-μm thick, dense PVP layer. FIG. 24C shows, similarly, that the PVP layer can be clearly distinguished from the PAN at higher magnification. FIG. 24D shows an exemplary view of the surface of a PVDF membrane with an advertised MWCO at 500 kg mol⁻¹. FIG. 24E shows the 3-μm thick sacrificial layer is visible from the cross-sectional analysis even at a lower magnification; and FIG. 24F shows, similarly, that the PVP layer can be clearly distinguished from the PAN at higher magnification as it guards against the mesophase solution infiltration during the subsequent membrane fabrication.

FIG. 25 presents a schematic of solutes in the transport experiment demonstrated by space-filling models. The geometric mean diameters derived from solute dimensions were measured from Chem3D software, or retrieved from literature, and are displayed and mapped to the corresponding molecule.

FIG. 26 illustrates the solute separation performance of the TFC membranes based on crosslinked mesophases. FIG. 26A shows an exemplary size-selective solute rejection curve for the PAN-H₁ membrane which indicates a 1-nm critical dimension; and FIG. 26B, similarly, for the PVDF-H₁ membrane, also indicates a 1-nm critical dimension. The rejection experiment was executed based on measuring the passage of single neutral solute with known sizes including polyethylene oxides (PEO) and irregular shaped small molecules. FIG. 26C illustrates the results of an exemplary rejection experiment illustrating the ubiquitous charged molecule purification capability of the crosslinked mesophases. Inset: photographs for the clear dye solution after the filtration contrast clearly with photographs for the feed solution, taken from the rejection experiment of PAN-H₁. FIG. 26D presents a survey of salt rejection studies to investigate the ionic separation functionality of the H₁ membranes. The salt solutions selected have different ion valence ratio from counterion and co-ions, but a consistent ionic strength at 10 mM. FIG. 26E illustrates the ion rejection performance of a PVDF-H₁ TFC membrane as a function of salt solution concentration using NaCl and MgCl₂ as model solutes. An induced electrostatic screening with increasing ionic strength lowered the extent of rejection. FIG. 26F illustrates a quantitative performance evaluation of PVDF-H₁ TFC (labelled H₁ in the figure) compared to other commercially available nanofiltration membranes, using feed solutions containing 200 ppm NaCl (solid symbol) or MgCl₂ (hollow symbol) as model solutes.

FIG. 27 is a schematic illustration of self-assembled OSN membranes with pore sizes tuned by tailoring the lyotropic mesophase chemistry as demonstrated in Example 3. FIG. 27A shows the chemical structure of the polymerizable surfactants and other components (PETA or HDDA crosslinkers; glycerol containing 10% water) of the mesophase. The specific mesophase compositions are tabulated. FIG. 27B Illustrates different H₁ thin films with unit cell dimensions d₁₀₀ ranging from 3.1 to 3.9 nm prepared atop ultrafiltration supports. The cylinders of the mesophase may orient vertically (cf. green cylinders) or horizontally. For parallel cylinders, the transport regulating dimension is the distance between neighboring cylinder surfaces, and this ranges from ˜0.6-1.3 nm for the 4 systems studied.

FIG. 28 shows structural characterization and dimensional analysis of different H₁ thin-films cast from 10 wt. % mesophase solutions in Example 3. FIG. 28A shows 2D-GISAXS data from samples prepared by spin-coating and cross-linking different mesophase thin-films atop either bare silicon wafers (top row) or on polyvinyl pyrrolidone (PVP, bottom row, noted with *). The GISAXS data reflect the existence of hexagonal mesophases with different orientations of the cylindrical nanostructures. FIG. 28B shows 1D GISAXS data acquired from H₁ coating on PVP-covered surfaces. FIG. 28C is a schematic showing the estimated critical dimensions for transport within the mesophases as inferred from the X-ray data for n7d*, n6d*, n6t* and n5t* systems.

FIG. 29 is a schematic illustration of the fabrication of thin mesophase-derived membranes and images of their resulting structure as described in Example 3. FIG. 29A is a schematic describing the self-assembled H₁ thin-film composite membrane fabrication process. FIG. 29B is a top-view scanning electron microscopy (SEM) images of a cross-linked n5t H₁ mesophase after thoroughly rinsing to remove the PVP sacrificial layer, and cross-sectional views of n5t, n6t, n6d, and n7d membranes atop PVDF supports after removal of PVP sacrificial layers. Selective layers are 180 nm in all cases.

FIG. 30 is data for the nanofiltration performance of the H₁ templated membranes in aqueous and organic environments in Example 3. FIG. 30A is a survey of transport performance among four H₁ membranes in DI water. The single solute rejections of 600 g mol⁻¹ polyethylene glycol (PEG) molecule are displayed with the hydraulic permeance. FIG. 30B shows pure solvent permeances. The dashed lines represent the linear regressions that derive the proportionality constant A proportional to the calculated membrane pore sizes shown in FIG. 30C. FIG. 30D shows observed solute rejection performance measured by permeating different dye molecules dissolved in methanol across the membrane at a consistent transmembrane pressure 5 bar. The observed molecular weight cut-offs (MWCOs) are located at 0.6, 0.63, 0.76 and 1.5 nm for n6t, n6d, n5t, and n7d membranes. The curves are fitted with a sigmoidal model. The methanol flux recorded during the neutral red rejection is listed with the MWCO curves.

FIG. 31 shows single solute and dual, or competitive, organic solvent nanofiltration performance from Example 3. FIG. 31A shows methanol permeance as a function of membrane thickness for H₁ membranes compared to other reported polymeric OSN membranes including polyamides (ACT-PA, PA/MOF), PIMs, rigid conjugated microporous polymers (CMP), beta cyclodextrin-terephthaloyl chloride (0-CD), cyclodextrin-trimesoyl chloride (CD-TMC), polyamide-cyclodextrin (PA-CD), and molecularly porous polyamide (MPCM). FIG. 31B shows a comparison of the methyl orange rejection and methanol permeance for the H₁ membranes to other materials in literature. FIG. 31C shows single solute rejection data of different mesophase templated membranes for acid fuchsin (AF) and methyl orange (MO) dissolved in isopropyl alcohol. FIG. 31D is UV-Vis data and photographs of the luminescent quantum dots demonstrating the n7d solute rejection in a solvent mixture of 5 to 5 (by volume) isopropyl alcohol to hexane solution. FIG. 31E is UV-visible spectrum and photograph for competitive separation of CdSe nanoparticle and AF dissolved in isopropyl alcohol, by n6d and n7d membranes.

FIG. 32 shows information from Example 4. FIG. 32A shows the molecular structures of the polymerizable surfactants with different alkane chain lengths, n=6 and n=8. Each molecule formulates the n6-CYL or n8-LAM mesophases with the cross-linking agent pentanethiol tetraacrylate (PETA) and glycerol. FIG. 32B shows 2-D GISAXS pattern of the cross-linked films cast atop silicon substrates. Both nanostructures follow a planar orientation to provide well-defined liming dimensions at 1-nm scale. FIG. 32C shows 1-D integrated SAXS data which confirms the formation of lamellar and hexagonal nanostructures at different mesophase formulations. The surfactant volume fractions (ε) and d₁₀₀ spacings are tabulated and shown. FIG. 32D shows a schematic of the membrane cross-sections with the critical dimensions determined from the 2-D X-ray analysis. The minimum transport dimension for the n8-LAM is 1.6 nm (labeled by blue sphere). Because of the planar cylinder orientation, the limiting dimension for planar n6-CYL is 0.9 nm (labeled by green sphere) instead of 1.5 nm (labeled by grey sphere).

### DETAILED DESCRIPTION

The present invention can be understood more readily by reference to the following detailed description, examples, drawings, and claims, and their previous and following description. However, it is to be understood that this invention is not limited to the specific compositions, articles, devices, systems, and/or methods disclosed unless otherwise specified, and as such, of course, can vary. While aspects of the present invention can be described and claimed in a particular statutory class, such as the composition of matter statutory class, this is for convenience only and one of skill in the art will understand that each aspect of the present invention can be described and claimed in any statutory class.

It is to be understood that the figures and descriptions of the present invention have been simplified to illustrate elements that are relevant for a clear understanding of the present invention, while eliminating, for the purpose of clarity, many other elements found in composite materials and polymeric thin films. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

While the present invention is capable of being embodied in various forms, the description below of several embodiments is made with the understanding that the present disclosure is to be considered as an exemplification of the invention, and is not intended to limit the invention to the specific embodiments illustrated. Headings are provided for convenience only and are not to be construed to limit the invention in any manner. Embodiments illustrated under any heading or in any portion of the disclosure may be combined with embodiments illustrated under the same or any other heading or other portion of the disclosure.

Any combination of the elements described herein in all possible variations thereof is encompassed by the invention unless otherwise indicated herein or otherwise clearly contradicted by context.

Unless otherwise expressly stated, it is in no way intended that any method or aspect set forth herein be construed as requiring that its steps be performed in a specific order. Accordingly, where a method claim does not specifically state in the claims or description that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of embodiments described in the specification. It is to be understood that both the foregoing general description and the following detailed description are exemplary and explanatory only and are not restrictive.

All publications mentioned herein are incorporated herein by reference to disclose and describe the methods and/or materials in connection with which the publications are cited.

As used herein, each of the following terms has the meaning associated with it in this section. Unless defined otherwise, all technical and scientific terms used herein generally have the same meaning as commonly understood by one of ordinary skill in the art to which this invention belongs.

The articles “a” and “an” are used herein to refer to one or to more than one (i.e. to at least one) of the grammatical object of the article. By way of example, “an element” means one element or more than one element.

As used herein, the term “about” will be understood by persons of ordinary skill in the art and will vary to some extent depending on the context in which it is used. As used herein when referring to a measurable value such as an amount, a temporal duration, and the like, the term “about” is meant to encompass variations of 20% or ±10%, more preferably ±5%, even more preferably +1%, and still more preferably +0.1% from the specified value, as such variations are appropriate to perform the disclosed methods.

As used herein, the terms “optional” or “optionally” mean that the subsequently described event, condition, component, or circumstance may or may not occur, and that the description includes instances where said event, condition, component, or circumstance occurs and instances where it does not.

The term “by weight,” when used in conjunction with a component, unless specifically stated to the contrary, is based on the total weight of the formulation or composition in which the component is included. For example, if a particular element or component in a composition or article is said to be present in an amount of 8% by weight, it is understood that this percentage is in relation to a total compositional percentage of 100%. In some instances, the weight percent of a component is based on the total weight of the composition “on a dry basis,” which indicates the weight of the composition without water (e.g., less than about 1%, less than about 0.5%, less than about 0.1%, less than about 0.05%, or about 0% of water by weight, based on the total weight of the composition).

As used herein, the term “mesophase” refers to the ordered phases of matter formed by anisotropic molecular or colloidal species as a function of temperature, concentration, pressure, ionic strength (salt content) or combinations thereof. The term “mesophase precursor” refers to a molecule or polymer that aggregates to form a mesophase.

As used herein, the term “H₁ mesophase” refers to the direct lyotropic mesophase composed of a hexagonally ordered array of cylindrical objects suspended in a fluid medium.

As used herein, the term “mesogen” refers to the constituents of mesophases.

As used herein, the term “liquid crystal” refers to a thermodynamic stable phase characterized by anisotropy of properties without the existence of a three-dimensional crystal lattice, generally lying in the temperature range between the solid and isotropic liquid phase.

As used herein, the term “lyotropic” refers to molecules that form phases with orientational and/or positional order in a solvent. Lyotropic liquid crystals can be formed using amphiphilic molecules (e.g., dodecyltrimethylammonium bromide, tetradecyldimethylammonium bromide, sodium laurate, phosphatidylethanolamine, lecithin). The solvent can be water.

As used herein, the term “nanopore” or “nanochannel” refers to a pore, channel or passage formed or otherwise provided in a membrane. A nanopore may have a characteristic width or diameter in a range of 0.1 nanometers to about 1000 nm. Correspondingly, a nanochannel may have a characteristic critical separation dimension in a range of 0.1 nanometers to about 1000 nm.

As used herein, the term “critical separation dimension,” refers to the smallest dimension through which solutes must pass to transit the membrane, and which therefore is one of the principal determinants of the membrane selectivity.

Herein, the terms permeance and permeation rate are used interchangeably.

As used herein, the term “monomer,” refers to any molecule that can be polymerized, that is, linked together via a chemical reaction to form a higher molecular weight species.

As used herein, the term “polymer” denotes a covalently bonded chain of monomer units, and is intended to include both homopolymers and copolymers.

As used herein, the term “initiator,” refers to a substance introduced into a reaction system in order to bring about a reaction or process generating free radicals or some other reactive reaction intermediates which then induce a chain reaction.

As used herein, the term “photoinitiator,” refers to a substance capable of inducing the polymerization of a monomer by a free radical or ionic chain reaction initiated by photoexcitation.

The term “crosslinker” refers to compounds that are able to react with the functional group or groups on the polymer chains to lengthen them and/or connect them, e.g., to form a crosslinked network like that of a cured elastomer.

As used herein, the term “AETDAB” refers to [2-(acryloyloxy) ethyl] tetradecyl dimethyl ammonium bromide. The term “METDAB” refers to [2-(methacryloyloxy) ethyl] tetradecyl dimethyl ammonium bromide.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range. Further, for lists of ranges, including lists of lower preferable values and upper preferable values, unless otherwise stated, the range is intended to include the endpoints thereof, and any combination of values therein, including any minimum and any maximum values recited.

### DESCRIPTION

As described herein, the present invention relates in part to the facile and scalable synthesis of thin polymer films containing oriented nanopores or nanochannels.

In an embodiment, the present invention relates to a small molecule separation membrane comprising a thin film described herein. Prior art approaches and current commercial separation membranes suffer from large pore size distributions and tortuosity which hinder performance and have proven challenging to overcome.

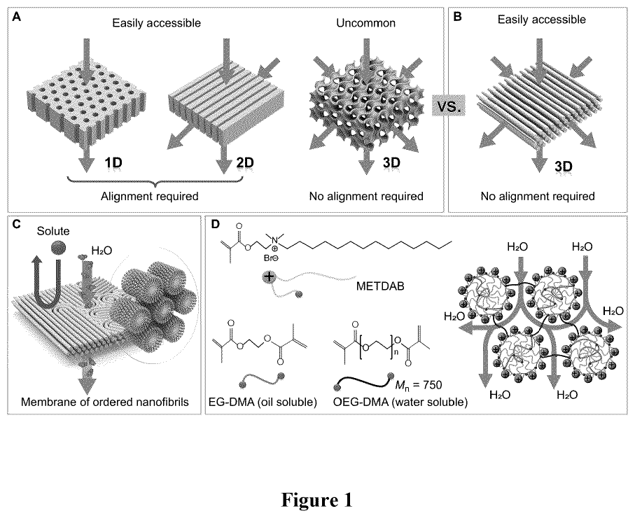

FIG. 1A illustrates schematically three types of nanostructure that have previously been obtained via self-assembly of block copolymers or small molecule liquid crystals. Nanostructures such as lamellae and cylinders require alignment of the self-assembled domains in order to be effective as nanopores. However, such optimized morphologies do not spontaneously occur during membrane fabrication processes. Also shown, 3-D interconnected gyroids are not universally observed in block copolymer and liquid crystal (LC) systems, and where they occur, usually exhibit narrow windows of stability.

FIG. 1B shows a proposed morphology for fabricating membranes that may be easily templated from mesophases of hexagonally packed cylinders and requires no alignment to enhance flux. FIG. 1C is a schematic illustration depicting a potential mode of exclusion for some molecular species based on size for a fabricated membrane prepared for use as a size exclusion nanofiltration membrane.

As described further herein, FIG. 1D contemplates the use of crosslinking of a direct hexagonal cylinder lyotropic mesophase (H₁) to lock in the desired nanostructure in preparing a membrane for use as a size exclusion nanofiltration membrane. FIG. 1D shows the molecular structures of the polymerizable surfactant 2-(methacryloyloxy)ethyl tetradecyl dimethyl ammonium bromide (METDAB), the water soluble crosslinker oligo(ethylene glycol) dimethacrylate (OEG-DMA) and the oily crosslinker ethylene glycol dimethacrylate (EG-DMA) for the formulation of the desired H₁ mesophase. EG-DMA copolymerizes with the surfactant in the hydrophobic core, and water soluble OEG-DMA bridges each cylinder into a network, the morphology of which provides a continuous aqueous transport path, as schematically illustrated. (Mn is the number average molecular weight of the OEG-DMA).

In one embodiment, the invention relates to a nanofiltration membrane or composite thin film having both high permeation rates and a high selectivity for certain molecular species. One objective includes providing thin films for which permeation rates and selectivity are controlled via the film nanostructure. Described herein are polymer thin films and methods to produce such films, wherein the films comprise a nanostructure that is locked in place (for example, by crosslinking) from the nanostructure provided by the LC mesophase.

In an embodiment, the present invention provides a polymer membrane, film or coating comprising a layer having a first surface, a second surface and a film thickness therebetween, and comprising cylindrical polymer fibers at least partially ordered as hexagonal packed cylinders within the film, aligned parallel to the film surface, and present as an H₁ mesophase; wherein the cylinders are crosslinked internally within the cylinders; and wherein the cylinders are spatially arranged to provide channels between the cylinders for fluid flow through the membrane, film or coating.

In an embodiment, the invention further provides a thin film composite membrane comprising: (i) the above polymer membrane, film or coating; and (ii) a porous support layer in contact with the polymer membrane, film or coating.

In an embodiment, the invention further provides a nanofiltration device comprising the thin film composite membrane disclosed herein.

In an embodiment, the invention further provides a method of producing a thin film composite membrane, said method comprising the steps of: providing a porous support layer, and, optionally, an adjacent layer in contact with the porous support layer; depositing a solution comprising at least one polymerizable mesophase precursor on the porous support layer or adjacent layer, wherein the solution has a water and/or solvent content; forming a mesophase on the porous support layer or adjacent layer, optionally, by reducing the water and/or solvent content; and polymerizing and crosslinking the mesophase precursor to form a polymer membrane, film or coating comprising cylindrical polymer fibers at least partially ordered as hexagonal packed cylinders within the film, aligned parallel to the film surface, and present as an H₁ mesophase; wherein the cylinders are crosslinked internally within the cylinders; and wherein the cylinders are spatially arranged to provide channels between the cylinders for fluid flow through the thin film composite membrane.

Further, in certain embodiments, the invention provides thin film composite membranes formed by the methods disclosed herein.

As contemplated herein, a LC mesophase is formed from the self-assembly of one or more mesogens. In one embodiment, the mesogen is a monomer. In one embodiment, the mesogen is a surfactant monomer. In certain embodiments, the LC mesophase may be a single-component material. In other embodiments, the mesophase may comprise one or more photoinitiators or other chemical constituents. In certain embodiments, the mesophase may be multicomponent, having tunable physicochemical properties. In other embodiments, the mesophase may be anisotropic, lyotropic, thermotropic and/or metallotropic.

In an embodiment, the mesophase comprises at least one monomer. In one embodiment, the mesogen is itself a monomer, capable of being reacted to form a polymer. In one embodiment, the monomer is amphiphilic, such as, for example, a surfactant monomer. As used herein, the term “amphiphilic” refers to a compound which has at least one hydrophilic moiety and at least one hydrophobic moiety.

In an embodiment, the monomer may comprise at least one polar group such as hydroxyl, carboxyl, sulfonate, phosphate, amino or any salts thereof, and at least one non-polar group such as n-alkyl, branched alkyl, alkenyl, or alkynyl. In an embodiment, the monomer contains one or more polymerizable constituents. The monomer may be synthetic, organic, or any other type of polymerizable monomeric molecule.

In an embodiment, the monomer comprises a type of polymerizable group. A polymerizable group is a chemical moiety that polymerizes under certain chemical conditions. In general, the type of polymerizable group is not critical, so long as the polymerizable group is capable of polymerization with a monomer of the instant invention. Examples of polymerizable groups include double-bond containing moieties which are polymerized by photopolymerization or free radical polymerization. In some embodiments, the polymerizable group is a vinyl group, acryl group, alkylacryl group (i.e. acryl group having an alkyl substituent, such as methacryl). As used herein, acryl (alkylacryl, methacryl, etc) includes acryl esters as well as acryl amides. In an embodiment, the monomer may be any alkyl methacrylate. In an embodiment, the monomer may be styrene, vinyl acetate, vinyl pyridine, n-isopropylacrylamide or a vinyl ether. In one embodiment, the monomer is a surfactant monomer. In one embodiment, the monomer is a polymerizable surfactant monomer of the formula [Z—N⁺(R₁)(R₂)(R₃)]X⁻, wherein Z comprises a polymerizable group; X is a salt counter anion, such as, for example, halide; R₁, R₂, and R₃ are alkyl groups which are bound to N that independently may be the same or different; and at least one of R₁, R₂, and R₃ is an alkyl group comprising at least 10 carbon atoms. In one embodiment, the monomer is [2-(acryloyloxy) ethyl] tetradecyl dimethyl ammonium bromide (“AETDAB”). In an embodiment, the monomer is [2-(methacryloyloxy) ethyl] tetradecyl dimethyl ammonium bromide (“METDAB”). In an embodiment, the monomer is 2-(acryloyloxy)ethyl octadecyl dimethyl ammonium bromide (“AEODAB”).

As described herein, these surfactant monomers are amphiphilic molecules possessing a large hydrophobic body and a small hydrophilic head, capable of forming hexagonal packed cylindrical polymer fibers in LC mesophases with closely-packed, ordered nanochannels. Exemplary hydrophilic moieties which can form the hydrophilic head include imidazolium, phosphonium, a zwitterion, sulfonic acid, acrylamido ammonium, glycerol, and ethylene glycerol. Exemplary hydrophobic moieties which can form the hydrophobic tail include diene, vinyl diene fluoride, and tetrafluoroethane. It is further contemplated that the polymerizable mesophase precursor may have a hydrophobic head and a hydrophilic tail. It is also contemplated that mixture of monomers having a specified head type (hydrophobic or hydrophilic) and a specified tail type (hydrophobic or hydrophilic) can be used. For example, a mixture of monomers having a phosphonium containing head and differing hydrophobic tails could be employed. In some embodiments the chain length of the tail is manipulated in order to obtain the desired membrane morphology and pore size.

The surfactant monomers are polymerizable mesophase precursors. Moreover, the reactive acrylate groups at the periphery of the monomer enables structural lock-in of the hexagonal packed cylinder order by photo-crosslinking into a mechanically and chemically robust polymer. Furthermore, as described herein, the presence of a quaternary ammonium salt (N⁺R₄—X⁻, where the four R groups are alkyl or substituted alkyl groups that may be the same or different, and X is a salt counter anion such as halide) in the monomer molecular structure may provide anti-biofouling properties.

Depending on conditions, a particular monomer may be capable of existing in a different LC mesophase type. In one embodiment, the monomer self-assembles into a hexagonal cylinder LC mesophase (H₁) at room temperature. In an embodiment, the monomer self-assembles into an H₁ mesophase in the presence of solvent or water. In an embodiment, the monomer self-assembles into an H₁ mesophase in the absence of solvent or water. Non-limiting examples of other LC mesophases include cubic, reverse hexagonal, lamellar, and reverse micellar. Upon self-assembled alignment, these cylinders may form nanochannels within the mesophase.

In an embodiment, the monomer is a natural or unnatural unsaturated fatty acid. Unsaturated fatty acids possess a carboxylic acid head group and a long aliphatic chain with one or more alkene groups. Examples of unsaturated fatty acids include, but are not limited to, 3-hexenoic acid, trans-2-heptenoic acid, 2-octenoic acid, 2-nonenoic acid, cis- and trans-4-decenoic acid, 9-decenoic acid, 10-undecenoic acid, trans-3-dodecenoic acid, tridecenoic acid, cis-9-tetradeceonic acid, pentadecenoic acid, cis-9-hexadecenoic acid, trans-9-hexadecenoic acid, 9-heptadecenoic acid, cis-6-octadecenoic acid, trans-6-octadecenoic acid, cis-9-octadecenoic acid, trans-9-octadecenoic acid, cis-11-octadecenoic acid, trans-11-octadecenoic acid, cis-5-eicosenoic acid, cis-9-eicosenoic acid, cis-11-docosenoic acid, cis-13-docosenoic acid, trans-13-docosenoic acid, cis-15-tetracosenoic acid, cis-17-hexacosenoic acid, and cis-21-triacontenoic acids, as well as 2,4-hexadienoic acid, cis-9-cis-12-octadecadienoic acid, cis-9-cis-12-cis-15-octadecatrienoic acid, eleostearic acid, 12-hydroxy-cis-9-octadecenoic acid, and the like. In one embodiment, the monomer is conjugated linoleic acid (CLA).

In an embodiment, the monomer is an epoxidized fatty acid. Epoxidized fatty acids are fatty acids that have been treated with a chemical agent to convert internal alkenes into epoxide moieties. Fatty acids suitable for epoxidation include, but are not limited to, all fatty acids discussed herein. In one embodiment, the epoxidized fatty acids are polymerized with reagents known to those of skill in the art. Epoxidized fatty acid polymerizing agents include, but are not limited to, aliphatic amines, aromatic amines, polyamide resins, tertiary and secondary amines, imidazoles, polymercaptans, polysulfide resins, anhydrides, boron trifluoride-amine complexes, dicyandiamide, organic acid hydrazides, as well as photo- and ultraviolet light polymerizations.

The mesophase may also include one or more initiators and/or crosslinkers, depending on the mechanism and the amount of polymerization and crosslinking desired. As contemplated herein, any type of initiator and/or crosslinker may be used as would be understood by those skilled in the art.

Examples of initiators include, but are not limited to, thermal initiators, photoinitiators, redox reaction initiators, persulfates, ionizing radiation initiators, and ternary initiators. Other photoinitiators and thermal initiators include those based on benzophenones as well as those based on peroxides. In an embodiment, the initiator is a photoinitiator.

In an embodiment, the initiator is an organic photoinitiatior. In an embodiment, the photoinitiator is acetophenone. Non-limiting examples of photoinitiators include 2-benzyl-2-(dimethylamino)-4′-morpholinobutyrophenone, 4′-tert-butyl-2′,6′-dimethylacetophenone, 2,2-diethoxyacetophenone, 2-methoxy-2-phenylacetophenone, 2,2-dimethoxy-2-phenylacetophenone, diphenyl(2,4,6-trimethylbenzoyl)phosphine oxide/2-hydroxy-2-methylpropiophenone blend, 4′-ethoxyacetophenone, 3′-hydroxyacetophenone, 4′-hydroxyacetophenone, 1-hydroxycyclohexyl phenyl ketone, 2-hydroxy-4′-(2-hydroxyethoxy)-2-methylpropiophenone, 2-hydroxy-2-methylpropiophenone, 2-methyl-4′-(methylthio)-2-morpholinopropiophenone, 4′-phenoxyacetophenone, benzoin, benzoin ethyl ether, benzoin methyl ether, 4,4′-dimethoxybenzoin, 4,4′-dimethylbenzil, benzophenone, benzophenone-3,3′,4,4′-tetracarboxylic dianhydride, 4-benzoylbiphenyl, 4,4′-bis(diethylamino)benzophenone, 4,4′-bis[2-(1-propenyl)phenoxy]benzophenone, 4-(diethylamino)benzophenone, 4,4′-dihydroxybenzophenone, 4-(dimethylamino)benzophenone, 3,4-dimethylbenzophenone, 3-hydroxybenzophenone, 4-hydroxybenzophenone, 2-methylbenzophenone, 3-methylbenzophenone, 4-methylbenzophenone, methyl benzoylformate, Michler's ketone (4,4′-bis(dimethylamino)benzophenone), bis(4-tert-butylphenyl)iodonium perfluoro-1-butanesulfonate, bis(4-tert-butylphenyl)iodonium p-toluenesulfonate, bis(4-tert-butylphenyl)iodonium triflate, boc-methoxyphenyldiphenylsulfonium triflate, (tert-butoxycarbonylmethoxynaphthyl)-diphenylsulfonium triflate, (4-tert-butylphenyl)diphenylsulfonium triflate, diphenyliodonium hexafluorophosphate, diphenyliodonium nitrate, diphenyliodonium perfluoro-1-butanesulfonate, diphenyliodonium p-toluenesulfonate, diphenyliodonium triflate, (4-fluorophenyl)diphenylsulfonium triflate, n-hydroxynaphthalimide triflate, n-hydroxy-5-norbornene-2,3-dicarboximide perfluoro-1-butanesulfonate, (4-iodophenyl)diphenylsulfonium triflate, (4-methoxyphenyl)diphenylsulfonium triflate, 2-(4-methoxystyryl)-4,6-bis(trichloromethyl)-1,3,5-triazine, (4-methylphenyl)diphenylsulfonium triflate, (4-methylthiophenyl)methyl phenyl sulfonium triflate, 1-naphthyl diphenylsulfonium triflate, (4-phenoxyphenyl)diphenylsulfonium triflate, (4-phenylthiophenyl)diphenylsulfonium triflate, triarylsulfonium hexafluoroantimonate salts, triarylsulfonium hexafluorophosphate salts, triphenylsulfonium perfluoro-1-butanesufonate, triphenylsulfonium triflate, tris(4-tert-butylphenyl)sulfonium perfluoro-1-butanesulfonate, tris(4-tert-butylphenyl)sulfonium triflate, anthraquinone-2-sulfonic acid, 2-tert-butylanthraquinone, camphorquinone, diphenyl(2,4,6-trimethylbenzoyl)phosphine oxide, 9,10-phenanthrenequinone, phenylbis(2,4,6-trimethylbenzoyl)phosphine oxide, 1-chloro-4-propoxy-9h-thioxanthen-9-one, 2-chlorothioxanthen-9-one, 2,4-diethyl-9h-thioxanthen-9-one, isopropyl-9h-thioxanthen-9-one, 10-methylphenothiazine, and thioxanthen-9-one. In one embodiment, the photoinitiator is 2-methoxy-2-phenylacetophenone. In one embodiment, the photoinitiator is 2,4,6-trimethylbenzoyl-diphenylphosphine oxide (Darocur TPO). In one embodiment, the photoinitiator is benzoin methyl ether.

In some embodiments, the initiator is a thermal initiator. In a non-limiting example, the thermal initiator polymerizes the monomer upon exposure to heat, as would be understood by one of ordinary skill in the art. Examples of thermal initiators include, but are not limited to, azo compounds, peroxides and persulfates. Suitable persulfates include, but are not limited to, sodium persulfate and ammonium persulfate.

Suitable azo compounds include, but are not limited to, non-water-soluble azo compounds, such as 1-1′-azobiscyclohexanecarbonitrile, 2-2′-azobisisobutyronitrile, 2-2′-azobis (2-methylbutyronitrile), 2-2′ azobis (propionitrile), 2-2′-azobis (2, 4-dimethylvaleronitrile), 2-2′ azobis (valeronitrile), 2-(carbamoylazo)-isobutyronitrile and mixtures thereof; and water-soluble azo compounds, such as azobis tertiary alkyl compounds, including 4-4′-azobis (4-cyanovaleric acid), 2-2′-azobis (2-methylpropionamidine) dihydrochloride, 2, 2′-azobis [2-methyl-N-(2-hydroxyethyl) propionamide], 4,4′-azobis (4-cyanopentanoic acid), 2,2′-azobis (N, N′-dimethyleneisobutyramidine), 2,2′-azobis (2-amidinopropane) dihydrochloride, 2,2′-azobis (N, N′-dimethyleneisobutyramidine) dihydrochloride and mixtures thereof.

Suitable peroxides include, but are not limited to, hydrogen peroxide, methyl ethyl ketone peroxides, benzoyl peroxides, di-t-butyl peroxides, di-t-amyl peroxides, dicumyl peroxides, diacyl peroxides, decanol peroxide, lauroyl peroxide, peroxydicarbonates, peroxyesters, dialkyl peroxides, hydroperoxides, peroxyketals and mixtures thereof.

Examples of crosslinkers include, without limitation, polycarboxylic acids, polyamines, polyisocyanates, polyepoxides, and polyhydroxyl containing species. Other crosslinkers include bi- and multifunctional vinyl ethers, acrylamides and acrylates. Exemplary crosslinkers include 1,3,5-triallyl-1,3,5-triazine-2,4,6(1H,3H,5H)-trione (also referred to as triallylisocyanurate) triallyl cyanurate, diallyl bispheiol A, diallylether bisphenol A, triethyleneglycol divinyl ether, 1,4-bis(4-vinylphenoxy)butane, cyclohexanedimethanol divinyl ether, multi-functional norbornene monomers prepared by reaction of multifunctional acrylates with cyclopentadiene, norbornadiene, 1,2,4˜benzenetricarboxylic acid tris[4-(ethenyloxy)butyl]ester, vinylcyclohexene, 1,2,4-trivinylcyclobexane, diallyl malate, diallyl monoglycol citrate, allyl vinyl malate, glycol vinyl allyl citrate, monoglycol monoallyl citrate, monoglycol monoallyl fumarate, N,N-methylene-bismethacrylamide, diethylene, glycol dimethacrylate, glycerine trimethacrylate, and the like. In one embodiment, the crosslinker is divinylbenzene. In one embodiment, the crosslinker is 1,6-hexanediol diacrylate (HDDA). The length of the alkylene chain in this type of crosslinker is not particularly limited. In one embodiment, the crosslinker is ethylene glycol dimethacrylate (EGDMA). In one embodiment, the crosslinker is poly(ethylene glycol)-400 dimethacrylate. The length of the ethylene glycol chain in this type of crosslinker is not particularly limited. In one embodiment, the crosslinker is poly(ethylene glycol)-x dimethacrylate, where x denotes an approximate molecular weight of the poly(ethylene glycol) fragment. In one embodiment, the crosslinker is oligo(ethylene glycol) dimethacrylate, OEG-DMA. In one embodiment, the crosslinker is pentanethiol tetraacrylate (PETA).

In some embodiments, one or more crosslinkers may be used in combination. In an embodiment, two types of crosslinker are used in an aqueous system: one “oily” crosslinker (more hydrophobic, such as EG-DMA), which partitions into the core of the cylindrical micelles (along with the hydrophobic tails of the amphiphilic monomer) and effects crosslinking within the interior of the cylindrical micelles (forming internally crosslinked cylindrical polymer fibers); and one hydrophilic crosslinker (such as OEG-DMA) which stays in the aqueous region outside of the cylindrical micelles and effects crosslinking between the neighboring cylindrical micelles (forming linkages between adjacent cylindrical polymer fibers). In an embodiment, a single type of crosslinker is used in an aqueous system, which is a hydrophobic crosslinker (forming internally crosslinked cylindrical polymer fibers). In an embodiment, a single type of crosslinker is used in an aqueous system, which is a hydrophilic crosslinker (forming linkages between adjacent cylindrical polymer fibers). Similarly, either a single type of crosslinker or dual type of crosslinking may be employed for solvent mesophase solutions.

In an embodiment, the polymer, membrane, film or coating has no inter-cylinder crosslinking to connect neighboring cylindrical polymer fibers.

In an embodiment, a solution comprising at least one polymerizable mesophase precursor (for example, surfactant monomer), and optionally at least one initiator, in a solvent, is deposited on a surface of a substrate, optionally with removal of some or all solvent, to form a LC mesophase of the invention. In an embodiment, the solvent is water. In an embodiment, the solvent is an organic solvent. Non-limiting examples of organic solvents include tetrahydrofuran (THF), xylene (ortho, meta, or para), methanol, ethanol, isopropanol, acetone, ethyl acetate, ethylene glycol, glycerol, acetonitrile, 1,4-dioxane, dimethylformamide, N-methyl pyrrolidone, hexane, hexene, octane, pentane, cyclohexane, iso-octane, and 1-hexene. In an embodiment, the solvent is tetrahydrofuran. In an embodiment, the solvent is glycerol. The thickness of the mesophase may be adjusted by varying the concentration of the monomer in the solution and by the amount of solution deposited on the substrate. In an embodiment, the step of depositing the monomer solution on the substrate comprises the step of spin coating from an organic solvent solution. In an embodiment, the organic solvent for spin coating may be selected from any of the solvents listed above. In an embodiment, the organic solvent for spin coating is selected from ethylene glycol, glycerol, ethyl acetate, ethanol, methanol, isopropanol, acetonitrile, tetrahydrofuran, 1,4-dioxane, acetone, dimethylformamide, or N-methyl pyrrolidone. In an embodiment, the organic solvent for spin coating is selected from ethylene glycol, glycerol, ethyl acetate. In an embodiment, the mesophase may include one or more other solvents, such as water, as would be understood by those skilled in the art. Upon deposition of the solution onto the surface of the substrate, the monomer may self-assemble into supramolecular cylinders, forming channels within the mesophase. The formation of the mesophase may be facilitated by, or may require, the removal of at least a portion of the solvent from the monomer solution.

The substrate may be formed from any material that would permit the formation of a LC mesophase upon its surface. In some embodiments, the substrate is a silicone elastomer substrate. In an embodiment, the silicone elastomer is polydimethylsiloxane (PDMS). Non-limiting examples of other polysiloxanes include polydiethylsiloxane, polydiphenylsiloxane, polymethylvinylsiloxane, polyethylvinylsiloxane, polyphenylvinylsiloxane, polyethylmethylsiloxane, polymethylphenylsiloxane, and polyethylmethylsiloxane. In an embodiment, the substrate is a PDMS substrate. In an embodiment, the substrate is a glass substrate. In an embodiment the substrate is Kapton® (DuPont de Nemours, Wilmington, DE, USA). In an embodiment the substrate is a silicon wafer. In an embodiment the substrate is composed of a polymeric material such as polyacrylonitrile, polyvinylidene fluoride, polyacrylic acid or polyvinylalcohol.

In an embodiment, the substrate may be a porous substrate. In an embodiment, the amphiphilic monomer may be polymerized and crosslinked to form a polymer membrane, which may be deposited on, or attached to, a porous substrate to form a composite membrane. Alternatively, the amphiphilic monomer may be deposited on a porous substrate and then polymerized and crosslinked to form a polymer membrane thereby forming a composite membrane. The porous substrate in such composite membranes is sometimes referred to as a porous support layer because it provides further mechanical stability and strength to the polymer membrane. The porous substrate in a composite membrane may or may not be polymeric. A porous polymer substrate of this type may be referred to as a porous polymer support layer. In an embodiment, the composite membrane is, or is a component of, a separation or filtration membrane. As a component of a separation or filtration membrane, the porous support layer is typically a more porous material than the membrane so that the permeation rate through the porous support layer does not limit the permeation rate through the composite membrane. In an embodiment, the porous support layer is composed of a material such as polyacrylonitrile, polyvinylidene fluoride, polysulfone, polyamide, polyimide, polypropylene, anodized aluminum oxide, cellulose acetate, or nonwoven fabric. In an embodiment, the porous support layer is composed of a polymeric material such as polyacrylonitrile or polyvinylidene fluoride.

In one embodiment, the substrate is treated with a chemical agent to modify its surface properties. In one embodiment, the surface agent is poly(sodium 4-styrenesulfonate (PSS). In one embodiment, the chemical agent is applied using spin-coating. In an embodiment, the surface agent is octadecyltrimethoxysilane (OTMS). In one embodiment, the chemical agent is applied by exposing the surface to a vapor of the chemical agent.

As discussed further herein, spin-coating the mesophase solution directly on a porous support may contribute a significant hydraulic resistance at the interface, leading to lower hydraulic permeance. In an embodiment, a stimuli-perishable polymeric layer, which acts as a sacrificial layer, may be deposited on the porous support, and is utilized in concert with deposition of the mesophase solution. The mesophase solution may be spin-coated onto the sacrificial layer, which temporarily supports the solution film, and therefore suppresses the solvent infiltration into the porous support. After polymerization of the mesophase solution, the sacrificial layer may be removed, for example by dissolving in an appropriate solvent, leaving the polymerized mesophase layer atop the porous support.

In one embodiment, the substrate comprises a layer of a dissolvable material which can be selectively removed from the film by dissolution in a solvent, or a solution of weak acid or weak base. Non-limiting examples of dissolvable materials include polyacrylic acid, polyvinyl alcohol, polyvinylpyrrolidone or a layer of chitosan or a layer of dextran. In one embodiment, the solvent for dissolving the sacrificial layer is water. In an embodiment, the solvent for dissolving the sacrificial layer is an organic solvent.

The mesophase may be of any volume, and is not limited to any particular geometry. Thus, the mesophase may take the shape and size of any substrate, mold, or container in order to produce, upon polymerization, a polymerized structure of desired geometry. For example, in one embodiment, the mesophase is shaped to form a thin-film polymer.

In one embodiment, the solvent is reduced or removed from the mesophase prior to polymerization. This may be accomplished, for example, by passing a stream of a gas or air over the mesophase surface, or by allowing the mesophase to remain exposed to air such that the solvent evaporates over time.

Polymerization

After alignment of the mesophase system, the system may be polymerized to form a polymer film having aligned or oriented channels therein. Polymerization may be performed via thermal polymerization, free radical polymerization, catalyst induced polymerization, or any other polymerization technique as would be understood by those skilled in the art. In certain embodiments, the polymerization is free radical polymerization. In an embodiment, the step of polymerizing the polymerizable mesophase precursor is performed by exposure to UV light.

In certain embodiments, the resulting polymer film may include a well-maintained alignment of structures substantially parallel to the film surface. In an embodiment, cylindrical polymer fibers, and also the channels between the fibers, preferably are aligned parallel to the film surface, and therefore perpendicular to the macroscopic transport direction. As discussed above, the mesophase solution may be deposited onto a substrate, in which case the film forms on the substrate (or on a sacrificial layer on the substrate). Such multilayer systems are generally referred to as composites, and in the case of thin layers these are referred to as thin film composites. In an embodiment, a thin film composite membrane comprises a polymer film formed from the mesophase and a porous support layer in contact with the polymer film. In an embodiment, the invention further provides a nanofiltration device comprising the thin film composite membrane described herein.

In certain embodiments, the mesophase may include an amount of monomer of from 1% to 99%, such as from 5% to 95%, 10% to 90%, 15% to 85%, 20% to 80%, 25% to 75%, 30% to 70%, 35% to 65%, 40% to 60%, or 45% to 55%, where the percentage is based on weight of monomer as a percentage of weight of the mesophase. In some embodiments, the monomer is the mesogen, and the mesophase is comprised almost exclusively of the monomer with a small amount of initiator.

In certain embodiments, the mesophase may not include any photoinitiator. In other embodiments, the mesophase may include an amount of photoinitiator in an amount of from 0.01% to 6%, such as from 0.02% to 5%, 0.03% to 4%, 0.04% to 3%, 0.05% to 2%, 0.06% to 1%, 0.08% to 0.9%, 0.09% to 0.8%, 0.1% to 0.6%, 0.2% to 0.5%, or 0.3% to 0.4%, where the percentage is based on weight of photoinitiator as a percentage of weight of the mesophase. In an embodiment, the mesophase includes about 0.04% to 1%, or 0.02% to 2%, or 0.02% to 1%, or 0.02 to 0.06% of photoinitiator by weight. In one embodiment, the mesophase includes about 0.04% of photoinitiator by weight.

In certain embodiments, the mesophase may not include any crosslinker. In other embodiments, the mesophase may include an amount of crosslinker equal to about 0.1% to 12%, such as from 0.4% to 10%, 0.5% to 8%, 0.7% to 6%, 0.8% to 5%, 0.9% to 4%, 1% to 3%, or 1.2% to 2%, where the percentage is based on weight of crosslinker as a percentage of weight of the mesophase. In an embodiment, the mesophase includes about 2% to 8%, or 2% to 6% of crosslinker by weight. In one embodiment, the mesophase includes about 4% of crosslinker by weight.

The mesophase is preferably in the form of a thin film of substantially constant thickness. In some embodiments, the thin film has a thickness ranging from about 10 nm to 500 μm. In other embodiments, the thin film has a thickness ranging from about 10 nm to 20 μm, or from about 10 nm to 10 μm. In an embodiment, the thickness of the thin film is from about 20 nm to 1 μm, such as from 50 nm to 750 nm, or from 50 nm to 500 nm, or from 50 nm to 400 nm, or from 50 nm to 360 nm, or 50 nm to 300 nm, or 50 nm to 250 nm, or 50 nm to 200 nm, or 75 nm to 150 nm. In an embodiment, the thickness of the thin film is from 75 nm to 400 nm, or from 75 nm to 250 nm. The influence of the thickness on the alignment can be readily understood in the context of the finite elasticity of the medium, which specifies the distance over which the memory of a given orientation will decay under thermal forces. That is, the length scale where the elastic energy due to a non-uniform orientation of the LC director is less than or equal to k_{B}T. This length scale can be considered in a dimensionally consistent manner, as a persistence length λ defined by the ratio of an effective bending rigidity of the mesophase K_{eff} and k_{B}T, where the effective bending rigidity originates from the elasticity of the mesophase. The quality of the alignment then decays exponentially with distance z from the interface, as captured by the tilt away from the boundary condition, cos θ=α^{-z/λ}.

In certain embodiments, the polymer membrane, film or coating has a water permeation rate of at least 1 L m⁻² h⁻¹ bar⁻¹, such as, for example, at least 2 L m⁻² h⁻¹ bar⁻¹, or at least 5 L m⁻² h⁻¹ bar⁻¹, or at least 10 L m⁻² h⁻¹ bar⁻¹, or at least 20 L m⁻² h⁻¹ bar⁻¹, or even greater than 50 L m⁻² h⁻¹ bar⁻¹, or even greater than 100 L m⁻² h⁻¹ bar⁻¹. For example, in certain embodiments, the polymer membrane, film or coating has a film thickness of from 50 nm to 360 nm, or 50 nm to 300 nm, or 50 nm to 250 nm, or 50 nm to 200 nm, or 75 nm to 150 nm, and a water permeation rate of at least 1 L m⁻² h⁻¹ bar⁻¹, at least 2 L m⁻² h⁻¹ bar⁻¹, such as, for example, at least 5 L m⁻² h⁻¹ bar⁻¹, or at least 10 L m⁻² h⁻¹ bar⁻¹, at least 20 L m⁻² h⁻¹ bar⁻¹, or even greater than 50 L m⁻² h⁻¹ bar⁻¹, or even greater than 100 L m⁻² h⁻¹ bar⁻¹, or from 1-100 L m⁻² h⁻¹ bar⁻¹, or from 1-50 L m⁻² h⁻¹ bar⁻¹, or from 2-50 L m⁻² h⁻¹ bar⁻¹, such as, for example, from 2-30 L m⁻² h⁻¹ bar⁻¹, or from 2-10 L m⁻² h⁻¹ bar⁻¹.

Preferably, the thin film has channels having a critical separation dimension ranging from about 0.1 nm to 10 nm. In an embodiment, the critical separation dimension is between 0.5 and 2 nm, or between 0.5 and 1.5 nm, or between 0.5 nm and 1.2 nm, or between 0.5 nm and 1.1 nm. In one embodiment, the critical separation dimension is between 0.1 and 1.5 nm, or between 0.8 and 1.2 nm, or between 0.8 and 1.1 nm. In one embodiment, the critical separation dimension is about 1 nm.

The low size dispersity of the transport-regulating features (channels having critical separation dimension described above) are a key element of the invention. The thin films have channels of substantially uniform size. By “substantially uniform” it is meant that at least 75%, for example 80% to 95%, of channels have critical separation dimensions to within 30%, within 10%, or within 5%, of the average critical separation dimension. More preferably, at least 85%, for example 90% to 95%, of channels have critical separation dimension to within 30%, or within 10%, and within 5%, of the average critical separation dimension.

Method of Producing a Thin Film Composite Membrane

In an embodiment, the invention provides a method of producing a thin film composite membrane, said method comprising the steps of: providing a porous support layer, and, optionally, an adjacent layer in contact with the porous support layer; depositing a solution comprising at least one polymerizable mesophase precursor on the porous support layer or adjacent layer, wherein the solution has a water and/or solvent content; forming a mesophase on the porous support layer or adjacent layer, optionally, by reducing the water and/or solvent content; and polymerizing and crosslinking the mesophase precursor to form a polymer membrane, film or coating comprising cylindrical polymer fibers at least partially ordered as hexagonal packed cylinders within the film, aligned parallel to the film surface, and present as an H₁ mesophase; wherein the cylinders are crosslinked internally within the cylinders; and wherein the cylinders are spatially arranged to provide channels between the cylinders for fluid flow through the thin film composite membrane.

In one embodiment of the method, the polymerizable mesophase precursor is a polymerizable surfactant. In one such embodiment, the polymerizable mesophase precursor is a polymerizable surfactant of the formula [Z—N⁺(R₁)(R₂)(R₃)]X⁻, wherein Z comprises a polymerizable group; X is a salt counter anion; R₁, R₂, and R₃ are alkyl groups which are bound to N that independently may be the same or different; and at least one of R₁, R₂, and R₃ is an alkyl group comprising at least 10 carbon atoms. In an embodiment, the polymerizable mesophase precursor is [2-(acryloyloxy) ethyl] tetradecyl dimethyl ammonium bromide (AETDAB). In an embodiment, the polymerizable mesophase precursor is [2-(methacryloyloxy) ethyl] tetradecyl dimethyl ammonium bromide (METDAB).

In an embodiment of the method, the solution further comprises a photoinitiator. Any photoinitiator known in the art may be used, although the level of usage may be critical. In an embodiment, the photoinitiator is 2,4,6-trimethylbenzoyl-diphenylphosphine oxide or 2-methoxy-2-phenylacetophenone at a level of from about 0.01-4 wt. %, or from about 0.02-2.0 wt. %, based on the weight of initiator as a percentage of the weight of the mesophase.

In an embodiment of the method, the step of polymerizing the polymerizable mesophase precursor is performed by exposing it to UV light.

In an embodiment of the method, the step of polymerizing the polymerizable mesophase precursor is performed in the presence of one or more crosslinker. In an embodiment, the crosslinker effects crosslinking internally within the cylindrical polymer fibers. In an embodiment, the crosslinker effects inter-cylinder crosslinking to connect neighboring cylindrical polymer fibers. In an embodiment, no inter-cylinder crosslinking exists to connect neighboring cylindrical polymer fibers.

In an embodiment of the method, the channels between the cylinders provide a critical separation dimension of less than about 1.5 nm for fluids or fluid/solute mixtures passing through the thin film composite membrane, such as from about 0.1 to 1.5 nm, or from about 0.8 to 1.2 nm, or from 0.8 to 1.1 nm.

In an embodiment of the method, the porous support layer is polyacrylonitrile, polyvinylidene fluoride, polysulfone, polyamide, polyimide, polypropylene, anodized aluminum oxide, cellulose acetate, or nonwoven fabric. In an embodiment, the porous support layer is composed of a polymeric material such as polyacrylonitrile or polyvinylidene fluoride.

In an embodiment of the method, the step of depositing the at least one polymerizable mesophase precursor comprises the step of spin coating from an organic solvent solution. In an embodiment, the organic solvent is selected from ethylene glycol, glycerol, ethyl acetate, ethanol, methanol, isopropanol, acetonitrile, tetrahydrofuran, 1,4-dioxane, acetone, dimethylformamide, or N-methyl pyrrolidone. In an embodiment, the organic solvent for spin coating is selected from ethylene glycol, glycerol, ethyl acetate. In an embodiment, the step of spin coating from an organic solvent solution produces a polymeric membrane, film or coating having a thickness ranging from about 50 nm to about 200 μm, or 50 nm to about 20 μm such as, for example, from 50 nm to about 360 nm, or from 50 nm to 300 nm, or 50 nm to 250 nm, or 50 nm to 200 nm, or 75 nm to 150 nm.

In an embodiment of the method, the step of polymerizing and crosslinking the polymerizable mesophase precursor forms a polymer membrane, film or coating having a water permeation rate of at least 1 L m⁻² h⁻¹ bar⁻¹, or at least 20 L m⁻² h⁻¹ bar⁻¹.

In an embodiment of the method, the layer adjacent to the support layer is a sacrificial layer which can be readily dissolved away using a solvent or water or dilute acid or dilute base solution. In an embodiment, the sacrificial layer is selected from a layer of polyacrylic acid, polyvinyl alcohol, polyvinylpyrrolidone, alginic acid, alginate, cadmium hydroxide, polyethylene oxide, polyethylene glycol, or a layer of chitosan or a layer of dextran.

Further embodiments of the method are contemplated to exist as the combination of any of the embodiments, or parts thereof, described herein.

The invention further provides thin film composite membranes formed by the methods described herein, as well as nanofiltration devices derived therefrom.

Membranes, films or coatings having transport properties including selectivity in the ˜1 nm range and the ability for high throughput (high permeation rate) enable usage in areas such as nanofiltration of fluids which may include large scale industrial wastewater purification, surface/ground pure water production, food processing, or even chemical weapon warfare gas/vapor protection, among others.

While self-assembled materials hold significant potential for improved OSN performance, we are not aware of any work to date implementing self-assembled nanostructures for OSN in the ˜1 nm regime. This is likely due to the significant challenges associated with doing so-apart from the difficulty associated with maintaining membrane stability in organic solvents with different polarities, the difficulty of preserving self-assembled nanostructures in thin-films, 28-30 and the potential need for nanostructural alignment to ensure good permeance 31, 32 represent significant obstacles in the fabrication of practical OSN membranes with ordered nanostructure. A recently developed strategy addresses these challenges however. The internally cross-linked cylinders from a direct lyotropic hexagonal (HI) mesophase present an attractive medium for nanofiltration, due to the bicontinuous nature of the solvent transport and the well-defined ˜1 nm slit-like pores provided by the space between the surfaces of nearest-neighbor cylinders

### EXPERIMENTAL EXAMPLES

The present invention provides a scalable approach to obtain highly permeable and selective nanofiltration membranes that also exhibit attractive anti-biofouling properties, specifically, antimicrobial activity. The membranes make novel use of a morphology consisting of hexagonally ordered molecular nanofibrils (FIG. 1B). This morphology is realized by crosslinking a direct cylindrical (H₁) lyotropic LC (FIG. 1C). In contrast to gyroid phases, the H₁ mesophase occurs more frequently and exhibits stability in a much wider composition window in lyotropic systems. While the H₁ phase obviates the need for alignment, care must be taken in the formulation of the system to ensure the ability to crosslink in place, without loss of structure. The membranes described herein are based on mesophases that have been optimized for high fidelity retention of the structure of the lyotropic precursor in the crosslinked system. The membrane is mechanically robust and is resilient against both dehydration and swelling by excess water. The notion that a polymerized direct lyotropic system would retain its structure in aqueous media is counter-intuitive, and represents a strong departure from prior reported work. (see, for example, M. A. DePierro, et al., Macromolecules 47, 5728-5738 (2014)). The self-assembled structure provides a uniform and well-defined spacing between nanofibrils, thereby leading to high membrane selectivity. More importantly, the availability of a three-dimensionally continuous transport path in the membrane obviates any need for structural alignment, thereby significantly reducing the complexity of membrane fabrication.

The invention is now described with reference to the following Examples. These Examples are provided for the purpose of illustration only, and the invention is not limited to these Examples, but rather encompasses all variations that are evident as a result of the teachings provided herein.

### Example 1: Dual Crosslinking Approach to Liquid Crystal Thin Film Composite Membranes

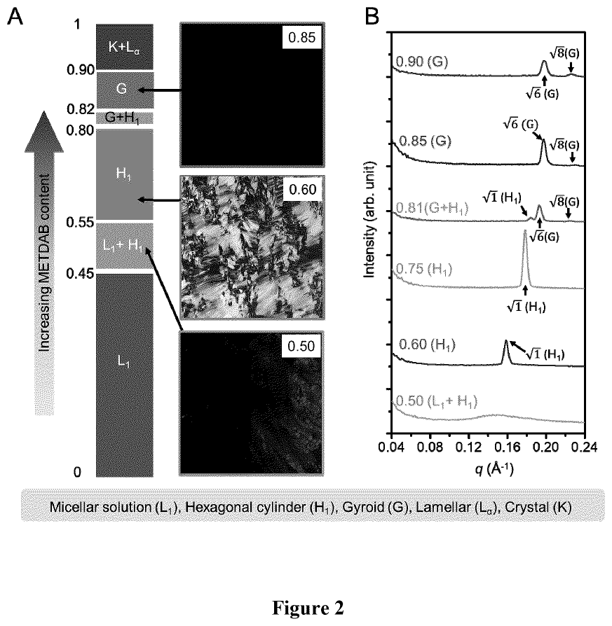

A cationic surfactant, 2-(methacryloyloxy)ethyl tetradecyl dimethyl ammonium bromide (METDAB), bearing a polymerizable methacrylate group close to the hydrophilic head, was utilized to formulate a polymerizable H₁ mesophase with water and additional crosslinkers, ethylene glycol dimethacrylate (EG-DMA) and oligo(ethylene glycol) dimethacrylate (OEG-DMA) (FIG. 1D). The surfactant monomer, or surfmer, was synthesized in a single step Menshutkin reaction, details of which can be found in the Materials and Methods. The METDAB/water binary phase diagram, as determined by polarized optical microscopy (POM) and X-ray scattering, at room temperature displays a phase sequence of isotropic micellar solution (L₁), hexagonal cylindrical phase (H₁), bicontinuous gyroid phase (G), lamellar phase (L_{α}), and crystal (K) as the surfactant concentration is increased from 0 to 100 wt. % (FIG. 2). The formation of H₁ phases at room temperature occurs in a range of METDAB concentration from roughly 55 to 80 wt. %.

One approach to obtain an ordered polymerized nanofibril structure is by photo-initiated polymerization of H₁ mesophases. For membrane applications, it is of critical importance to achieve high-fidelity replication of the ordered nanostructures from the LC template. Herein, detailed structural characterizations are described using a combination of high resolution small-angle X-ray scattering (SAXS) with high resolution microscopy (high resolution POM and direct imaging by transmission electron microscopy (TEM) and atomic force microscopy (AFM)) to verify the retention of our formulated H₁ mesophase after UV-initiated crosslinking.

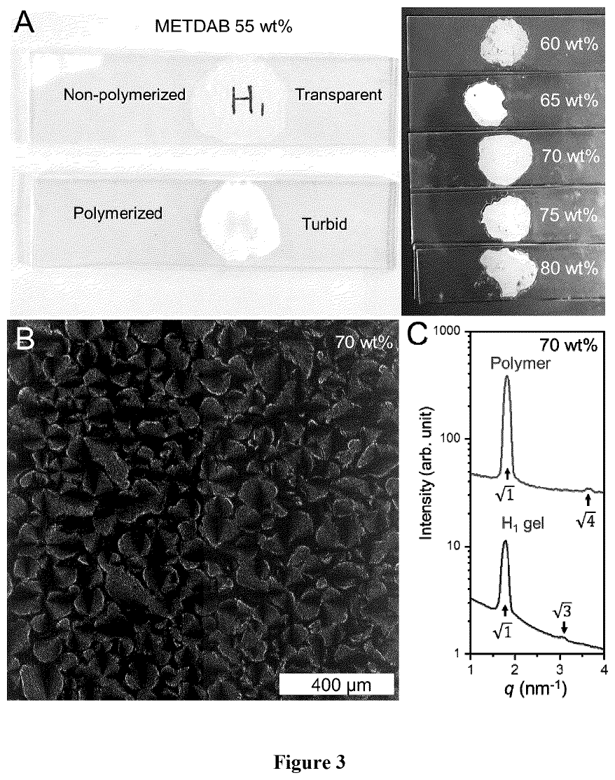

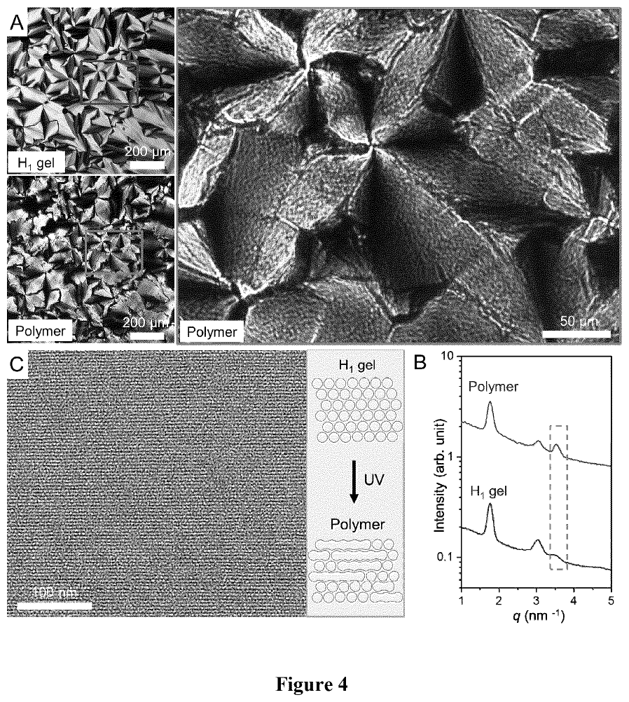

Results of crosslinking experiments carried out on H₁ mesophases that are not optimally formulated highlight the issue of structure retention and appropriate characterization thereof. Photo-initiated polymerization of H₁ mesophases simply formed by METDAB/water binary systems in a broad range of compositions (METDAB content ranging from 55 to 80 wt. %) in the absence of any crosslinker resulted in significant disruption of the H₁ morphology, as evidenced by the apparent cloudiness developed in the polymerized samples (FIG. 3A), the indiscernible LC textures in POM images (FIG. 3B), and the shift of the SAXS peak ratio from 1:√3 to 1:√4 after polymerization (FIG. 3C). Although the presence of an added crosslinker (internal crosslinking within the cylinders using 1,6-hexanediol dimethacrylate (HMDDA)) may improve the structural retention of the system on polymerization, disruption still occurs. While the disruption is not easily recognized at first by X-ray scattering due to the preservation of the 1:√3 SAXS peak ratios, and POM, it is seen in the subtle changes to the LC texture of developable domains in high resolution POM images (FIG. 4A) and the tendency of the hexagonal cylinders to transform to lamellar structures observed in TEM images (FIG. 4C); these, in turn, may explain the unexpected increase of the (200) peak intensity after polymerization found in this system (70 wt. % METDAB, 6 wt. % HDMA, 24 wt. % water) shown in FIG. 4B. These observations mirror the polymerization-induced phase transformation or phase-separation previously observed in lyotropic mesophases.

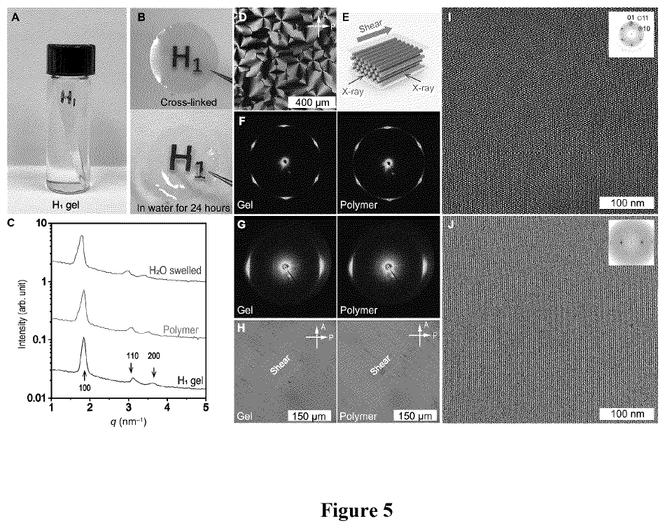

In a first aspect, a dual crosslinking strategy was employed with the aim to more robustly preserve the H₁ morphology and to thereby circumvent the structural disruption issue described above: EG-DMA is insoluble in water, and therefore presumably sequesters selectively within the hydrophobic cores of the cylindrical micelles of METDAB. Addition of EG-DMA is therefore expected to help crosslink the interior of the cylindrical micelles into nanofibrils. Conversely, we pursued the addition of a hydrophilic counterpart, OEG-DMA, with the express intention that it bridge the aqueous spaces between the crosslinked nanofibrils to form a tight network (FIG. 1D). In this perspective, OEG-DMA serves not only to improve morphology retention during polymerization, but also to provide mechanical integrity in the resulting polymer films which must be robust enough to permit pressure driven permeation in use as membranes. An optimized composition of 70 wt. % METDAB, 22.8 wt. % water, 5.4 wt. % OEG-DMA, and 1.8 wt. % EG-DMA was developed that formed a stable, homogeneous H₁ mesophase gel (FIG. 5A). The EG-DMA was itself mixed with a small amount of a photo-initiator 2-methoxy-2-phenylacetophenone (10 wt. %) to facilitate photo-induced crosslinking of the mesophase. The photo-initiator concentration in the system overall was therefore 0.18 wt. %.

Phase transformation and phase separation on UV-induced crosslinking were successfully suppressed for the optimal gel composition as reflected by the excellent transparency of a representative resulting sample (40 μm thick polymer film, FIG. 5B). Moreover, the observed physical integrity on handling and the preservation of high optical transparency of the film after immersion in water for 24 h indicates that the system is resistant against structural collapse due to water swelling (FIG. 5B, 5C). Such retention of structural integrity is a critical necessity for a working membrane that remains in contact with aqueous streams for extended durations. Rheological measurements indicate that the shear modulus of cross-linked H₁ films is approximately 0.1 GPa, highlighting the mechanical integrity of the materials.

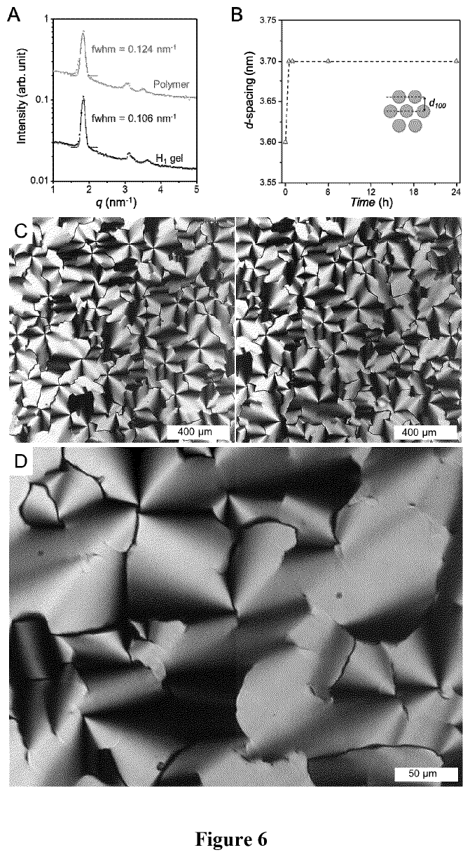

SAXS data provides more reliable information on the structural retention of the H₁ morphology after crosslinking and subsequent water swelling (FIG. 5C). The unchanged ratio of scattering peak locations (1:√3:√4) as shown in the 1-D integrated data demonstrates the intact hexagonal morphology after crosslinking. The d₁₀₀ spacing of 3.6 nm was the same before and after UV-exposure, highlighting the fact that there was no change of lattice parameter during crosslinking. The primary Bragg peak width became marginally broader after crosslinking, with an increase of 0.018 nm⁻¹ in the full width at half maximum (FIG. 6A), suggesting a slight reduction in structural correlation length after polymerization. As for the polymer immersed in water for 24 h, a negligible swelling of the network was observed, evidenced by a small (˜2%) increase of the d₁₀₀ spacing from 3.6 to 3.7 nm (shown in the time dependent d100 spacing as determined by X-ray scattering, FIG. 6B). These findings demonstrate the effectiveness of the dual crosslinker strategy for retaining structural order post-crosslinking and producing a mechanically resilient nanostructured film with water continuous domains. Time-dependent SAXS measurements on the influence of the d₁₀₀ spacing by water swelling suggest that the ˜2% lattice parameter change occurred within 30 min (FIG. 6B). In addition, the structural robustness of the crosslinked film after swelling is further reflected in the maintenance of the developable domain LC texture shown in the high resolution POM image (FIG. 5D). Furthermore, larger-area and higher-resolution views in POM images also display no optical inhomogeneity within the LC domains (FIG. 6C, 6D).

The retention of the original H₁ structure in the crosslinked polymer is also apparent by comparing SAXS data of a shear-aligned specimen before and after UV-exposure. FIG. 5E shows the schematic illustration of the shear induced alignment and the incident directions of the X-ray on the sample. 2-D SAXS images as obtained by incidence of the X-ray beam along and orthogonal to the shear direction display patterns with 6-fold and 2-fold symmetries, respectively, which can be preserved in the corresponding crosslinked polymer (FIG. 5F, 5G). The unperturbed orientations of both cylindrical axes and hexagonal lattices strongly demonstrate that the H₁ morphology was effectively locked in by crosslinking. As expected, POM images further show the same birefringent color of the sheared aligned sample before and after crosslinking (FIG. 5H).

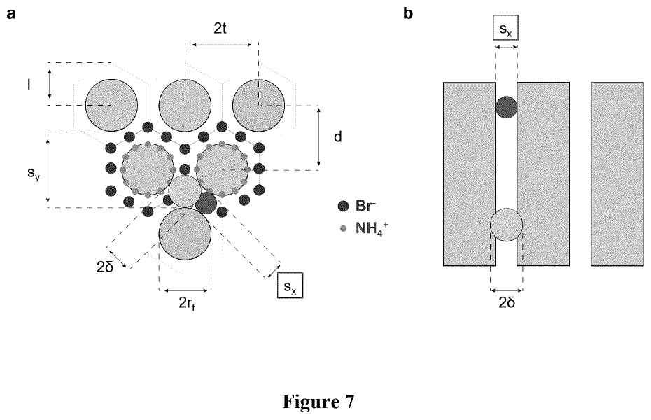

A high resolution TEM image, as shown FIG. 5I, was obtained for an approximately 150 nm thick section microtomed perpendicular to the shear direction. Before sectioning, the polymer sample was stained by immersing into a 0.1 wt. % KI aqueous solution to enhance atomic number contrast. An ordered array of hexagonally packed nanofibrils can be observed, with the inset Fast Fourier Transform (FFT) pattern displaying 6-fold symmetry (FIG. 5I, inset). The cores of the nanofibrils shown in the TEM are brighter than the matrix due to the reduced electron transparency of the fibril outer wall as stained by iodine ions. A d₁₀₀-spacing of 3.6 nm was calculated from the FFT pattern of this TEM image, in good agreement with the SAXS data. TEM visualization orthogonal to the shear direction (FIG. 5J) displays the orientation of the nanofibrils along the shear direction, and the corresponding FFT image shows 2-fold symmetry (FIG. 5J, inset). This TEM data shows the successful production of ordered nanofibril arrays from polymerization or crosslinking of lyotropic H₁ mesophases. On the basis of the structural characterization data, controlling dimensions are estimated to be ˜1.1 nm (2δ) and ˜0.5 nm (Sₓ) transport in parallel, and perpendicular to the nanofibrils, respectively (FIG. 7).

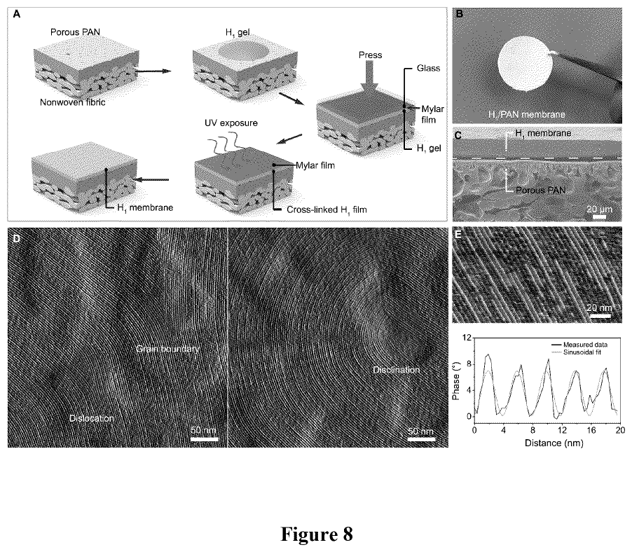

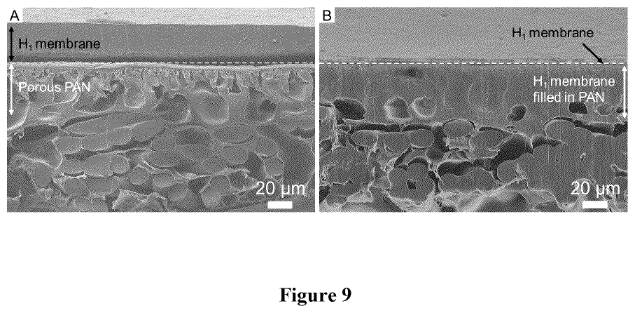

The water-continuous nature, mechanical resilience and ordered self-assembled morphology of the crosslinked H₁ mesophase are attractive for membrane applications. The ability of the system to function as a membrane was assessed in a proof-of-concept manner. Membranes were produced by crosslinking a thin film of the H₁ mesophase spread on commercially sourced polyacrylonitrile (PAN) ultrafiltration membranes (Sterlitech Corporation, Kent, Washington, USA), with molecular weight cut-off of ˜400 kDa that were used as mechanical supports. As schematically illustrated in FIG. 8A, the process involves spreading of the H₁ gel onto a PAN support, followed by a mechanical pressing step to produce a thin gel film, and subsequent UV exposure for crosslinking (detailed procedures in the Materials and Methods). The Mylar® film can be removed to access the crosslinked H₁ film. The resulting crosslinked H₁ film was contiguous with the supporting PAN membrane, as shown in the photo of the H₁/PAN composite membrane (FIG. 8B) and the SEM image of the cross-sectional view (FIG. 8C). The continuity of structure (i.e. absence of delamination) suggests there is appreciable adhesion between the film and the PAN. In fact, the mesophase typically penetrated some distance (˜10s of microns) into the PAN support during pressing (FIG. 9). The penetrated H₁ material was crosslinked along with the surface H₁ layer. While such penetration could be useful in avoiding delamination, it lends uncertainty in the determination of the effective thickness of the H₁ film, and, moreover, the penetrated H₁ material loses the self-assembled alignment and the nanostructures within the PAN support follow a random orientation. In terms of the well-identified layer above the PAN surface, the procedure resulted in H₁ films with thickness in the range of approximately 3 to 30 μm as visualized by SEM.

The surface morphology of the H₁ membrane was characterized by AFM. Planarly oriented arrays of nanofibrils connected by typical topological defects including grain boundaries, dislocations, and disclinations can be clearly observed in the high-resolution AFM images (FIG. 8D). An inter-fibril spacing of approximately 4 nm was obtained from the cross-sectional analysis of an AFM image (FIG. 8E). The morphology of randomly oriented nanofibril domains may contribute to the membrane's structural integrity because of the effective entanglement provided by topological defects connecting domains of different orientation. However, given the structural stability observed on extended swelling studies as well as on drying, the role of the OEG-DMA in covalently crosslinking nanofibrils is expected to be equally, if not more, important.

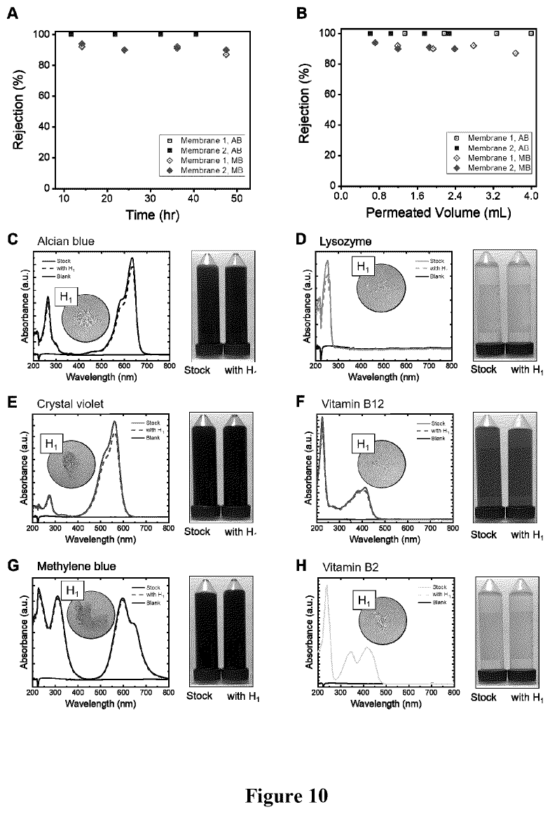

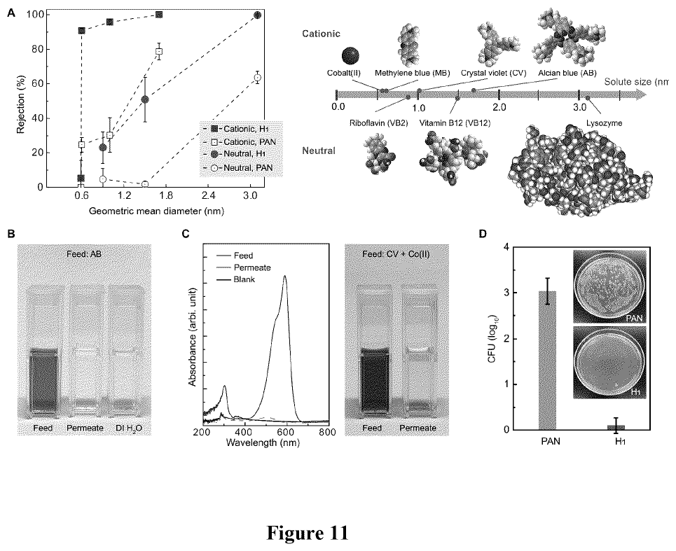

Solute rejection experiments were assessed by challenging the H₁ composite membrane with solutions containing a series of charged (cationic) and neutral molecules, with geometric mean sizes (diameters) ranging from 0.6 to 3.1 nm in a pressurized stirred cell. Anionic dyes were not utilized to avoid the potentially confounding role of molecular fouling due to adsorption onto the positively charged nanofibril exterior. Experiments were conducted over extended periods (several hours to several days) to ensure that the results were representative of steady-state performance, rather than reflecting any transient effects due to dead-space in the filtration cell, solute adsorption, membrane compaction, or any inadvertent leaching of material from the system (FIG. 10). The results of single-solute rejection experiments are summarized in FIG. 11A (error bars in FIG. 11A represent 95% t test confidence limits derived from data variance across multiple measurements, typically 2 membranes and 4 permeate samples per membrane). The solute sizes are geometric mean sizes (shown diagrammatically in FIG. 11B, and as the x axis in FIG. 11A) determined from molecular dimensions calculated using the Chem3D software package. The supporting PAN membrane data is given as the control. The composite membrane displays strong size selectivity towards charged organic dye molecules, demonstrating rejection of ˜90% or higher for methylene blue (MB, ˜320 Da), crystal violet (CV, ˜408 Da) and alcian blue 8G (AB, ˜1300 Da). Complete AB rejection by the H₁ membrane is visible from the colors of the feed solution, and the permeate from the H₁ membrane, respectively: the blue color from AB effectively disappears from the permeate (FIG. 11B). Meanwhile, the lower solute rejection of the PAN support by itself indicates that the selectivity of the composite membrane is dominated by the H₁ layer. The H₁ membrane did not reject CoCl₂, suggesting that the effective pore size in the system is larger than the limiting 0.8 nm diameter of hydrated Co²⁺ ions. The molecular weight cut-off (MWCO) and size cut-off for the charged solutes were ˜350 Da and 1 nm, respectively. The membranes were also selective against neutral solutes, but with a shift in the cut-offs to ˜4 kDa and ˜2.5 nm. The H₁ composite membrane completely rejects lysozyme (˜14.3 kDa) at the isoelectric point, while both cobalamin (VB₁₂, ˜1400 Da) and riboflavin (VB₂, ˜380 Da) are only moderately rejected.

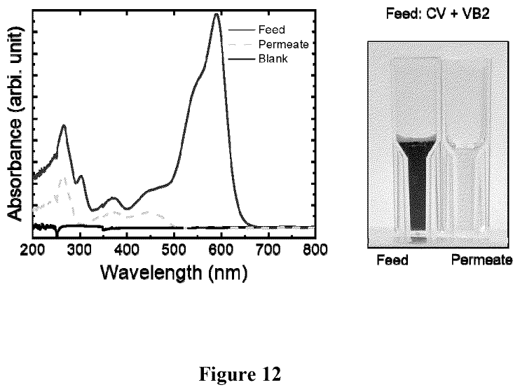

The transport data indicate that the membranes can separate solutes effectively based on size as well as charge. Competitive rejection tests involving filtration of solutions containing 2 solutes were performed, for solutes of different size, and different charge, respectively. In the former case (solutes of different size), a mixture of CoCl₂ and CV was fully separated, with complete rejection of CV, and zero rejection of Co²⁺ (UV-vis spectrum, FIG. 11C). For the latter case (solutes of different charge), the membrane was challenged with a mixture of CV and VB₂. Analysis of the permeate shows that CV was completely rejected by the membrane, while the VB₂ was approximately 50% rejected (FIG. 12).

The rejection data highlight the important role of electrostatic interactions, i.e. Donnan exclusion, in the transport properties of these membranes. At the same time, relative to the theoretical transport dimensions of the mesophase (see calculations of channel dimensions), and under the assumption that diffusion through the nanofibrils (rather than flow around them) is prohibited, the rejection data for neutral solutes suggests that transport may be compromised by the presence of defects of some sort. While not wishing to be bound by any particular theory, it is possible that such defects originate due to imperfections associated with the mechanical pressing or another step in the membrane fabrication process. Another possibility is that topological defects in the mesophase provide less restrictive paths for solute transport. It is likely that continued refinement of the membrane fabrication process, and specifically, a departure from mechanical pressing methods, will improve the selectivity of the membranes by reducing defects such as those described here. It is worthwhile noting however that the assumption of zero permeability through the nanofibrils has not been rigorously tested here. While it is expected that diffusion of water-soluble dyes through the hydrophobic nanofibrils would represent a very high resistance pathway, in the limit of sub-nm scale interstitial spaces, it represents the only transport pathway for solutes. Additional investigation along these lines may be fruitful, particularly in terms of highlighting the boundary between porous and solution diffusion mechanisms in polymer membranes.

The thickness-normalized pure water permeability of the H₁ membranes was determined to be ˜10 L m⁻² h⁻¹ bar⁻¹ μm, using free-standing membranes to avoid the uncertainty in thickness due to PAN penetration. Water permeability decreased by up to 50% during filtration of charged solutes, but was unaltered in the presence of neutral solutes. The high water fluxes observed for the system are consistent with the presence of a physically continuous transport path. Notably, the water permeability is considerably higher than that reported for membranes templated from gyroid LCs. It is anticipated that a high water flux well above 100 L m⁻² h⁻¹ bar⁻¹ can be realized when the thickness of the H₁ film is reduced to the range of 200 nm. Indeed, Applicants have obtained permeation rates greater than 25 L m⁻² h⁻¹ bar⁻¹ for an embodiment of the invention that produced a membrane from a similar crosslinked H₁ mesophase system of this type using a C16 surfactant monomer. These permeation rates, current and anticipated, compare favorably to those of commercial nanofiltration membranes, such as Dow Filmtec NF90-400 that have permeance of roughly 4-9 L m⁻² h⁻¹ bar⁻¹.

The presence of the water-facing quaternary ammonium groups on the nanofibrils due to the surfactant self-assembly suggests that the membranes may exhibit anti-biofouling behavior, due to the well-established antimicrobial properties of these functional groups. The potential for anti-biofouling behavior of H₁ membranes was studied using a standard colony-forming unit (CFU) enumeration assay (details in the Materials and Methods). Bare PAN membranes were also investigated as a control for comparison. In a typical experiment, a PAN or an H₁ membrane was kept in contact with a model Gram negative bacterium (Escherichia coli) in suspension for 3 h. The membranes were mildly sonicated in saline solution to detach bacteria from their surfaces that were subsequently cultured on Agar and incubated overnight. Photos in FIG. 11D show the Agar plates of E. coli colonies cultured from cells on the control and the H₁ membrane. The CFU data shows that the number of viable E. coli cells from the H₁ membrane was 3 orders of magnitude smaller than that of the control. The strong reduction in CFU for H₁ membranes is consistent with a strong antimicrobial response, as anticipated due to the presence of the quaternary ammonium groups. It is worth noting however that biofouling due to bacterial growth is only one aspect of the complex problem of membrane biofouling, and fouling overall.

In concluding Aspect 1, this invention provides a facile approach to fabrication of polymer nanofiltration membranes with a unique morphology of ordered arrays of nanofibrils. The approach utilizes a crosslinkable, water-continuous lyotropic H₁ mesophase as a template to realize the desired morphology. Formulation of the H₁ mesophase takes advantage of dual crosslinkers to preserve the ordered nanostructures with high fidelity and to ensure mechanical robustness of the resulting membrane. Systematic structural characterizations using POM, SAXS, high resolution AFM and TEM have unambiguously confirmed the formation of highly ordered nanofibrils in the crosslinked polymer membranes. The main constituent species of the H₁ mesophase system, METDAB, can be synthesized in large quantities in a single step using readily available and inexpensive reagents. Production of large area, highly permeable and molecularly selective membranes for nanofiltration involves simple photo-induced crosslinking of the mesophase without any alignment procedure.

The membranes exhibit clear size-based selectivity when challenged with molecular dyes as model solutes and demonstrate thickness-normalized water permeabilities of ˜10 L m² h⁻¹ bar⁻¹ μm. The relatively high water flux observed is linked to the water-continuous structure templated from the water-continuous lyotropic liquid crystal. The disparity in the molecular weight cut-off for passage of neutral solutes relative to the theoretical limiting dimensions of the mesophase suggests defects may be present. A reduction of such defects, for example by improvements in fabrication processes, can improve membrane selectivity. In the limit of very small interstitial spaces and low defect densities, these membranes may enable an assessment of the crossover from porous transport to solution diffusion.

It is anticipated that additional improvements can be obtained by optimizing fabrication procedures to provide thinner selective layers. Finally, the derived membranes demonstrate excellent antimicrobial activity due to the intrinsic presence of quaternary ammonium groups. Such antimicrobial activity is beneficial in mitigating biofouling, which is a pressing concern in practical membrane applications.

The materials and methods employed in these experiments are now described.

Materials and Methods

### Materials

All chemicals used in this study were purchased from Sigma-Aldrich, Corp. (St. Louis, MO, USA) and used as received unless otherwise noted. The water soluble cross-linker oligo(ethylene glycol) dimethacrylate (OEG-DMA) has an number average molecular weight, Mn of 750 as specified by the supplier. A radical photoinitiator 2-methoxy-2-phenylacetophenone (MPAP from Acros Organics, BVBA, Geel, Belgium) was dissolved into the oil soluble cross-linker ethylene glycol dimethacrylate (EG-DMA) at a concentration of 10 wt. % (weight of MPAP expressed as a percentage of EG-DMA).

### Synthesis of Polymerizable Surfactant METDAB

Polymerizable surfactant 2-(methacryloyloxy)ethyl tetradecyl dimethyl ammonium bromide (METDAB) was synthesized by an adapted one-step Menshutkin reaction follows: 2-(Dimethylamino)ethyl methacrylate (31.4 g, 0.2 mol), 1-bromotetradecane (55.4 g, 0.2 mol), and anhydrous acetone (100 g) were mixed in a round-bottom flask. The mixture was stirred and heated at 45° C. in an oil bath for 48 h. After the reaction, the product, a white solid was precipitated from the solution by adding an excess amount of diethyl ether to the flask and then filtered using a Buchner funnel. The crude product was purified by recrystallization in ethyl acetate. The final product was rinsed several times with diethyl ether and filtered, followed by drying in vacuum for 12 h before use. The yield was above 70%.

### Formulation of Lyotropic Liquid Crystals and Cross-Linking

Lyotropic liquid crystals (LCs) can be formed by simply mixing the polymerizable surfactant METDAB and water. The binary surfactant/water phase diagram (FIG. 2) was obtained by systematic variation of the weight ratio of surfactant to water and characterization of the corresponding surfactant/water mixtures using POM and X-ray scattering. The formation of direct hexagonal phases (H₁) at room temperature was found to locate in the window of METDAB contents from 55 to 80 wt %. Polymerization of the METDAB surfactant monomer without a crosslinker was found to disrupt the H1 LC mesophase (FIG. 3). In order to preserve the mesophase morphologies, additional cross-linkers were introduced into the system. The crosslinkable H₁ phase utilized for the preparation of H₁ polymer membranes was obtained by mixing 70 wt % METDAB, 22.8 wt % water, 5.4 wt % OEG-DMA, and 1.8 wt % EG-DMA (doped with a radical initiator). This formulation was crosslinkable while still resulting in excellent preservation of the H₁ morphology (FIG. 6). Crosslinking/polymerization of mesophases was conducted in an N₂ atmosphere using a focused spot UV beam for 30 min (100 W Sunspot SM spot curing system at a distance of ˜2 cm).

### Polarizing Optical Microscopy (POM)

POM studies on LC textures were performed using a Zeiss Axiovert 200 M inverted microscope. LC samples sandwiched by two glass slides were slightly heated to facilitate the formation of the typical LC texture before POM visualization.

### X-Ray Scattering

2-D X-ray scattering data of mesophases before and after cross-linking were obtained using a Rigaku SMAX-3000 instrument with the accessible scattering vector (q) ranging from 0.015 to 0.24 Å⁻¹. The wavelength of the X-ray beam was 1.542 Å (Cu Kα radiation). X-ray scattering with higher q values were performed using a Rigaku 007 HF+instrument with a rotating anode Cu Kα X-ray source and a 2-D Saturn 994+ CCD detector. The calibrations of the X-ray scattering instruments were performed using a silver behenate standard and a silicon powder standard, respectively. All the 2-D scattering patterns were integrated into 1-D plots of scattering intensity (I) versus q, where q=4π sin(θ)/λ and the scattering angle is 2θ.

### Transmission Electron Microscopy (TEM)

Cross-linked H₁ samples were immersed into a 0.1 wt % KI aqueous solution for 1 h to enhance atomic number contrast. The stained sample was rinsed with water and completely dried before sectioning. The stained, cross-linked samples were then embedded into an epoxy resin specified for microtoming. The epoxy resin was cured at 50° C. for 12 h to ensure the required rigidity for sectioning. Samples were microtomed (cut perpendicular to the film surface to show a cross-section of the film) at room temperature by a diamond knife mounted on a Leica EM UC7 ultramicrotome. The thickness of the microtomed cross-sections was set to 150 nm by the microtoming instrument. Sectioned samples were then transferred to a TEM grid and characterized by an FEI Tecnai Osiris TEM with an accelerating voltage of 200 kV.

### Atomic Force Microscopy (AFM)

AFM studies on the surface morphology of the H₁ membranes were performed using the tapping mode of a Bruker Dimension Fastscan AFM instrument.

### Rheological Characterization

Mechanical characterization of the crosslinked H₁ material was performed on an ARES G2 rheometer (TA Instruments) in the dynamic mode to determine the shear modulus of the system, using a 8 mm parallel plate with a gap height ˜2 mm.

### Scanning Electron Microscopy (SEM)

SEM imaging on cross-sections of the H₁ membranes on supports was conducted by a Hitachi SU-70 instrument with an accelerating voltage of 5 kV.

### UV-Vis Spectroscopy

UV-Vis spectra were recorded in transmission mode using a dual beam configuration on a Cary 300 spectrometer. Dye rejection was quantified by UV-Vis spectrophotometry of permeate solutions (diluted as necessary) compared with UV-Vis absorbances of calibrated dye standard solutions at the characteristic peak absorbance wavelengths of the solutes. UV-Vis data for both permeate solutions and standards were quantified by using numerically integrated (trapezoid rule) areas under the samples' UV-Vis absorbance traces.

Fabrication of H₁/PAN membranes

Polyacrylonitrile (PAN) ultrafiltration membranes with a rejection size of 400 kDa were obtained from Sterlitech Corporation (Kent, Washington, USA) and the item No. was specified as YMPX3001-Synder Flat Sheet Membrane. PAN membranes were employed in this study as mechanical supports for the H₁ active membranes. The procedure for the membrane fabrication is briefly illustrated by FIG. 8A. Homogenized H₁ gel contained in a centrifugal tube was centrifuged at a speed of 14×10³ rpm for 40 min to completely eliminate bubbles trapped in the gel before use. The degassed H₁ gel (˜5-10 mg) was quickly placed on top of a smooth Mylar® film (slightly stretched to ensure smoothness), followed by covering by a PAN membrane with the active PAN layer facing the H₁ gel. The Mylar®/H₁/PAN construct was then sandwiched by two glass plates. Appropriate pressure was applied on the sandwiched construct for 5 min to ensure spreading of the gel on the PAN support. After that, the glass plates were removed and the gel covered by the Mylar® film was exposed to a focused spot UV beam for 10 min (100 W Sunspot SM spot curing system at a distance of ˜2.5 cm) in an N₂ atmosphere. The Mylar® film was then carefully peeled off from the cross-linked H₁ membrane.

### Filtration Testing, Static Adsorption and Relevant Example Calculations

The hydraulic permeance and dye rejection quantification procedures were identical for the H₁/PAN membranes and the control PAN support. Roughly square coupons (approx. 2 cm×2 cm) were installed into a 50 mL EMD Millipore Amicon (UFSC05001) stirred cell atop of a 4.5-cm diameter piece of polyester macroporous support (Sterlitech). The surface of the membrane was then covered with a customized circular stainless-steel mesh. Within the filtration cell, the active testing area of the membrane coupon was a circular area with a diameter of 1.1 cm, corresponding to an effective surface area of 0.95 cm². After loading the feed solution into the test cell chamber, compressed nitrogen gas was used to pressurize the test cell to pressures ranging from 0.5 to 80 psi. Permeate was collected in glass vials and sealed with Parafilm® (Bemis Company, Neenah, WI, USA) to prevent solvent evaporation.

During the rejection experiments, a constant pressure of 80 psi was maintained, and the cell was stirred at 400 rpm to reduce the concentration polarization. At least 1 mL of permeate was collected for each solute rejection experiment. After completion of tests with one dye and before testing the coupon with the next dye, the stirred cells and the membranes were rinsed with DI water thoroughly, followed by filtering at least 3 mL DI water through the coupon to rinse any residual solutes. To prepare the feed solution for single solute rejection experiments, Alcian blue 8G (AB), crystal violet (CV), methylene blue (MB), vitamin B12 (VB12) and lysozyme at a concentration of 0.5 g L⁻¹ were dissolved in DI water. The solution pH for lysozyme solution was adjusted by dissolving NaOH pellets in the solution until the isoelectric point at pH=11.35 was achieved, as monitored by using an Accumet AB15 pH meter (Thermo Fisher Scientific, Inc., Waltham, MA, USA) coupled with pH test strips. Separately, riboflavin (VB2) was dissolved in DI water at a concentration of 0.05 g L⁻¹. And, in the salt rejection experiment, CoCl₂ was dissolved in DI water at a concentration of 100 mM. To prepare the feed solution for competitive solute rejection experiments, a mixture of solutes was dissolved in DI water. Specifically, the VB2 and CV solution was prepared with an equal solute concentration of 0.05 g L⁻¹, and the CoCl₂ and CV solution was prepared at a concentration of 100 mM and 0.5 g L⁻¹, respectively.

The free-standing H₁ thin-films used for static solute adsorption experiments were prepared in a similar manner as the H₁ PAN composite, with minor modifications. Specifically, glass slides with sacrificial polymeric coatings were employed to sandwich the film during pressing. Two microscope slides (Thermo Fisher Scientific, pre-cleaned) were spin-coated (2000 rpm, 1 min) with aqueous polymer solutions, the first slide with 1 wt. % Dextran (Mₙ˜70 kg mol⁻¹) and the second slide with 1 wt % Chitosan (medium molecular weight) solutions, and were subsequently baked in a convection oven at 85° C. for 2 h. Measured amounts of H₁ gel (˜10 mg) were sandwiched between a chitosan-coated slide and a dextran-coated slide. Upon the completion of photo-initiated cross-linking, the glass slide sandwiched H₁ thin film was plunged in a DI water bath for a few hours until the dextran coating was fully dissolved to allow removal of the top slide. Following this, the H₁ gel adhered to the bottom chitosan-coated slide was immersed in a 3 wt % acetic acid bath for 24 h, causing the dissolution of the chitosan coating and leading to a free-standing floating crosslinked thin-film of the H₁ gel. Subsequently, pieces of free-standing thin-films were then immersed in targeted solute solutions for 48 h with a packing ratio of ˜0.2 g membrane per L solution. In the end, the concentrations of the solutions with H₁ free-standing thin-films were analyzed and compared with the reference stock solutions.

The hydraulic permeance was quantified by measuring the amount of time required to collect a certain volume into the collection vial. The following formula was used:

$$I = \frac{( {m}_{vial , final} - {m}_{vial , tnic} ) \times ( 1 / ρ )}{A \times ( {t}_{final} - {t}_{final} ) \times P} = [ \frac{L}{{m}^{2} \cdot hr \cdot bar} ]$$

where,
m=mass of vial (in grams)
ρ=density of water (in grams/liter)
A=active membrane testing area (in square meters)
t=time (in hours)
P=gauge pressure (in bar)

A sample calculation is shown below for water permeance of an H₁ membrane:

$$A = \frac{π {D}^{2}}{4} = \frac{{π [ 1.1 \times {10}^{- 2} m ]}^{2}}{4} = 9.5 \times {10}^{- 5} {m}^{2}$$

$$P = 80 psi \times \frac{1 bar}{14.5 psi} = 5.5 bar$$

$$I = \frac{( 1.75 ) \times ( 1 / 1000 )}{( 9.5 \times {10}^{- 3} ) \times ( 29 ) \times ( 5.5 )} = 0.12 L {m}^{- 2} {h}^{- 1} {bar}^{- 1}$$

UV-Vis spectrophotometry was used for concentration determinations to quantify dye rejection/selectivity performance of the tested membranes. The concentration of the permeate was determined from the linear regression plot from a series of standard concentrations. The dye rejection metric was calculated from UV-Vis spectra as shown here:

$$\% Reje ction = 100 \% \times ( 1 - \frac{{c}_{permeate}}{{c}_{feed}} )$$

where,
Cₚₑᵣₘₑₐₜₑ=concentration of permeate dye solution (as weight fraction in DI water)
C_{feed}=concentration of feed dye solution (as weight fraction in DI water)

### Colony Forming Units (CFU) Enumeration Assay

Escherichia coli (ATCC BW26437) were received from the Yale E. coli Genetic Stock Center. Bacteria were grown overnight in Luria-Bertani (LB) broth at 37° C. After incubation, the culture was diluted in a fresh medium and grown until log phase (˜1.5 h), as evidenced by an optical density of ˜0.8 at 600 nm. The bacterial cells were washed three times with sterile saline solutions (0.9 wt. % NaCl) before use. CFU enumeration assay was used to evaluate the antimicrobial activity of the H₁ membranes. The bacterial suspension (10⁸ CFU mL⁻¹) was exposed to the membrane surface for 3 h at room temperature. After discarding the excess bacterial suspension, a 5-mL saline solution was used to rinse unattached cells from the film. The film was then transferred into another 5-mL saline solution and sonicated for 10 min in an ultrasonic bath (26 W·L⁻¹, FS60 Ultrasonic Cleaner) to detach bacteria from the film surface. After detachment of cells from the membrane surface, the supernatant was immediately cultured on an LB agar media and incubated overnight at 37° C. for CFU enumeration. Bare PAN membranes were also investigated as controls for comparison. Three independent samples were exposed to E. coli and the average value with one standard deviation was reported. All results were presented as means±standard deviation. Statistical differences (p<0.05) between two groups were determined using Student's t test with paired two-tailed distribution.

### Example 2. Ultra-Thin High Performance Liquid Crystal Thin Film Composite Membranes

A second aspect of the invention focuses on optimizing the performance of the device. At the device level, it is apparent that minimizing the thickness of the membrane materials, provides an important second means of maximizing membrane permeance independent of selectivity.

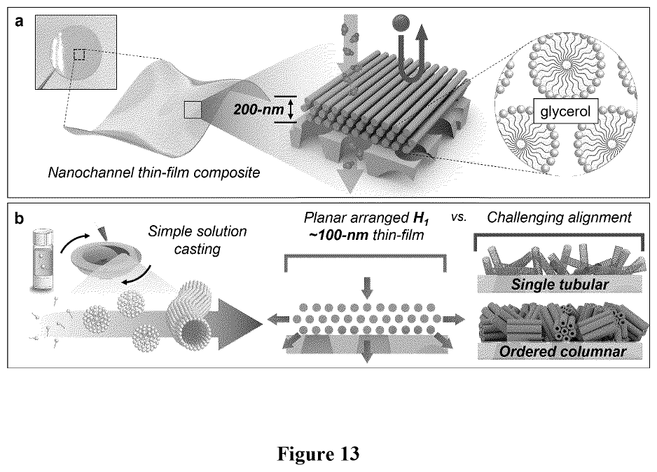

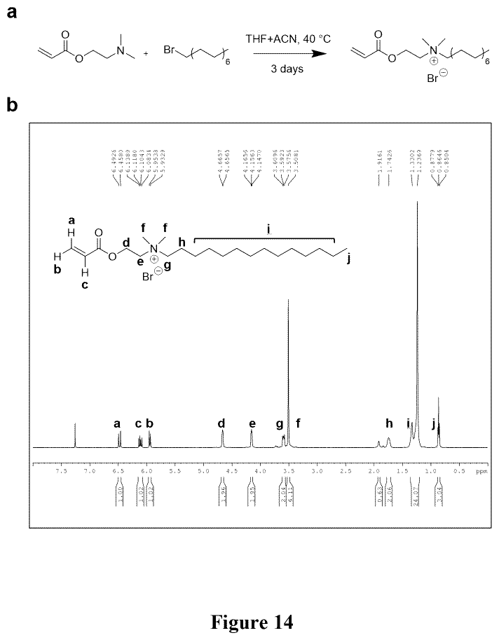

The second aspect presents a direct columnar (H₁) lyotropic LC-TFC that overcomes the above-mentioned challenges by constructing ultra-thin but defect-free 3D-water-bicontinuous transport pathways (FIG. 13). In comparison with tubular nanochannels such as inverse hexagonal cylinders (H₂) or carbon nanotubes, no channel alignment is required to guarantee effective solvent permeation. This mesophase was prepared by mixing glycerol and crosslinker with a cationic surfactant [2-(acryloyloxy)ethyl]dimethyl tetradecyl ammonium bromide (AETDAB) derived from a straightforward synthetic approach (FIG. 14A). For hydraulic permeance experiments presented later herein, the glycerol content was exchanged with water. While the composition of the mesophase is soluble in common organic solvents, the membrane is capable of being manufactured at large-scale through standard solution-coating technologies. The controllable deposition of thin-film thickness down to the order of ˜100 nm leads to hydraulic permeance ˜10 L m⁻¹ h⁻¹ bar⁻¹ that is representative of high-performance commercial nanofiltration membranes. Furthermore, 2-D grazing-incidence small-angle X-ray scattering (GISAXS) suggests the solution coating allows the spontaneous arrangement of degenerative nanofibrils parallel to the surface within the thin film. Significantly, this orientation is representative of a smaller critical solute transport dimension ˜1 nm. Using information from transport experiments, the determined nanochannel from the ultra-thin mesophase defines a critical separation dimension c.a. 1 nm based on charge-neutral solutes, and the membrane is highly efficient for charged microcontaminants purification. While the successful fabrication of the H₁ membrane offers a foundation that is useful for the rational design of LC-TFC, our detailed performance characterization indicates that the potential of nanofiltration based on the optimized nanostructure from the bottom-up approach is immense. Accordingly, the current study highlights a class of novel nanochannel materials easily adapted to large-scale fabrication, which represents an attractive candidate for the next-generation nanofiltration membrane derived from optimized lyotropic liquid crystal self-assembly.

The design principle of the water-bicontinuous TFC relies on the preservation of the H₁ mesophase during the processing, such as preventing the potential phase change from a standard thin-film casting procedure using a solution of organic solvent with dissolved precursors. Since changes in aqueous content may induce mesophase transformation before photoinitiated polymerization, the emergence of other mesophases with limited water accessible domain, such as lamellar (L_{α}) is undesired. As such, it is necessary to exploit an alternative lyotropic mesophase formulation with lower volatility than presented in aqueous systems, to prevent the evaporative loss from the ultra-thin film. We used glycerol as a water replacement, due to its low vapor pressure at ambient conditions (<1 torr at 20° C.) and ability to solvate the amphiphilic surfactant. In this manner, by incorporating 31 wt. % glycerol and 4 wt. % hexanediol diacrylate (HDDA) with AETAB, a highly ordered array of hexagonally closed packed cylinders self-assembles at equilibrium. In addition, in comparison with other reported LC precursors, the AETAB was facilely synthesized by a single-step Menshutkin reaction as detailed in FIG. 14A, 14B.

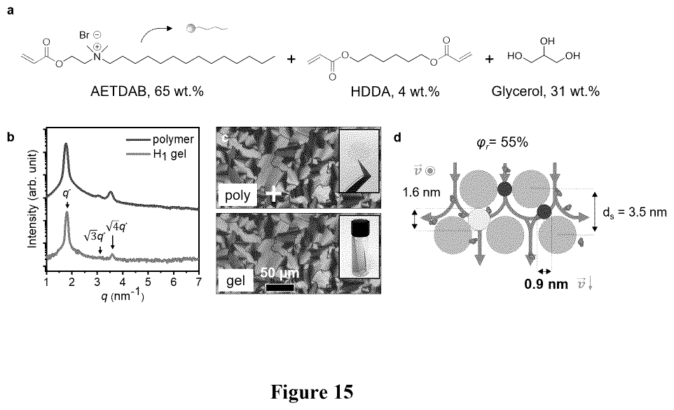

The self-assembly of the lyotropic H₁ mesophase is evidenced by 1-D integrated small-angle X-ray scattering (SAXS) trace coupled with polarized optical microscopy (POM) analysis. Bulk film samples for optical characterization were prepared by pressing between glass slides and then thermally annealed to develop the equilibrium texture slowly. The diffraction peak of the self-assembled lyotropic gel follows a ratio of (q/q*)²=1, 3, and 4 (FIG. 15B) and matches with the existence of fan-like texture observed in POM images, as shown in FIG. 15C.

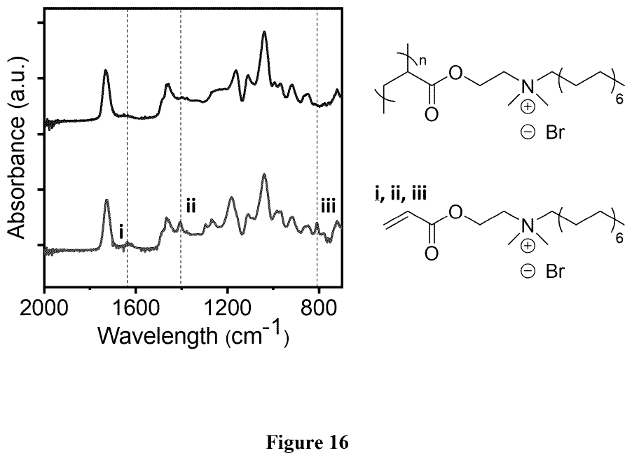

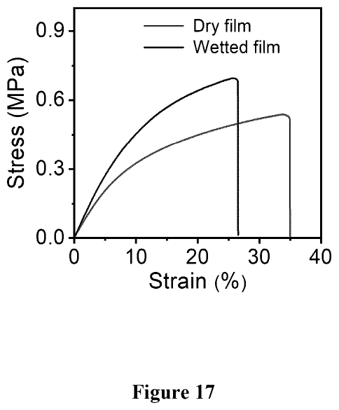

Polymerization of the self-assembled lyotropic gel was conducted using a 100-W focused UV beam illuminating on the surface of the lyotropic liquid crystal in a nitrogen atmosphere for 25 min. Fourier-transform infrared (FTIR) spectra confirmed the UV-initiated polymerization of the monomer AETDAB within the self-assembled H₁ matrix (FIG. 16). The disappearance of the peaks at ˜(i) 1620 cm⁻¹, (ii) 1410 cm⁻¹, and (iii) 810 cm⁻¹ indicated the formation of saturated alkanes. An estimated percent conversion >97% is calculated by comparing the characteristic peak areas before and after the polymerization. FIG. 17 shows the stress-strain curve of the resulting crosslinked H₁ bulk films. The curve demonstrates a consistent toughness of ˜130 kPa m⁻³ for both dry and water wetted films, indicating the film is sufficiently strong to prevent irreversible deformation from the pressure-driven flow when in use in a separation membrane.

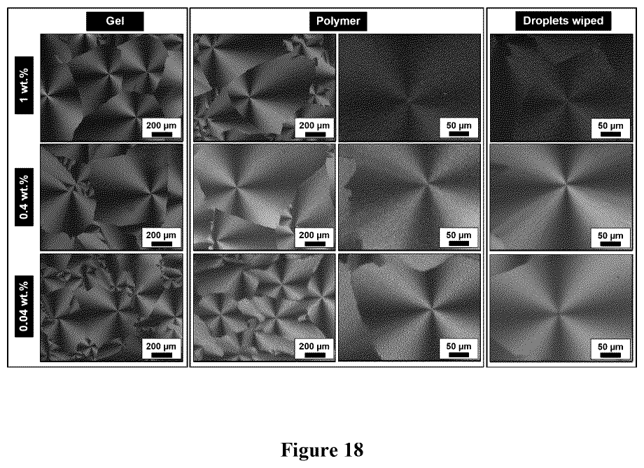

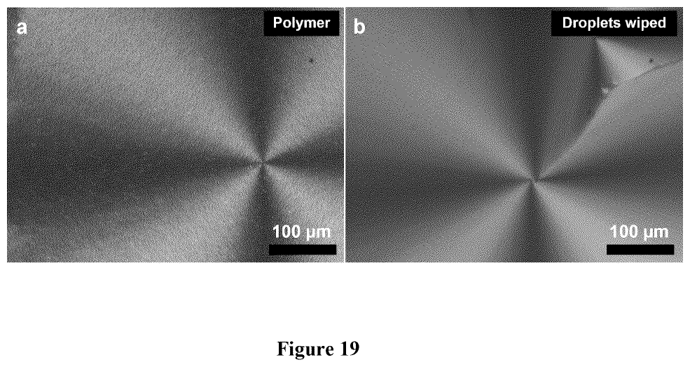

Since, upon polymerization, the preservation of the highly ordered water channels is critical to the separation performance, the high-fidelity retention of the H₁ template during the photoinitiated crosslinking was investigated in detail by manipulating the concentration of photo-initiators 2-methoxy-2-phenylacetophenone within the H₁ mesophase. The crosslinking of samples was consistently conducted by illuminating the mesophase thin-films under a focused spot UV beam (100 W) for 25 min at a distance of ˜8 cm, in a nitrogen atmosphere. In this way, the successful structural retention was directly observed from the high-resolution polarized optical microscopy. The micrographs demonstrate the retention of domain texture is directly related to a critically low weight fraction of initiator existing within the mesophase thin-film in a range from 0.04 to 1.0 wt. % (FIG. 18). A clear contrast in the optical discontinuity was identified when higher concentrations of photoinitiator (>1 wt. %) were incorporated despite the superficially similar focal conic texture. In contrast, a general trend of better-preserved birefringence features from crosslinked thin-films was determined through decreasing initiator loading, generating high-resolution micrograph with almost no optical inhomogeneities (0.04 wt. % initiator, FIG. 19). It would appear that the lyotropic mesophase remains stable under a sufficiently low concentration of free radicals during the photoinitiated polymerization. Therefore, based on these observations, an optimum mesophase formulation with 0.04 wt. % initiator that offers the high-fidelity retention of the H₁ is identified for the preparation of subsequent molecular separation devices.

To further elucidate the quality of mesophase preservation during UV-initiated crosslinking, X-ray scattering characterization identifying the phase preservation was conducted through preparing the crosslinked mesophase with proper photoinitiator content in bulk (0.04 wt. % initiator). As represented by the SAXS principle reflection peak q* from FIG. 15B, the alteration in domain spacing from 3.5 to 3.6 nm demonstrates only minor change among the spatial arrangement of hexagonal close-packed nanofibrils, before and after the crosslinking. Most significantly, a consistent characteristic peak spacing ratio 1:√3:√4 calculated from the SAXS diffraction data indicates the phase transformation is generally suppressed. Moreover, a carefully designed high-resolution POM micrographs study for the bulk film before and after polymerization (FIG. 15C) demonstrates indistinguishable textures that confirm the absence of discernable phase alternation. Based upon the structural analysis assuming the fully preserved H₁ template with a cylinder volume fraction φᵣ of 55%, the orientation of nanoconfined cylindrical micelle is capable of controlling the critical separation dimensions for solvent transport perpendicular to the surface. Specifically, for channels ordered in the plane of the membrane, local free volume elements with different critical dimensions at 0.9 or 1.6 nm can be assumed for solute travel perpendicular to the surface, and in the plane of the surface, respectively (FIG. 15D), with detailed information shown in FIG. 7 along with a detailed spacing calculation herein below.

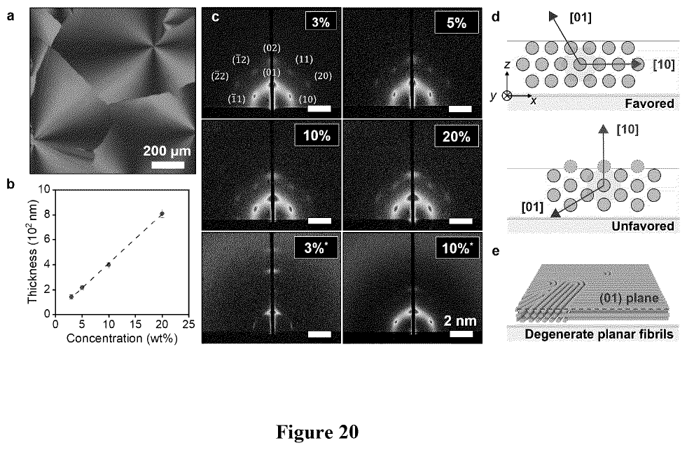

In addition to the characterization of photo-crosslinked H₁ thin-film using the optical microscope (FIG. 20A), two-dimensional grazing-incidence small-angle X-ray scattering (GISAXS) provides information regarding the mesophase orientation at the surface, which is critical for understanding the intrinsically confined dimension available for molecular separation. In order to prepare thin-films, mesophase solutions dissolved in ethyl acetate (vapor pressure ˜70 torrs at 20° C.) were spin-coated on polished (100) silicon wafers with pre-determined concentrations. Thereafter, the solution was allowed to undergo complete solvent evaporation, achieving targeted mesophase composition prior to subsequent photopolymerization. Atomic force microscopy (AFM) height profile analysis of film thickness on the silicon wafer shown in FIG. 20B demonstrates that the spin-coating profile can be simply controlled by tuning the solution concentration.

GISAXS patterns from spin-coated mesophase solutions with solution concentrations ranging from 3 to 20 wt. % deposited on silicon wafer substrates demonstrate a consistently uniform scattering pattern of sharp Bragg spots arranged in a hexagonal lattice (FIG. 20C). The observed (01) and (02) spots located along the z-direction (i.e., the film normal) indicate the planar orientation of the cylindrical director on the x-y plane (i.e., the film surface). The planar orientations, however, are degenerate at the surface, as evidenced by the stronger intensity of the meridional (01) spot compared with that of the (10) and (11) spots. Furthermore, the scattering spots with limited azimuthal spread suggest the orientation of the hexagonal lattice relative to the surface is strictly prescribed, with the (01) plane in parallel to the surface. This configuration of orientation is preferred because it eliminates the distortion of cylinders at the surface. Other orientations, for instance, the one with the (01) plane perpendicular to the surface, lead to a significant distortion of the structure, as schematically illustrated (FIG. 20D). The corresponding 1-D integration of primary reflection q* provides a consistent spacing at ˜3.5 nm (FIG. 7).

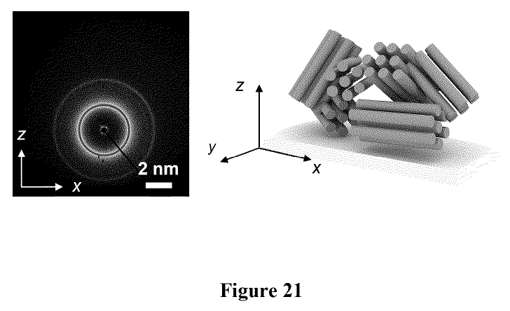

FIG. 21 shows a 2D-transmission SAXS pattern collected from another crosslinked bulk film that does not show preferential nanofibril alignment. The 3-D model illustrates nanostructures at bulk follow a random orientation.

In contrast with the bulk film with random cylinder orientation (FIG. 21), the critical separation dimension of the planar configuration of the invention can be estimated as ˜1 nm according to the planar aligned geometry of FIG. 7.

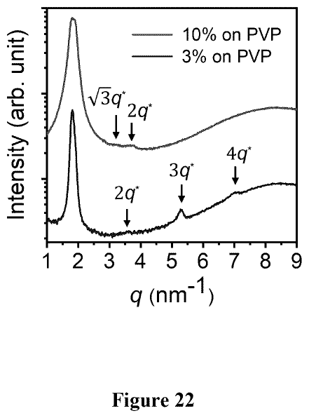

Meanwhile, a comparison experiment was conducted to establish a connection between the nanostructure of the H₁ template in response to the impact of particular substrate chemistry. A control group of thin-films was prepared on silicon wafers covered with a polyvinylpyrrolidone (PVP) layer that is not interactive with the ethyl acetate used as the solvent. The modified substrate chemistry resembles the sacrificial material to be utilized during prospective composite membrane fabrication. However, the solution coating on the modified substrate with a layer of PVP manifested the emergence of suspected phase transformation as illustrated in FIG. 20C (for example, see 3%* sample) with solution concentrations labeled with an additional asterisk. Although the ethyl acetate is not interactive with PVP, the 1D integration of GISAXS patterns in FIG. 22 confirmed the presence of L_{α} (lamellar phase) while coating a lower solution concentration (i.e., 3 wt. %) atop of the PVP (i.e. 3%* sample in FIG. 20C), presumably due to change in lyotropic aqueous content during solution coating.

From information collected in the nanostructural analysis, the array of 2.4×10⁸ mutually accessible 1-nm×1 m nanochannels provided for fluid flow is significant to bring unmatched transport performance (FIG. 7). Therefore, connecting the processing of the TFC fabrication to the advantageous transport property possessed by the H₁ template is central to unleashing the final performance. By establishing the impact of the mesophase thin-film related to distinct supporting materials, parameters that contribute to the transport performance may be identified to inform further modifications.

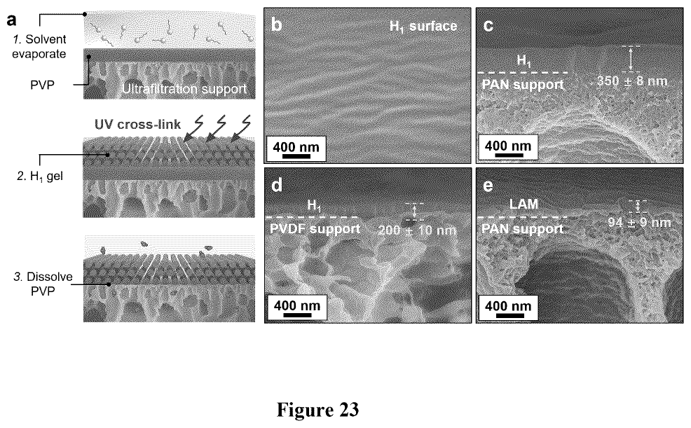

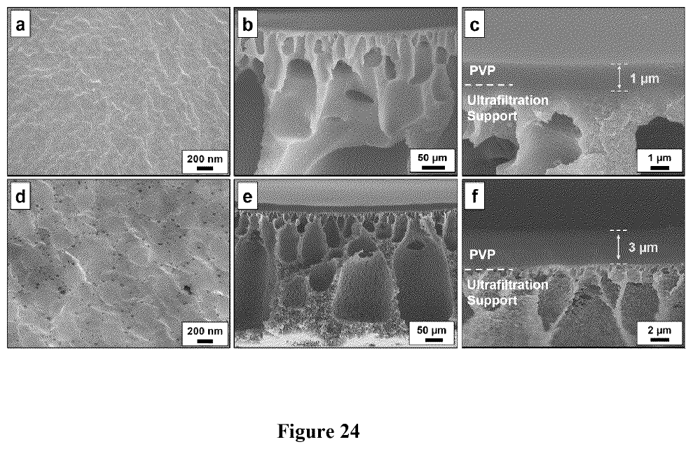

Hydraulic permeance is one of the critical parameters in determining the utility of the nanofiltration membranes. However, spin-coating the mesophase solution directly on ultrafiltration supports may contribute a significant hydraulic resistance at the interface, leading to lower hydraulic permeance <1 L m⁻² h⁻¹ bar⁻¹. Therefore, a sacrificial layer assisted fabrication strategy using a stimuli-perishable polymeric layer was utilized in concert with H₁ deposition. The corresponding casting protocol temporarily supports the solution film, and therefore suppresses the solvent infiltration into ultrafiltration supports (FIG. 23A). Namely, PVP that exhibits low surface energy with ethyl acetate can be used to construct a dense sacrificial layer atop of different ultrafiltration supports. To demonstrate the robustness of current LC membrane casting methodology, poly(acrylonitrile) (PAN, Snyder PX) and polyvinylidene fluoride (PVDF, Snyder V6) ultrafiltration membranes with distinct macromolecular chemistries were investigated. Detailed imaging characterizations for support membranes are shown in FIG. 24 as follows: FIG. 24A shows the surface morphology of a PAN ultrafiltration membrane with an advertised molecular weight cut off (MWCO) at 300 kg mol⁻¹. FIG. 24B shows the cross-sectional image of the same membrane covered with a 1-μm thick, dense PVP layer that can be clearly distinguished from the PAN at higher magnification, as shown in FIG. 24C. FIG. 24D shows the surface of a PVDF membrane with an advertised MWCO at 500 kg mol⁻¹. FIG. 24E, F show the 3-μm thick sacrificial layer which is visible from the cross-sectional analysis even at a lower magnification, and it guards the mesophase solution infiltration during the subsequent membrane fabrication.

Through the implementation of an additional water-soluble layer, ultra-thin membranes with higher hydraulic permeance were prepared with ease. Thereafter, the impact of H₁ mesophase morphology was subsequently analyzed with correlated transport characterization.

Thin film of H₁ mesophase solutions (in ethyl acetate) were spin-cast on modified ultrafiltration substrates followed by photoinitiated crosslinking. Throughout the study, the precursors prepared in casting solutions were allowed to evaporate for 3 minutes before the initiation of a focused UV beam. To this end, surface and cross-section morphologies for the mesophase thin-films are easily distinguished from the scanned electron micrographs shown in FIG. 23. Images were captured after rinsing the TFC thoroughly with water, which removes the sacrificial PVP layer. A macroscopically defect-free coating is identified from FIG. 23B, which displays the surface morphology from coating a 10 wt. % mesophase solution atop of modified PAN (modified with PVP). Meanwhile, the cross-sectional image of the same composite membrane in FIG. 23C demonstrates the 350-nm thick H₁ along with the underlying PAN ultrafiltration support. This PAN-H₁ membrane possesses hydraulic permeance of 6.1 L m⁻² h⁻¹ bar⁻¹, equivalent to a permeability value ˜2 L m⁻² h⁻¹ bar⁻¹ μm that matches with the theoretical calculation. In comparison, casting the same mesophase solution on modified PVDF generates a clear cross-section that is indicative of the formation of a 200-nm thick film shown in FIG. 23D. A lower hydraulic resistance characterized higher permeance of 10.0 L m⁻² h⁻¹ bar⁻¹. Furthermore, these H₁ membranes demonstrate consistent hydraulic permeance after the initial rinsing procedure during the flow-through transport experiments.

Alternatively, the ultra-thin 94-nm thick film with suspected phase transformation (to the lamellar phase) shown in FIG. 4E was investigated as a control. This TFC was derived from coating a 3 wt. % mesophase solution on water-soluble material supported PAN. Despite the potential lamellar (LAM) phase containing domains largely inaccessible to fluid, initial hydraulic permeance of 10.4 L m⁻² h⁻¹ bar⁻¹ was recorded presumably due to the co-existence of H₁. Following a thickness normalized calculation, such permeance is related to a normalized permeability ˜1 L m⁻² h⁻¹ bar⁻¹ μm, which is lower than the above mentioned H₁.

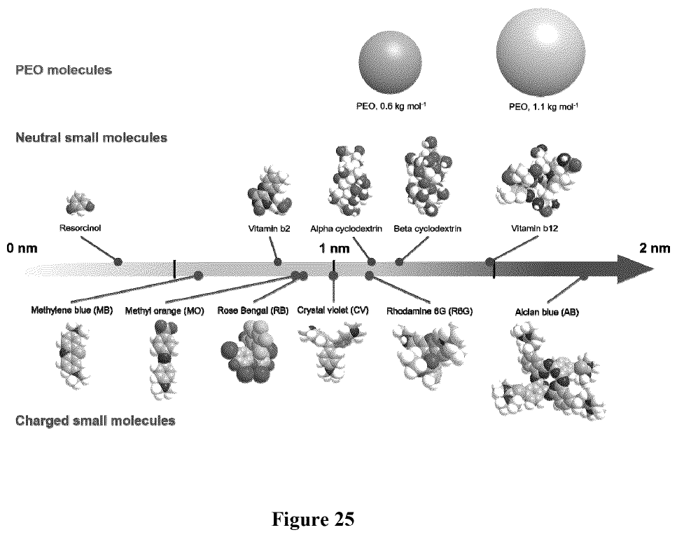

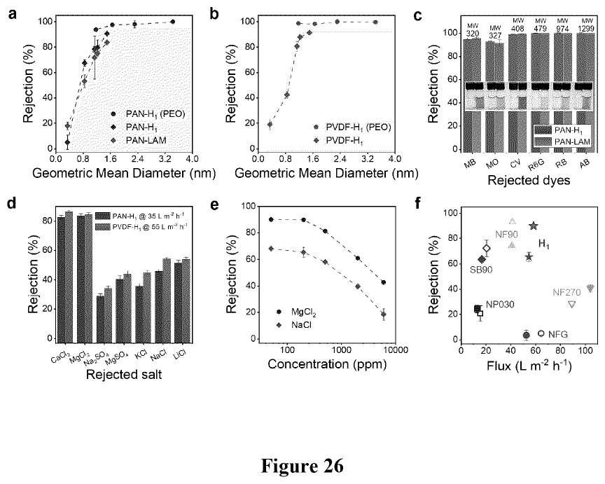

Molecular weight cut-off (MWCO) experiments were conducted to elucidate the intrinsic size-selectivity of mesophase templated membranes. The solute rejection was conducted by challenging membranes with polyethylene oxides (PEO) and a series of small neutral molecules with known sizes, with the geometric mean diameter ranging from ˜0.3 to 3 nm. The molecular dimension of the solutes is detailed in FIG. 25. The extent of rejection was then calculated by comparing the concentration of the solute in feed solution to the concentration measured from permeate at steady-state. While the hydrodynamic diameter of the PEO and cyclodextrins were acquired from literature, sizes for other small molecules with the asymmetric structure were determined from spatial dimensions estimated using the Chem3D software package. As such, the solute rejection curves summarized in FIG. 26A and FIG. 26B are demonstrating a sharp cut-off at 1-1.2 nm for LC-TFC membranes. The dimension of solute selectivity performance highlights the general correlation between the cylindrical structure of H₁ mesophase, along with the planar orientation determined from 2D X-ray analysis. Simultaneously, the separation capability of the ultra-thin LAM was quantified as a control, along with the rejection of small molecules with solute rejection curve PAN-LAM listed in FIG. 26A. In comparison with the PAN-H₁, a horizontal right shift in the MWCO is manifesting an alternated molecular selectivity originating from nanostructure transformation.

The solute rejection curves indicate H₁ membranes have a higher selectivity towards PEO molecules than other small molecules with a similar size. H₁ membranes almost completely rejected the smallest 600 g mol⁻¹ PEO that is ˜1.2 nm in diameter, with H₁-PAN (Rejection, R=94%) and H₁-PVDF (R=99%), respectively. In contrast, because the controlling dimension along the length of the cylinder is indefinitely extending, the nanoconfined H₁ template creates a rectangular aisle for the passage of irregularly shaped solutes. For example, while the H₁-PVDF partially gates the permeation of 1100 g mol⁻¹ beta-cyclodextrin with a geometric mean diameter of 1.2 nm (separation factor α=8.2), it blocks the passage of 600 g mol⁻¹ PEO molecule with a similar diameter of 1.2 nm (α=77). The difference in selectivity of solutes with ˜1 Å difference in size may be attributed to the minimum dimension of alpha-cyclodextrin equivalent to ˜0.8 nm, which is smaller than the limiting dimension ˜0.9 nm of the H₁ template. Therefore, the unique H₁ nanochannel conformation enables a capability to differentiate solutes with similar averaged size but different conformations selectively.

As demonstrated above, H₁ thin-films are capable of efficiently separating neutral solutes with a 1-nm dimension. However, since the separation of charged small molecules accounts for additional electrostatic double-layer and van der Waals interactions, more efficient organic contaminant purification based on organic dye molecules is demonstrated in FIG. 26C. While the rejection of the smallest solute 320 g mol⁻¹ methylene blue remained ˜95%, the mesophase membranes effectively rejected both cationic and anionic small molecules down to an exclusion limit 300 Da. Moreover, during the dye permeation, no significant reduction in the hydraulic permeance was recognized, indicating the absence of molecular fouling, and the separation is unrelated to charged species adsorption within H₁ interior.

Furthermore, the salt rejection experiment was investigated with a focus on understanding the role of electrostatic interactions, through the use of various salt solutions with a consistent ionic strength (I) at 10 mM and a constant transmembrane pressure 5.5 bar. The salt permeation detailed in FIG. 26D suggests the rejection appeared to be dominated by electrostatic interactions following the ion valence ratio in a manner consistent with the trend predicted by the Donnan theory, for which i and j refer to co-ion and counterion, respectively. As such, for PVDF-H₁, the salt rejection is generally suppressed while the ionic species were switched from A²⁺2B type (e.g., MgCl₂, R=85%) to 2AB²⁻ type (i.e., Na₂SO₄, R=34%) in the dilute salt regime. This phenomenon indicates the presence of competition in electrostatic interactions between the co-ions and counterions against the positively charged H₁ surface. Further, to understand the salt rejection at higher ionic strength regime with enhanced electrostatic screening, PVDF-H₁ was challenged with NaCl and MgCl₂, with concentrations increasing from 50 to 6000 ppm. As a result, a monotonic decrease in salt rejection listed in FIG. 26E was followed, where the final NaCl I˜100 mM lowered the rejection to R=18%, and the MgCl₂ I˜190 mM corresponded a rejection R=43%. The moderate rejection of Mg²⁺ at higher ionic strength may be related to the large hydrodynamic radii ˜0.43 nm compared with Na⁺˜0.36 nm. Therefore, H₁ may regulate the charged species transport through a combination of steric sieving and electrostatic interactions.

An extensive ionic transport evaluation was conducted to compare the performance of PVDF-H₁ with other commercially available nanofiltration membranes. The transport evaluation utilized 200 ppm NaCl and MgCl₂ as model solutes. The corresponding hydraulic flux, as well as the salt rejection, are recorded in FIG. 26D. Significantly, the H₁ TFC outcompetes common asymmetric polymeric nanofiltration membranes such as cellulose acetate SB90 or polyethersulfone NP030. Meanwhile, a hydraulic flux 55⁺ L m⁻² h⁻¹ from the H₁ testbed is similar to other high-flux polyamides TFCs, such as NFG and NF90. Although the NF270 possesses a higher flux, this polyamide has a lower permeability 0.6 L m⁻² h⁻¹ bar⁻¹ μm compared to the 2 L m⁻² h⁻¹ bar⁻¹ μm of H₁. In turn, after appropriate optimizations from various engineering disciplines, the hydraulic permeance from nanostructured H₁ with unique water transport channels is exhibiting great potential to outcompete commercial materials.

The architecting and the fabrication of nanostructured templates for nanofiltration had previously overlooked rational water-channel design. Herein, the design of ultra-thin, but defect-free planar oriented direct columnar (H₁) nanofibrils fabricated in a rapid and scalable membrane casting protocol, has been shown to possess a hydraulic permeance 10 L m⁻² h⁻¹ bar⁻¹, which is similar to high-performance commercial TFC membranes. The high fidelity-retention of the mesophase during crosslinking achieved a well-defined critical separation dimension at ˜1 nm that demonstrated ˜9 fold difference in the separation factor of neutral solutes less than 1 Å apart by their geometries. Additionally, the high density of quaternary ammonium hydrophilic head groups contributes an enhanced selectivity of H₁-TFC in charged species separations, in addition to improved biofouling performance.

### Materials

All chemicals used in this study were purchased from Sigma-Aldrich and used as received unless otherwise noted. Ultrafiltration supports and commercially available nanofiltration membranes were purchased from the Sterlitech Corporation. The glycerol stock solution was prepared through mixing 90 wt. % of ≥99.5% glycerol (Thermo Fisher Scientific) with 10 wt. % DI water (R=18 MΩ cm). Solid photo-initiator 2-methoxy-2-phenylacetophenone (Acros Organics) was dissolved in a stock solution of hexanediol acrylate (HDDA, Alfa Aesar, Ward Hill, MA) at a concentration of 1 wt. %.

### Synthesis of Polymerizable Surfactant, AETDAB

The cationic surfactant, [2-(acryloyloxy)ethyl]dimethyl tetradecyl ammonium bromide (AETDAB) was synthesized using an adapted single-step, Menshukin reaction as follows: a mixture of 2-(dimethylamino)ethyl acrylate (15 g, 0.2 mol), 1-Bromotetradecane (32 g, 0.11 mol), and hydroquinone (0.6 g, 0.05 mol) were dissolved in a 250 mL binary solvent composed of 50/50 (v/v) acetonitrile and tetrahydrofuran. Once a homogeneous mixture was acquired, the reactant solution was then transferred to a 500 mL reaction flask containing a magnetic Teflon® (DuPont de Nemours, Wilmington, DE, USA) stir bar. Subsequently, the flask was refilled with nitrogen and was stirred at 40° C. in an oilbath for 72 hr. After this time, the orange-colored solution was allowed to cool down to room temperature. Subsequently, the solid product was obtained from precipitating and rinsing the reaction mixture with an excess amount of cold, anhydrous diethyl ether at least 3 times. Finally, the product was dried under vacuum overnight. ¹H nuclear magnetic resonance (NMR) spectra of the AETDAB was collected from a Bruker AVII 500 spectrometer using deuterated chloroform (CDCl₃) as the solvent.

### Crosslinking H₁ Films for Nanostructural Characterizations

The self-assembled lyotropic H₁ mesophase at bulk was prepared by mixing a ternary mixture of 65 wt. % AETDAB, 31 wt. % glycerol, and 4 wt. % HDDA doped with the photoinitiator until a homogeneous, lyotropic liquid crystal phase was generated. In order to fabricate mesophase film at bulk, lyotropic gel samples were sandwiched between two sonication pre-cleaned glass slides to confine a film thickness c.a. 100 μm.

Meanwhile, H₁ thin-films (i.e. with thickness ≤1 μm) were cast from solutions of mesophase precursors dissolved in organic solvent (i.e., ethyl acetate) by spin-coating with a range of concentrations from 3 to 20 wt. %. These thin-films were supported by silicon wafers with one side exposed to air. In this manner, ultrathin mesophase films were directly coated on the selected substrates at a spin-speed of 2000 rpm for 1 min with pre-determined concentrations. Thin-films were prepared on both pre-cleaned (100) silicon substrates and on cleaned glass slides. In the later portion of the study, in order to understand the phase behavior of thin-films in the presence of modified substrate chemistry, silicon substrates were coated with a thin layer of polyvinyl pyrrolidone (PVP) that resembles the sacrificial layer in the membrane fabrication process. To prepare the sacrificial layer, a 20 wt. % 55 kg mol⁻¹ PVP casting solution composed of 50/50 (w/w) water/ethanol was spin-coated on silicon substrates using a spin-speed of 3000 rpm for 5 min. Further, in order to explore the phase behavior of the LC mesophase thin-film during the crosslinking, 20 wt. % mesophase dissolved in acetonitrile was spin-coated on glass slides with photoinitiator doping ranging from 0.04 to 1 wt. %. Additionally, prior to crosslinking, the self-assembled mesophase films for optical analysis were subsequently annealed and slowly cooled to develop spherulites with cylinders tangentially arranged for enhanced visual contrast.

Finally, photoinitiated crosslinking of the mesophases was conducted through illuminating a focused UV-beam (100-W Sunspot SM) on films at a distance of 8-cm under N₂ atmosphere for 25 min. The conversion of the photoinitiated crosslinking reaction at bulk was estimated from the Fourier Transform Infrared Spectra (FTIR), which was collected from a Jasco FT/IR-6800 FTIR spectrometer over the range of wavenumbers from 300≤ν≤400 cm⁻¹.

### Fabrication of H₁ Thin-Film Composites

A sacrificial layer methodology was employed to build a dense but water-soluble surface layer atop ultrafiltration supports prior to mesophase solution coating. With the sacrificial layer barrier, potential solution infiltration into the support which could lead to additional hydraulic resistance at the H₁-support interface was prevented. Specifically, two ultrafiltration mesoporous membranes with different macromolecular chemistries and molecular weight cut-off (MWCO) greater than 400 kg mol⁻¹ were investigated as structural supports.

Polyacrylonitrile (PAN, MWCO 400 kg mol⁻¹, Synder PX from Sterlitech Corporation) and polyvinylidene fluoride (PVDF, MWCO 500 kg mol⁻¹, Synder V6 from Sterlitech Corporation) ultrafiltration membranes were coated with a layer of water-soluble PVP thin-film. The coating was conducted through spin-coating different PVP solutions at a consistent spin rate at 3000 rpm for 5 min. A casting solution consisting of 55 kg mol⁻¹ PVP dissolved in 50/50 (w/w) water/ethanol was used for coating PAN ultrafiltration support. Similarly, 12 wt. % 360 kg mol⁻¹ PVP dissolved in ethanol was coated on PVDF support. Supports with sacrificial layers were dried under vacuum before immediate use in the following H₁ composite membrane fabrication.

H₁ composite membranes were prepared in a fume hood situated in an air-conditioned laboratory with a regulated temperature between 18 to 23° C., and relative humidity between 20 to 60%. The membrane casting solution was prepared by dissolving mesophase precursors in a solution of ethyl acetate at a concentration of 10 wt. %. The homogeneous solution was filtered through a 0.2 μm polytetrafluoroethylene (PTFE) syringe filter and degassed before use. In order to cast a composite membrane, the mesophase solution was dropped on the selected support and was spin-coated at 2000 rpm for 1 min. The film was then immediately transferred into a nitrogen atmosphere, and was illuminated by the focused UV-beam for 25 minutes for crosslinking. The composite membranes were then tailored into appropriate sections for further experiments.

### Structural Characterizations

The liquid crystal birefringence textures were analyzed by POM using a Zeiss Axiovert 200 M inverted microscope. Corresponding polarized light images were captured from a CCD camera connected to a computer. For imaging, the domain textures from the lyotropic mesophase were annealed through heating and slow cooling protocols to develop typical liquid crystal textures for characterization.

X-ray spectra were collected in the Dual Source and Environmental X-ray Scattering facility operated by the Laboratory for Research on the Structure of Matter at the University of Pennsylvania, using a Xeuss 2.0 system (Xenocs). The GeniX3D Cu source provides a wavelength of λ=1.54 Å. A consistent sample to detector distance 55 cm covered a range of accessible scattering vectors (q) from 0.016 to 1.02 Å⁻¹ was maintained, and the 2-D scattering patterns were acquired with the line-eraser mode. Corresponding scattering patterns were azimuthally integrated into 1-D plots using the Foxtrot software package for scattering intensity (I) versus q, where q=4π sin(θ)/λ and the scattering angle is 2θ. Silver behenate was used as a calibration standard. For transmission scattering experiments, samples were packed between Kapton® (DuPont de Nemours, Wilmington, DE, USA) windows. In the case of grazing incidence small-angle X-ray scattering (GISAXS) experiments, silicon substrates (with both care SiO₂ and PVP treated surface) were mounted on a standard GISAXS holder with an incidence angle between the substrate surface to the X-ray maintained from 0.17 to 0.2°. It should be noted that the characteristic q_{z}′>>q_{c} (˜0.01 Å⁻¹), where the q_{z}′ is the perpendicular q projection, and the q_{c} is the q corresponding to the critical angle. As such, the 1-D plots from 2-D GISAXS pattern were integrated by estimating q_{z}′˜q_{z}.

A JOEL 7500F Field-Emission Scanned Electron Microscope HR-SEM was utilized to characterize the nanoscale morphology of the crosslinked composite membranes and their supports. The surface characterization was based on sectioning vacuum-dried samples into 10 mm×10 mm pieces. In order to prepare samples for cross-sectional imaging, dried samples were immediately cryo-fractured after submerging sections in a bath of liquid nitrogen for ˜20 s. Samples were mounted on standard pin-stubs using carbon tape and were subsequently sputter-coated with ˜3.0 nm of iridium, then loaded into the SEM chamber. Micrographs were photographed at a working distance of 8.0 mm with a consistent accelerating voltage of 10 kV.

Height-profile analysis of the silicon substrate supported H₁ thin-film was performed using a Bruker Dimension Icon Atomic Force Microscope (AFM) at the tapping mode with a MikroMasch HQ:NSC15/AL BS probe.

Mechanical characterization based on a TA Instrument ARES-G2 rheometer measured the toughness of the crosslinked H₁ material. Specifically, crosslinked rectangular samples in bulk were clamped to a tensible attachment loaded on the rheometer. The clamp pressure was sufficiently high to hold the samples in place without deforming the original conformation. The tensible force was measured over time as the samples were vertically strained along the longitudinal direction, at a rate \dot{γ}=0.001 s⁻¹ until the samples failed.

### Transport Characterizations

The thin-film composite H₁ membranes were transferred into a 50-ml Millipore Amicon stirred cell (UFSC05001) situated in the lab with room temperature between 15 to 18° C. The composite membrane was oriented with the surface layer facing the feed solution and was supported by a 4.5-cm-diameter PP/PE nonwoven mat. A customized stainless steel disk with a circular opening was used to confine a controlled filtration area, corresponding to an active surface area of 2.4 cm² available for solvent permeation. Compressed nitrogen gas with a well-regulated transmembrane pressure ranging from 1 to 80 psi was used to drive the solute rejection and hydraulic permeance characterization experiments. Before starting the solute rejection experiments, the H₁ thin-film composites were rinsed thoroughly within the stirred cell to remove the sacrificial layer. The membranes were continuously permeated with DI water and 10 mM NaCl solution for ˜8 hrs before starting to collect specific permeate solutions. The solution permeated from the membrane was collected in a capped glass container or a polypropylene tube (for cationic dye solutions) situated on an electronic balance.

The molecular weight cut-off (MWCO) experiments were conducted using molecules with known sizes to characterize the size-selective solute separation performance. A range of solutes with the geometric mean diameters ranging from ˜0.4 to 4-nm was chosen to challenge the H₁ composite membrane. As such, a series of small molecules of vitamin B12 (VB12), beta-cyclodextrin, alpha-cyclodextrin, vitamin B2 (VB2), and resorcinol were coupled with poly(ethylene oxide) (PEO, Polymer Source, Inc., Dorval, Canada) standards with number averaged molecular weights of 0.60, 1.1, 2.0 and 4.0 kg mol⁻¹ and polydispersity values of 1.1 or less. In order to prepare small molecule feed solutions, solutes were dissolved in DI-water at a concentration of 0.1 mM. Meanwhile, the PEO feed solutions were formulated with 1 g L⁻¹ polymer in DI-water. Similarly, dye rejection experiments were performed by permeating 0.1 mM solutions of alcian blue (AB), rhodamine 6G (R6G), crystal violet (CV), rose Bengal (RB), methyl orange (MO) and methylene blue (MB) that are dissolved in DI-water through the membrane. During these solute rejection experiments, single species solute solution was permeated through the membrane bearing hydraulic flux at ˜18 L m⁻² h⁻¹, with the cell stirred at 400 rpm to reduce the concentration polarization. At least 5 ml feed solution was permeated through the membrane from every single rejection experiment. It should be noted that no significant molecular fouling (i.e., reduction in hydraulic permeance, or irreversible dye deposition on the membrane) was observed during the rejection experiments.

The concentration of the permeate solution was analyzed by a Cary 100 ultraviolet-visible (UV-Vis) spectrometer which calculates the concentration of the analyte using Beer-Lambert's Law. A modified Dragendorff reagent method was used for the quantitative determination of the PEO solution concentration with a minimum coefficient of determination >99.5% in calibration using linear regression. The observed percent rejection was calculated by comparing the solute concentration in the permeate to the feed through the following equation.

$${R}_{o} ( \% ) = ( 1 - \frac{{C}_{p}}{{C}_{f}} ) \times 100 \% \qquad ( S1 )$$

In this equation, Cₚ represents the concentration of the permeate, and C_{f} is the concentration of the feed. The intrinsic rejection was calculated by correcting the percent rejection of the effect of concentration polarization, by a function of volumetric water flux J_{w} and mass transfer coefficient k.

$${R}_{a} ( \% ) = 1 - {R}_{a} + {R}_{a} exp ( \frac{{J}_{w}}{k} ) \qquad ( S 2 )$$

In order to estimate the mass transfer coefficient, the Colton-Smith empirical correlation reported in prior literature is assumed.

$$\frac{kr}{{D}_{i}} = 0.285 \cdot {( \frac{v}{{D}_{i}} )}^{\frac{1}{2}} \cdot {( \frac{ω {r}^{2}}{v} )}^{0.567} \qquad ( S 3 )$$

Here, r stands for the projected stirred cell radius, Dᵢ is the solute diffusion coefficient, ν represents the kinematic viscosity and the ω indicates the cell stirring speed at 42 radians per second. The solute diffusion coefficient is calculated with the Stoke-Einstein equation, in which the solute dimension rₛ was directly retrieved from literature, or calculated through the Chem3D software package.

$${D}_{i} = \frac{{k}_{B} T}{6 π {r}_{s}} \qquad ( S 4 )$$

From the above calculations, the ratio of the volumetric water flux J_{w} to the mass transfer coefficient k was kept below 0.6 in the solute rejection experiments. This ratio suggests that there is no severe concentration polarization.

The single salt rejection experiment was performed in two parts, in which a consistent ionic strength salt screening assay and an ionic strength dependent rejection were investigated in detail. In the first portion of the assay experiment, the rejection assay involved a series of single salt solutions containing CaCl₂), MgCl₂, Na₂SO₄, MgSO₄, KCl, NaCl, and LiCl prepared with a consistent ionic strength 10 mM. Meanwhile, additional single salt MgCl₂ and NaCl solutions were prepared in a range of concentrations (by weight) ranging from 50 to 6000 ppm for the ionic strength dependent salt rejection experiment. In both parts, compressed-nitrogen driven salt solution flow permeated through the membrane at a constant transmembrane pressure 80 psi, with the cell stirred at 400 rpm. At least 8 ml permeate solution was collected from each salt rejection experiment, and the salt concentration of the permeate was compared to the feed to calculate the percent rejection. Between salt rejection experiments, membranes were rinsed thoroughly with DI-water 3 times, and the dead-volume within the cell was subsequently flushed with ˜3 ml DI water. An Oakton Con 11 conductivity meter was used to assess the salt concentrations.

In order to compare the performance of H₁ with other commercially available nanofiltration membranes, flat-sheet nanofiltration membranes purchased from the vendor were packed within the same stirred cell filtration setup as described above. A series of different nanofiltration membranes, including Filmtech™ polyamide NF270 (DuPont DeNemours, Wilmington, DE, USA), Filmtech™ polyamide NF90, Synder® polyamide NFG (Synder Filtration, Vacaville, CA, USA), Trisep® cellulose acetate SB90 (MicrodynNadir, Wiesbaden, Germany), and MicrodynNadir® polyethersulfone NP030 (MicrodynNadir, Wiesbaden, Germany) were investigated in detail. Membranes were rinsed with DI-water for ˜8 hr prior to starting the salt rejection experiment using 200 ppm NaCl and MgCl₂ as model solutes. The salt rejection experiment utilized the same protocol as described above.

### The Calculation for Critical Pore Dimension

The crosslinked H₁ template follows a direct lyotropic hexagonal close-packed nanostructure. Detailed nomenclatures are listed in FIG. 7. The water-continuous channels are provided by the cylinders following a center-to-center distance of d=3.6-nm. By calculating the total weight fractions of the surfactant and the crosslinker, the weight fraction of the cylinders, w_{CYL}=0.69. However, since the counterion Br⁻ is water-soluble, a cylinder volume fraction ϕ=0.56 is assumed. Hence, the corresponding volume fraction of the water transport channel is 1−ϕ=0.44. Therefore, the critical pore dimension of the H₁ membrane is estimated by the following geometrical analysis.

$$δ = l - {r}_{f} \qquad ( S5 )$$

$$t = l \cdot sin ( \frac{π}{3} ) = 2.1 nm \qquad ( S6 )$$

$$2 δ = d [ \frac{4}{3} - {( \frac{8 ϕ}{\sqrt{3} π} )}^{\frac{1}{2}} ] = 1.5 nm \qquad ( S7 )$$

$${S}_{x} = 2 t - 2 {r}_{f} = d [ \sqrt{\frac{4}{3}} - {( \frac{8 ϕ}{\sqrt{3} π} )}^{\frac{1}{2}} ] = 0.89 nm \qquad ( S8 )$$

$${S}_{y} = 3 l - 2 {r}_{f} = d [ 2 - {( \frac{8 ϕ}{\sqrt{3} π} )}^{\frac{1}{2}} ] = 3.9 nm \qquad ( S9 )$$

Therefore, the number of nanochannels packed within 1 m² membrane surface area is approximated using the following equation.

$$N = \frac{1 m}{2 t} = 2.4 \times {10}^{8} \qquad ( S10 )$$

The corresponding surface porosity e can be derived from a simple derivation.

$$ε = \frac{2.4 \times {10}^{8} \cdot {S}_{x} \cdot 1 m}{1 {m}^{2}} \times 100 \% = 21.4 \% \qquad ( S11 )$$

In addition, the intrinsic tortuosity T within an array of planar orientated H₁ can be simply calculated using the result from the above estimation.

$$τ = \frac{2 l}{d} = 1.33 \qquad ( S12 )$$

### The Calculation for Theoretical Hydraulic Permeability

The dimensionless permeability k* predicted from assuming a periodic array of ordered single-layer, parallel cylinders in low Reynolds number is estimated using the following relation:

$${K}^{*} = \frac{2 \sqrt{2}}{9 ∅} {( 1 - \sqrt{\frac{4 ∅}{π}} )}^{3 / 2} \qquad ( S13 )$$

In the case that a solid volume fraction Ø=0.56 is assumed, k*˜0.0054. In turn, the Darcy permeability k is derived from a simple relation as:

k=k*·r_{f}²=1.29×10⁻²⁰ m² (14)

Alternatively, the hydraulic permeability P for water at room temperature is calculated:

$$P = \frac{k}{μ} = 1.17 \times {10}^{- 17} \frac{{m}^{2}}{Pa \cdot S} \qquad ( S15 )$$

Here the μ refers to the water viscosity at 16° C., where μ=0.0011 Pa·s. In order to convert the calculated hydraulic permeability to hydraulic permeance, a multilayer parallel arranged cylindrical matrix with a thickness δ=200 nm and a tortuosity τ′=2 is assumed:

$${L}_{v} = \frac{P}{δ {τ}^{′}} = 2.9 \times {10}^{- 11} \frac{m}{Pa \cdot S} \sim 10 \frac{L}{{m}^{2} h bar} \qquad ( S16 )$$

In conclusion, the invention provides novel polymer films and approach for fabricating polymer films wherein the films comprise highly aligned cylindrical polymer fibers, oriented parallel to the film surface. This approach relies on the use of the self-assembly of polymerizable surfactants into a hexagonally packed columnar H₁ mesophase, which can be polymerized and crosslinked to preserve the H₁ mesophase morphology and produce films comprising polymer fibers and nanochannels oriented parallel to the film surface. The alignment methods are highly scalable and facile production of large area thin films for membrane applications may be possible.

The resulting nanochannel materials demonstrate remarkable size and charge selectivity in membrane transport experiments, as well as high permeation rates. These aligned nanochannel materials will be useful in a wide range of applications from nanofiltration to analytical chemistry and lithographic pattern transfer.

### Example 3—Organic Solvent Nanofiltration with Tunable Selectivity at the 1-Nm Scale in Self-Assembled Nanoporous Membranes

A third aspect focuses on the fabrication of cross-linked hexagonal mesophase-based membranes for organic solvent nanofiltration (OSN) and data relating to their solute rejection and permeability characteristics. The utilization of self-assembled systems for OSN offers the possibility of fine-tuning the filtration characteristics of membranes by appropriately altering the size of the molecular building blocks, and/or their concentration in the phase. A series of mesophases was prepared using surfactants having differing alkyl chain lengths and differing crosslinking chemistries. The resulting membranes exhibited systematic variation in pore size that manifested accordingly in their transport characteristics. In comparison to several recently reported polymeric OSN membranes, the mesophase-derived membranes described herein are highly ordered and display higher solvent permeabilities. These nanostructured membranes were shown to operate effectively in sieving-based separation, as demonstrated by solute rejection experiments in different organic solvents. The self-assembled materials explored here provide a new paradigm for membranes with tunable nanostructure for OSN applications.

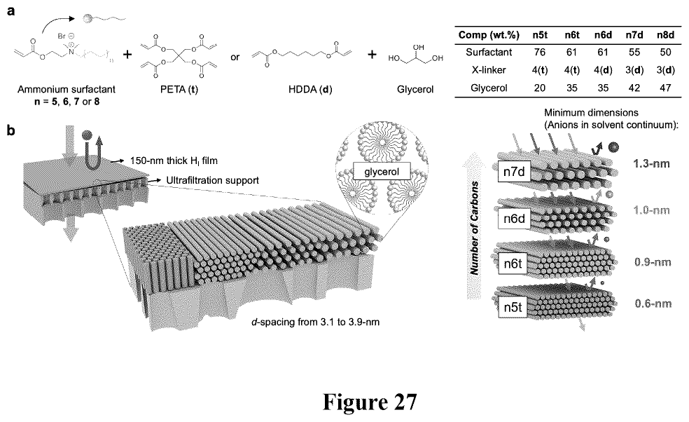

A series of polymerizable surfactants that feature a hydrophobic ethyl acrylate group and alkyl tail jointly linked to a hydrophilic quaternary ammonium head group were used. These molecules were synthesized using a one-step Menshutkin reaction (as discussed above) targeting different carbon chain lengths. Mesophases are prepared by mixing the surfactants with glycerol (containing 10 wt. % water) and a selected cross-linker (either pentanethiol tetraacrylate (PETA, denoted t in the naming protocol below) or hexanediol diacrylate (HDDA, denoted d in the naming protocol below) with designated weight fractions, shown in FIG. 27A. Four polymerizable surfactants were used with differing alkyl chain lengths corresponding to 18 (n8), 16 (n7), 14 (n6) and 12 (n5) methylene groups in the hydrophobic tail. Each surfactant was screened to identify appropriate compositions that provided stable hexagonal lyotropic mesophases at room temperature. All four species formed H₁ mesophases with unit cell dimensions of 3-4 nm. The mesophases were designated according to the type of surfactant molecule and the cross-linker presented within, as n5t, n6t, n6d, n7d, and n8d, respectively.

Glycerol is a low volatility liquid (vapor pressure <1 torr at 20° C.). As such, its use as the medium for lyotropic assembly facilitates structure retention during solution-based processing by avoiding changes in composition due to evaporative loss. The components of the mesophase were dissolved in ethyl acetate at 10 wt % (vapor pressure ˜70 torr at 20° C.) to yield a low viscosity solution. The solution was spin-coated on various substrates, followed by ultraviolet (UV)-initiated cross-linking in a nitrogen atmosphere to produced solid films. The mesophase structure in fabricated thin films was examined by high-resolution polarized optical microscopy (POM) coupled with grazing-incidence small-angle X-ray scattering (GISAXS) on different substrates. Comparison of the optical textures of the mesophase in its initial lyotropic gel state, versus those in the crosslinked gel reveal excellent retention of the hexagonal structure after UV-induced crosslinking.

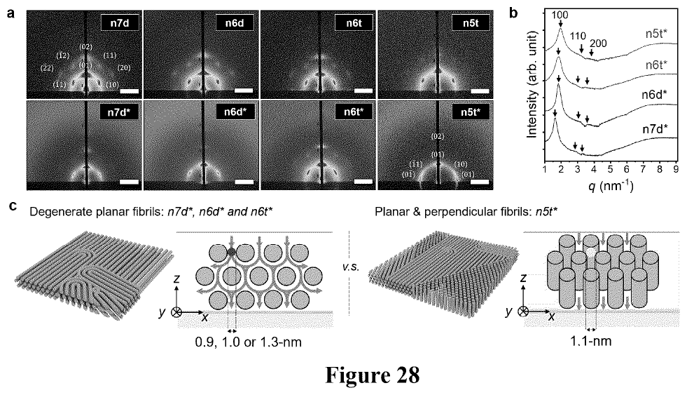

GISAXS was conducted for thin films prepared by spin-coating 10 wt. % mesophase solutions on polished silicon wafers, and on wafers coated with a thin layer (3 um) of polyvinyl pyrrolidone (PVP). PVP coated surfaces were investigated as its orthogonal solubility relative to the crosslinked mesophase makes it a good sacrificial layer for membrane fabrication on porous supports (discussed below). Data are shown in FIGS. 28A and B. For mesophases containing surfactants with hydrophobic tails shorter than 18 carbons, the higher-order Bragg reflections from one-dimensional integration of the GISAXS data from the PVP-H₁ composites occur at scattering vector ratios of 1:√3:√4. This is consistent with high-fidelity retention of the H₁ mesophase structure after cross-linking (FIG. 28b). However, the crosslinking of the n8d mesophase was accompanied by disruption of the mesophase order, as manifested by a marked change in optical textures observed by POM. GISAXS data indicate that the n8d system undergoes a transformation to a lamellar structure during crosslinking.

The 2D GISAXS data provides information regarding the orientation of the nanostructures produced by spin-coating and crosslinking the mesophases. The hexagonal symmetry observed for n7d, n6d and n6t on both silicon and PVP coated surfaces indicates that the crosslinked fibers in the system are oriented with their long axes parallel to the plane of the substrate. By contrast, for n5t, while such a planar configuration was observed on silicon substrates, a mixture of planar and perpendicular, or vertical, cylinders was observed for films prepared on PVP coated surfaces. The existence of vertically oriented cylinders is implied by the concentration of scattering intensity along the equatorial line of the scattering plane. The observed mixture of planar and perpendicular cylinders was found for n5t samples prepared from a broad range of surfactant concentrations. It may be possible that the effect of the PVP coating on the morphology is more pronounced for this 10-carbon alkyl surfactant system, relative to the others. One possible explanation is that the planar configuration is metastable, and kinetically dictated during the rapid assembly during spin-coating, following which the low mobility of longer-chain surfactant mesophases precluded rearrangement. It is also possible that the observed differences are related to differences in the energetics of the substrate interactions, which can vary considerably with composition and molar mass of the constituent species. For the planar arrangements, the orientation of the cylinders in the plane of the film is not constrained, as evidenced by the lower intensity of the off-meridional (10) reflections relative to the meridional (01) reflection. Further, the discrete azimuthal intensity variation indicates that there is a preferred orientation of the hexagonal lattice in the films, with the close-packed planes parallel to the film surface.

The display of planar vs perpendicular orientations of the cylinders has implications for selective transport in the fabricated films. The transport limiting dimension for solutes traveling through the film along its thickness (the z-axis) is larger for perpendicular cylinders than it is for planar cylinders. The ratio between the two is the diameter of the circular void at the center of a triangle connecting the centers of 3 nearest neighbor cylinders relative to the distance between surfaces of any pair of nearest neighbor cylinders. This ratio, P=2δ/Sₓ=(4/3−ξ)/[(4/3)^{1/2}−ξ] where ξ=(8φ/\sqrt{3}π)^{1/2} for a system with volume fraction of crosslinked cylinders given by φ. For example, with φ=0.50, P is 1.6. From the d100 spacings provided by GISAXS, we calculate the transport limiting dimensions associated with the planar and mixed planar/perpendicular orientations of the cylinders. For n5t, the transport limiting dimension is 2δ, associated with travel parallel to the cylinder axes, whereas for the other mesophases, it is the smaller critical dimension, Sₓ, associated with travel orthogonal to the cylinders. The transport limiting dimensions ranged from ˜0.9 to 1.3-nm, as shown in FIG. 28C.

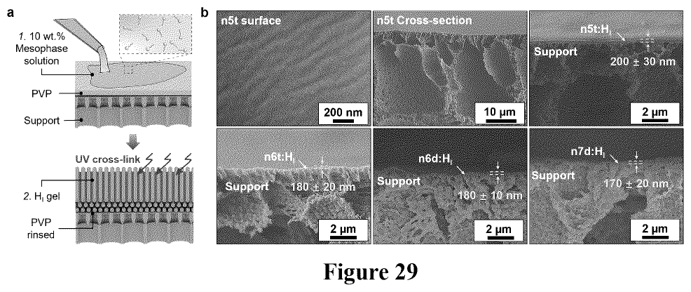

Thin (i.e. less than 200 nm) membranes were prepared for the characterization of transport properties by spin casting thin layers of the lyotropic mesophases on a sacrificial layer coated on ultrafiltration supports. The sacrificial layer prevents the infiltration of the mesophase solution into the support membrane during casting. The fabrication process is illustrated in FIG. 29. A PVP film of 3 μm thickness was coated on polyvinylidene fluoride (PVDF) ultrafiltration membranes by spin coating to form a composite. Subsequently, mesophase solutions in ethyl acetate were directly spin-coated on the composite. PVP is insoluble in ethyl acetate and therefore prevents entry of the mesophase into the PVDF support. The mesophase thin film was kept quiescently under ambient conditions for 1 minute to facilitate solvent evaporation, then photopolymerized by exposure to UV light. The resulting composite membranes were permeated with deionized (DI) water in a stirred dead-end filtration cell for 12 hours, until steady permeances were recorded, indicating that the sacrificial layer had been fully removed. Membranes were kept in the filtration cell for the weeks-long duration of their testing. No delamination of the selective layer from the underlying support was observed during this period.

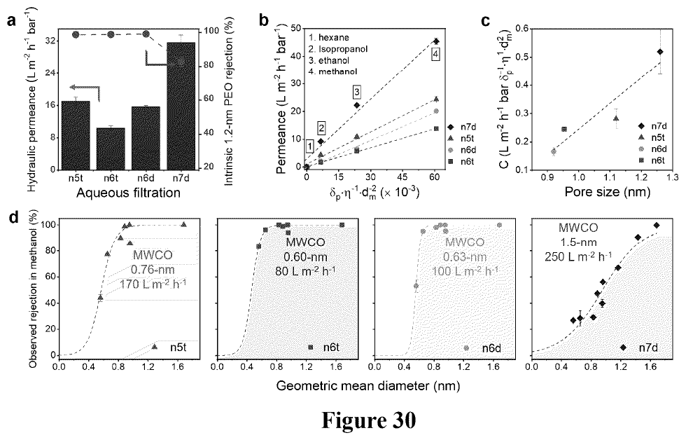

The transport properties of the membranes were first characterized using aqueous solutions (dielectric constant, ε=80.2) containing 1.2-nm hydrodynamic diameter polyethylene glycol (600 g mol⁻¹ PEG).³⁷⁻³⁹ The measured hydraulic permeance was consistent with the theoretical estimate of permeance based on the assumption of ordered cylinders in parallel or mixed orientations of perpendicular and planar. Complete rejection was observed for membranes based on mesophases with calculated limiting dimensions lower than 1.2-nm as shown in FIG. 30A. The n7d membranes, with a transport regulating dimension estimated at 1.3 nm, demonstrated a rejection of 83%. The transport regulating dimension was estimated based on the simplifying assumption that the Br⁻ counterion is a fixed part of the mobile phase. It is possible that the degree to which Br⁻ is part of the stationary vs. the mobile phase is a strong function of solvent polarity. It is anticipated that the effective pore size may be modestly larger in high polarity media such as water that favors dissociation of the counterion from the quaternary ammonium co-ion. Nevertheless, the observed rejections, under convective transport conditions, indicate the regime of solute sizes that can be effectively filtered by the membranes.

Prior to performing organic solvent filtration experiments, we examined the stability of the membranes on exposure to various solvents by GISAXS measurements using n6d as a model system. Cross-linked films on silicon wafers were immersed in various solvents, and then vacuum dried for subsequent structural characterization. GISAXS data show a preservation of structure, as manifested by retention of hexagonally arranged Bragg spots with a d₁₀₀ spacing of approximately 3.4 nm. These data indicate that the membranes retained their nanostructure in the presence of the organic solvents considered here.

Organic solvent permeation experiments were conducted in dead-end filtration cells at 20° C. Data is shown in FIG. 30B. Permeance was derived from the linear regression of solvent flux to the applied pressure. The solvent permeances and solute rejections did not change measurably over the weeks-long durations of the permeation tests. This steady transport performance indicates that the nanostructures within the membrane, and the composition overall, were highly stable under the test conditions. The highest permeance recorded was 45 L m⁻² h⁻¹ bar⁻¹ for passage of methanol through a n7d membrane. The same membrane showed a 5× reduction in permeance for isopropanol, while hexane exhibited no measurable permeation, even at a high transmembrane pressure of 28 bar.

The membranes described herein provide precise, small changes in transport regulating dimensions that are narrowly distributed. Analysis of water flux normalized data suggests that the proportionality factor scales linearly with pore size.

Rejection experiments were performed in methanol (ε=32.7) using a constant transmembrane pressure 5 bar, and a variety of molecular solutes with sizes in the range of 0.5-2 nm. The membranes displayed distinct rejection characteristics. As shown in FIG. 30D, the molecular weight cut-off (MWCO) varied from ˜0.6 to 1.5 nm across the 4 types of membranes considered. This range of sizes corresponds to ˜290 to 800 g mol⁻¹ in terms of molar mass. The methanol flux recorded during the nanofiltration of neutral red (NR, 289 g mol⁻¹) are indicated on each MWCO curve. Membranes n6d and n6t demonstrate similar selectivity with only a minor difference in their MWCOs. (320 vs 290 g mol⁻¹ respectively). This is unsurprising given the single Angstrom difference in their lattice constants, with d₁₀₀ spacings of 3.4 and 3.5 nm. Meanwhile, the n8d membrane with the largest d-spacing of 3.9-nm exhibited a cut-off at 1.5 nm, and correspondingly displayed the highest solvent flux, 250 Lm⁻² h⁻¹. For n5t membranes, the large MWCO of 350 g mol⁻¹ reflects the larger transport limiting dimension in this system despite having the smallest d-spacing of 3.1 nm. As discussed earlier, this is due to the presence of some vertical oriented cylinders, which result in larger pores being available for transport than the case for all planar cylinders.

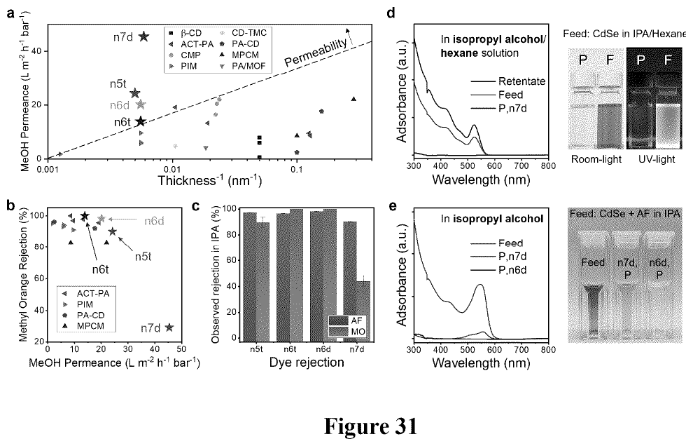

FIG. 31A provides a summary of methanol permeance versus the reciprocal membrane thickness for our mesophase-derived membranes, along with data for several recently reported polymeric OSN membranes. The mesophase-derived membranes exhibited higher permeance, and in the majority of cases, also higher permeability, relative to recently reported systems. A more detailed performance comparison is provided by considering solute rejection as a function of solvent (methanol) permeance, shown in FIG. 31B. The data highlight the improved permeance available at high rejection levels. In the case of n7d, the data are uncorrected for the effects of concentration polarization, which negatively affect rejection under high flux conditions. Solute rejection performance was examined in isopropyl alcohol (IPA, ε=19.9) at a consistent solvent flux ˜10 L m⁻² h⁻¹. As shown in FIG. 31C, the n7d membrane exhibits a higher rejection to both acid fuchsin (AF) and methyl orange (MO) in the IPA rejection experiment than in methanol, and demonstrate an improved MWCO of ˜0.9-nm (590 g mol⁻¹).

The filtration of particulate species in a mixed solvent, and competitive filtration of particulate and molecular species in a single solvent were investigated using CdSe quantum dots, and mixtures of these dots with molecular dyes, respectively. 2.7-nm photoluminescent CdSe quantum dots were dispersed in a 1:1 vol. mixture of IPA and hexane, and the suspensions filtered using n7d membranes. The quantum dots were completely rejected by the membrane, as expected based on the 1.3 nm pore size for this system (FIG. 31D). The experiment also highlighted the differential permeation of IPA and hexane. Cd photoluminescence (PL) is sensitive to the nature of the surrounding solvent, and in particular, PL is reduced in IPA, relative to hexane. PL data showed enhanced PL in the retentate, relative to the feed, indicative of HEX enrichment in the feed due to its rejection by the membrane. This highlights potential utility in solvent separations for these membranes.

Experiments in 100% IPA also resulted in complete rejection of CdSe, in n6d and n7d membranes. Data for competitive rejection experiments for CdSe in the presence of AF in IPA are shown in FIG. 31E. Both membranes rejected CdSe completely. The n6d membrane rejected AF completely, but roughly 10% AF permeated across the n7d membrane. In another dual solute rejection experiment, approximately 40% and 15% MB permeated across n7d and n6d membranes, respectively, while fully blocking the quantum dot nanoparticles.

Self-assembled membranes for high-performance OSN in the 1 nm regime were demonstrated. Rapid fabrication of mesophase-derived membranes was enabled by a facile solution process. The cross-linked nanostructures exhibited resiliency in both the aqueous medium and a range of organic solvents. While the self-assembled mesophases are thermodynamically defined, the targeted solute separation character can be rapidly screened and tailored for the required solute dimensions. Distinct channels derived from lyotropic self-assembly were designed, and their sizes and channel orientations were identified by X-ray diffraction coupled with solute permeation experiments, giving well-defined molecular weight cut-off curves between 0.6 to 1.5-nm. The unique transport feature from the H₁ mesophases offers exceptional solvent permeabilities higher than most amorphous polymeric membranes.

It is anticipated that this approach can extend to other self-assembled systems to prepare different channel morphologies using a bottom-up strategy. Furthermore, since the surfactants constituting the H₁ system were synthesized by a simple one-step reaction with readily available reagents, scalable fabrication of different self-assembled membranes is possible with extended exploration in the solution processing methodology. The membranes described herein may facilitate the development of emerging energy-efficient membrane applications, especially for organic solvent applications that require excellent sieving performance, such as biopharmaceutical purification, heterogeneous membrane reactors or functional nanoparticles remediation.

### Example 4—Breathable Liquid Crystal Membranes with Well-Defined Permeation Channels as Protective Garment Against Vapor Toxicant

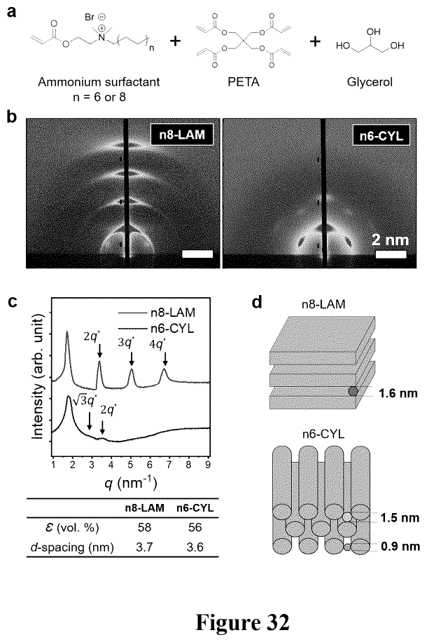

Lamellar (Lα) and direct hexagonal (HI) thin lyotropic mesophases with continuous permeation channels were made as templates to prepare nanostructured thin membranes with uniform 1-nm pores. The surfactant molecules were solvated in glycerol and the formulations were optimized to prepare a stable mesophase and prevent potential compositional changes in the thin films. The alteration in the chemical structure of surfactants and the aqueous content dedicates the principal curvatures of the interface, which in turn governs the self-assembly of lyotropic aggregates. Surfactant molecules with different hydrocarbon chain lengths were used in order to locate different cross-linked nanostructures. Specifically, as shown in FIG. 32A the n6-CYL mesophase was composed of 65 wt % 2-(acryloyloxy)ethyl tetradecyl dimethyl ammonium bromide (AETDAB), 4 wt % PETA and 31 wt % glycerol, and the formula served as the template for membranes with hexagonally ordered cylinders (H₁). The n8-LAM mesophase consisted with 67 wt % 2-(acryloyloxy)ethyl octadecyl dimethyl ammonium bromide (AEODAB), 5 wt % PETA, and 28 wt % glycerol were prepared to target the lamellar (Lα) nanostructured membranes. Because the subsequent preparation of the protective membrane involves the coating of mesophase films on support membranes covered with a dense layer of poly(vinyl pyrrolidone) (PVP), the nanostructural characterizations were based on spin-coating the solution on silicon substrates that involved a PVP layer. The PVP presents an intermediate layer that prevents the mesophase solution infiltration into the ultrafiltration support in the perspective fabrication procedure. During the spin-coating, the complete ethyl acetate evaporation leads to the formation of mesophases with the pre-assigned compositions on the support. Thereafter, photopolymerization anchors the liquid crystalline mesophase to nanostructured membranes for subsequent permeation experiments.

Two-dimensional grazing-incidence small-angle X-ray scattering (GISAXS) spectra evidenced the formation of nanostructured networks. Compared to mesophases polymerized in bulk, the in-plane morphologies of both n8-LAM and n6-CYL as thin films were restricted, as shown in FIG. 32B. For n8-LAM, the occurrence of Bragg spots in lieu of the equatorial line is accompanied with the scattering vectors q relative to the principle reflection at q* occurring at ratios of 1, 2, 3, and 4, indicating the lamellar planes stacked in parallel. Similarly, the n6-CYL obeyed a planar orientation of cylinders. That is, the scattering from n6-CYL was identified at ratios of 1, 3, and 4 to the primary peak, representing the hexagonally packed cylinders. Meanwhile, the observed (01) and (02) reflections along the polar axis are indicative of parallel cylinder orientations, but the lower intensity scattering from meridian (10) and (11) spots suggest the cylinder directions were free to explore in the plane. Albeit both nanostructures were assembled with a similar d-spacing from ˜3.5 to 3.6 nm, these orientations assigned different critical dimensions for cylinder and lamellar structures, respectively. Namely, a 0.9 nm channel was derived from the confinement of the nearest cylinders in parallel, and the lamellar stacking sheets generated a 1.5 nm passage for solute transport.

We speculate that the structural integrity of the 3D nanostructure is anchored by the topological defects that were spontaneously generated during the self-assembly procedure.

### Materials

All chemicals were purchased from Sigma-Aldrich and used as received unless otherwise noted. Cross-linker pentaerythritol tetraacrylate (PETA) solution was doped with 1 wt % photoinitiator 2-dimethoxy-2-phenylacetophenone (Acros Organics). The glycerol stock solution was prepared by mixing 10 wt % deionized water (R=18 MΩ) with 90 wt % of anhydrous glycerol (>99.5%) and was used immediately after a homogeneous solution was acquired. The polyvinylidene fluoride ultrafiltration support (PVDF, Synder V6) was purchased from Sterlitech Corporation. Support membranes were rinsed with excess water followed by immersing in ethanol before being trimmed into 2-inch diameter disks for spin-coating.

### Monomer Synthesis

Polymerizable surfactants 2-(acryloyloxy)ethyl tetradecyl dimethyl ammonium bromide (AETDAB, n=6) and 2-(acryloyloxy)ethyl octadecyl dimethyl ammonium bromide (AEODAB, n=8) were synthesized by a single-step Menshukin reaction as described above. In a typical procedure, the reaction was carried out from a mixture of 1.00 mol 2-(dimethylamino)ethyl acrylate with 1.05 mol of 1-bromotetradecane or 1-bromooctadecane, diluted by a binary solvent composed of 50/50 (v/v) tetrahydrofuran and acetonitrile to 200 mL, with 0.01 mol hydroquinone. The mixture was transferred to a round-bottom flask that came with a Teflon-coated magnetic stir bar and heated in a 45° C. oil bath for 48 hr. The product was precipitated in anhydrous diethyl ether (Fisher Scientific) at least 3 times and dried under high vacuum.

### Nanostructured Film Casting Procedure

Lyotropic liquid crystal films were deposited by spin coating the mesophase solution on different substrates in an air-conditioned room with temperature regulated from 20 to 24° C., and relative humidity controlled between 30 to 80%. The casting solution was prepared by dissolving the polymerizable surfactants, glycerol, and the cross-linking agent in ethyl acetate solution at prescribed formulas with a consistent total concentration of 25 wt %. The homogeneous mesophase solutions were purified by passage through poly(tetrafluoroethylene) syringe filters (200 nm PTFE, Fisher Scientific), then degassed before immediate use. Lyotropic thin-films were cast from solutions by spin-coating on supports at a spin speed of 2000 rpm for 1 minute, and let sit in a fume hood for another 1 minute. Subsequently, lyotropic thin-films were cross-linked by photoinitiated polymerization in a nitrogen atmosphere by projecting a focused UV beam (100-W Sunspot SM) covering a spectrum of wavelengths from 275 to 400 nm at a distance of 8 centimeters (cm) for 25 minutes. A 15 wt % ethanolic solution of 360 kg mol⁻¹ PVP was cast on (100) silicon or PVDF ultrafiltration support by spin-coating at a speed of 3000 rpm for 5 minutes.

### Structural Characterization

The birefringence textures of the lyotropic thin-films before and after cross-linking were analyzed by a Zeiss 200 M inverted microscope integrated with the Axiovert system. In preparation of samples with typical liquid crystal textures, mesophase thin films were annealed with a gentle heating and slow cooling procedure. Polarized light micrographs were captured by a CCD camera connected to a computer. The 2D grazing-incidence small-angle x-ray scattering (GISAXS) spectra were collected at the Dual Source and Environmental X-ray Scattering, operated by the Laboratory for Research on the Structure of Matter at the University of Pennsylvania based on the Xenocs Xeuss 2.0 system. The facility was equipped with a 1M Pilatus solid-state detector and a GeniX3D Cu source providing a wavelength λ=1.54 Å. The calibration was performed using silver behenate standard. Substrates were mounted on a standard GISAXS holder with a detector to sample distance of 55 cm, corresponding to accessible scattering vector (q) ranging from 0.016 to 1.02 Å-1 with incident angle varied between 0.150 to 0.2°. The 2D spectra were subsequently integrated into 1-D SAXS data by using the Foxtrot software package. Surface and cross-section micrographs of the cross-linked thin-films were captured by a field-emission scanning electron microscope (JEOL 7500F HRSEM) with a working distance ranging from 6 to 8 mm at an accelerating voltage 5 kV.

### VAPOR PERMEATION EXPERIMENT

Cross-linked, thin mesophase film on PVDF supports were mounted on customized membrane holders modified from Teflon lined scintillation vial caps, which were encased by epoxy covered aluminum tape, followed by screwing tightly on the glass vial to leave the active layer (i.e., nanoporous surface) opening to the outer atmosphere. In this manner, the nonwoven end (from the support) was exposed to a deionized (DI) water, CEES, or DMMP environment. The glass vials were filled with ˜10 mL DI water and were then transferred into an air-tight Drierite containing glass chamber. Vials containing ˜10 mL CEES or DMMP simulants were placed in another chamber filled with Drierite and activated charcoal (50/50 v/v). The relative humidity within the glass chamber was controlled below 20%, and the room temperature was regulated ˜23° C. In the temperature-controlled experiments, the chamber was placed on an aluminum shelf of a jacket-heating oven equipped with a digitized thermostat to regulate the environmental temperature ranging from 23 to 40° C., by a proportional integral derivative controller. The individual vial mass was equilibrated for approximately 24 hrs and was weighed every 12 hr for a total duration of 48 to 72 hr.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A method of producing a thin film composite membrane, said method comprising the steps of:
providing a porous support layer, and an adjacent layer in contact with the porous support layer;
depositing a solution comprising at least one polymerizable mesophase precursor on the adjacent layer, wherein the solution has a water and/or solvent content;
forming a mesophase on the adjacent layer;
polymerizing and crosslinking the mesophase precursor to form a polymer membrane, film or coating comprising cylindrical polymer fibers at least partially ordered as hexagonal packed cylinders within the film, aligned parallel to the film surface, and present as an H₁ mesophase; and
removing the adjacent layer;
wherein the cylinders are crosslinked internally within the cylinders; and wherein the cylinders are spatially arranged to provide channels between the cylinders for fluid flow through the thin film composite membrane.

2. (canceled)

3. The method of claim 1, wherein the polymerizable mesophase precursor comprises a polymerizable surfactant of the formula [Z—N⁺(R₁)(R₂)(R₃)]X⁻, wherein Z comprises a polymerizable group; X is a salt counter anion; R₁, R₂, and R₃ are alkyl groups which are bound to N and independently may be the same or different; and at least one of R₁, R₂, and R₃ is an alkyl group comprising at least 10 carbon atoms.

4. (canceled)

5. The method of claim 1, wherein the solution further comprises a photoinitiator.

6. (canceled)

7. The method of claim 1, wherein the amount of photoinitiator is from about 0.02-2.0 wt. %.

8.-15. (canceled)

16. The method of claim 1, wherein the step of polymerizing and crosslinking the polymerizable mesophase precursor forms a polymer membrane, film or coating comprising cylindrical polymer fibers at least partially ordered as hexagonal packed cylinders within the film, at least a portion of which are aligned parallel to the film surface, and present as an H₁ mesophase; wherein the cylinders are crosslinked internally within the cylinders.

17. (canceled)

18. (canceled)

19. The method of claim 1,
wherein the adjacent layer is a sacrificial layer which can be readily dissolved away using a solvent or water or dilute acid or dilute base solution; and
wherein the sacrificial layer is selected from a layer of polyacrylic acid, polyvinyl alcohol, polyvinylpyrrolidone, alginic acid, alginate, cadmium hydroxide, polyethyleneoxide, chitosan and dextran.

20.-22. (canceled)

23. A thin film composite membrane formed by the method of claim 1.

24. A polymer membrane, film or coating comprising a layer having a first surface, a second surface and a film thickness therebetween, and comprising cylindrical polymer fibers at least partially ordered as hexagonal packed cylinders within the film, aligned parallel to the film surface, and present as an H₁ mesophase;
wherein the cylinders are crosslinked internally within the cylinders; and
wherein the cylinders are spatially arranged to provide channels between the cylinders for fluid flow through the membrane, film or coating.

25. The polymer membrane, film or coating of claim 24 wherein the channels between the cylinders have a critical separation dimension of less than about 1.5 nm for fluids or fluid/solute mixtures passing through the polymer membrane, film or coating.

26. (canceled)

27. The polymer membrane, film or coating of claim 24, wherein the cylindrical polymer fibers comprise a polymerizable surfactant of the formula [Z—N⁺(R₁)(R₂)(R₃)]X⁻, wherein Z comprises a polymerizable group; X is a salt counter anion; R₁, R₂, and R₃ are alkyl groups which are bound to N that independently may be the same or different; and at least one of R₁, R₂, and R₃ is an alkyl group comprising at least 10 carbon atoms.

28. (canceled)

29. The polymer membrane, film or coating of claim 24, having a film thickness ranging from about 50 nm to about 20 μm.

30. (canceled)

31. (canceled)

32. The polymer membrane, film or coating of claim 24, wherein the cylinders are crosslinked internally within the cylinders and wherein intercylinder crosslinking also exists to connect neighboring cylindrical polymer fibers.

33. (canceled)

34. A thin film composite membrane comprising:
(i) the polymer membrane, film or coating of claim 24; and
(ii) a porous support layer in contact with the polymer membrane, film or coating.

35. The thin film composite membrane of claim 34, wherein the porous support layer is polyacrylonitrile, polyvinylidene fluoride, polysulfone, polyamide, polyimide, polypropylene, anodized aluminum oxide, cellulose acetate, or nonwoven fabric.

36. A nanofiltration device comprising the thin film composite membrane of claim 34.

37. A method of producing a thin film composite membrane, said method comprising the steps of:
providing a porous support layer;
depositing a mesophase gel on the porous support layer wherein the mesophase gel comprises a polymerizable mesophase precursor; and polymerizing and crosslinking the polymerizable mesophase precursor to form a polymer membrane, film or coating comprising cylindrical polymer fibers at least partially ordered as hexagonal packed cylinders within the film, aligned parallel to the film surface, and present as an H₁ mesophase;
wherein the cylinders are crosslinked internally within the cylinders; and wherein the cylinders are spatially arranged to provide channels between the cylinders for fluid flow through the thin film composite membrane.

38. (canceled)

39. The method of claim 37, wherein the polymerizable mesophase precursor is a polymerizable surfactant of the formula [Z—N⁺(R₁)(R₂)(R₃)]X⁻, wherein Z comprises a polymerizable group; X is a salt counter anion; R₁, R₂, and R₃ are alkyl groups which are bound to N that independently may be the same or different; and at least one of R₁, R₂, and R₃ is an alkyl group comprising at least 10 carbon atoms.

40. (canceled)

41. The method of claim 37, wherein the mesophase gel further comprises a photoinitiator.

42.-50. (canceled)

51. The method of claim 37, wherein the step of polymerizing and crosslinking the polymerizable mesophase precursor forms a polymer membrane, film or coating comprising cylindrical polymer fibers at least partially ordered as hexagonal packed cylinders within the film, aligned parallel to the film surface, and present as an H₁ mesophase;
wherein the cylinders are crosslinked internally within the cylinders and wherein inter-cylinder crosslinking also exists to connect neighboring cylindrical polymer fibers.

52. (canceled)

53. A thin film composite membrane formed by the method of claim 37.
